(19) United States
(12) Patent Application Publication
(10) Pub. No.: US 2006/0076297 A1
(43) Pub. Date: Apr. 13, 2006

(54) Method and device for electrolytically removing and recovering metal ions from waste water

(75) Inventors: Masaji Akahori, Tokyo (JP); Sota Nakagawa, Tokyo (JP)

Correspondence Address: WENDEROTH, LIND & PONACK, L.L.P., 2033 K STREET N. W., SUITE 800, WASHINGTON, DC, 20006-1021, US

(73) Assignee: Ebara Corporation, Tokyo (JP)

(21) Appl. No.: 10/536,363

(22) PCT Filed: Mar. 12, 2003
(86) PCT No.: PCT/JP03/02903

§ 371 Date: May 26, 2005

(30) Foreign Application Priority Data
Dec. 19, 2002 (JP) 2002-368650

(51) Int. Cl. B01D 17/06

(52) U.S. Cl. 210/663; 210/243; 210/702; 210/806; 204/572; 210/660; 204/665

(57) ABSTRACT

The present invention relates to a method for removing and recovering metal ions from various kinds of waste water to be treated. The method comprises an oxidizing agent removing apparatus for decomposing and removing an oxidizing agent from the water, and an electrolytic deposition apparatus (21) for removing and recovering metal ions from the water discharged from the oxidizing agent removing apparatus. The electrolytic deposition apparatus has electrodes and an ion exchanger disposed between the electrodes.

### TECHNICAL FIELD

The present invention relates to an apparatus for removing and recovering metal ions from various kinds of waste water to be treated.

### BACKGROUND ART

In a case of treating waste water containing heavy metal, such as waste water produced in plating, waste water produced in semiconductor device fabrication processes, waste water produced in fabrication of printed circuit boards, or waste water produced in mines, it has been required to remove heavy metal from waste water and recover the heavy metal as needed.

For example, in fabrication processes for semiconductor devices such as semiconductor integrated circuits, demands for semiconductor devices having finer interconnections or elements have further increased in recent years to thereby cause a problem of signal delay due to interconnection resistance. In order to solve this problem, aluminum or tungsten is replaced with copper for interconnections.

Specifically, as semiconductor chips such as central processing units (CPU) or dynamic random access memories (DRAM) have become more highly integrated, materials for interconnections in semiconductor chips, particularly for interconnections having a minimum width of 0.13 μm or smaller, have changed from aluminum into copper which has an electrical resistance lower than aluminum.

It is difficult to etch a copper layer in a semiconductor chip to form a pattern in the semiconductor chip. Therefore, when copper is used for interconnections in semiconductor chips, a semiconductor substrate is plated with copper by damascene process to deposit a copper layer on the semiconductor substrate, and then a surface of the copper layer is polished by chemical mechanical polishing (CMP) or electrochemical polishing (ECP) to form interconnections on the semiconductor substrate.

FIGS. 1A thorough 1E show an example of a process for forming an interconnection on a semiconductor substrate. As shown in FIG. 1A, a conductive layer 2 is formed on a semiconductor substrate 1 on which semiconductor devices have been formed, and an insulating film 3 of SiO₂ is deposited on the conductive layer 2. A contact hole 4 and an interconnection groove are formed in the insulating film 3 by lithography etching technology. Then, as shown in FIG. 1B, a barrier layer 6 is formed on the insulating film 3. The barrier layer 6 is made of metal such as Ta, TaN, TiN, WN, SiTiN, CoWP, or CoWB, or metallic compound thereof. In a case of forming a copper layer by electrolytic plating, as shown in FIG. 1C, a copper seed layer 7, which is used as a feeding layer in electrolytic plating, is further formed on the barrier layer 6 by sputtering or the like. In a case of forming a copper layer by electroless plating, a catalyst layer 7 is formed on the barrier layer 6 by pretreatment instead of the copper seed layer.

Subsequently, as shown in FIG. 1D, electrolytic copper plating or electroless copper plating is applied onto a surface of the copper seed layer 7 or the catalyst layer 7 to fill the contact hole 4 and the interconnection groove 5 with copper and to deposit a copper layer 8 on the insulating film 3. Thereafter, the copper layer 8 on the insulating film 3 is removed by chemical mechanical polishing (CMP) or electrochemical polishing (ECP) so that a surface of the copper layer 8 filled in the contact hole 4 and the interconnection groove 5 is substantially flushed with a surface of the insulating film 3. Thus, as shown in FIG. 1E, an interconnection comprising the copper seed layer or the catalyst layer 7, and the copper layer 8 is formed in the insulating film 3.

Waste water containing a large number of copper ions is produced in an electrolytic copper plating process and an electroless copper plating process in a semiconductor device fabrication process, and a chemical mechanical polishing (CMP) process and an electrochemical polishing (ECP) process for microchips having integrated circuits. With respect to an allowable limit of copper ions contained in waste water, a maximum concentration of copper ions is restricted to 3.0 mg/l or lower in Japan. In the United States, a concentration of copper ions is more strictly limited than in Japan. For example, a maximum concentration of copper ions is restricted to 2.7 mg/l or lower, an average concentration of copper ions per day is restricted to 1.0 mg/l or lower, and an average concentration of copper ions per year is restricted to 0.4 mg/l or lower. Therefore, there has been strongly required to provide technology capable of efficiently removing copper from waste water.

In a general type of semiconductor device fabrication plant, a single CMP apparatus produces waste water having a maximum flow rate of about 0.5 m³/h and having a maximum copper concentration of about 100 mg/l. A single copper plating apparatus produces waste water having a maximum flow rate of about 0.2 m³/h and having a maximum copper concentration of about 100 mg/l. In average fabrication plants for semiconductor devices having copper interconnections, there may be provided about ten CMP apparatuses and about ten to twenty copper plating apparatuses per a plant. In such a case, the total flow rate of waste water containing copper becomes as high as about 220 m³/day at the maximum, and the total amount of copper contained in the waste water becomes as much as about 22 kg-Cu/day at the maximum. Thus, there has been strongly required to efficiently recover and reuse copper from waste water in view of resource saving as well as environmental protection.

In a conventional installation industry including a semiconductor device fabrication industry, waste water has been treated by a synthetic waste water treating system in which waste water has been collected from various processes in a plant and has been collectively treated. However, in a semiconductor device fabrication industry in which fabrication processes have been rapidly improved, there has been required to treat waste water discharged from respective processes on the spots, i.e., at locations where water has been used. This reason is as follows: Production systems have changed from conventional mass production into diversified few quantity production. Types of products are changed so frequently that variation of properties of waste water becomes large. The conventional waste water treating system cannot sufficiently cope with the variation of properties of waste water. Additionally, a system in which waste water produced in respective processes is respectively treated can facilitate recovering and reusing heavy metal as compared to the conventional synthetic waste water treating system.

Under these circumstances, there has been required an apparatus for removing and recovering metal ions from waste water which can treat waste water containing metal ions in a wide range from a high concentration to a low concentration, and can sufficiently treat a large amount of waste water. Particularly, there has been required an apparatus for removing and recovering copper from waste water produced in semiconductor device fabrication processes.

### DISCLOSURE OF INVENTION

It is therefore an object of the present invention to provide a system for treating waste water which can treat waste water containing metal ions in a wide range from a high concentration to a low concentration, and can sufficiently treat a large amount of waste water.

The present inventors have found from an extensive study that as an apparatus for treating waste water containing metal ions, particularly waste water containing copper ions discharged from a semiconductor device fabrication process, metal ions in waste water can be efficiently removed and recovered by combining electrolytic deposition operation and ion exchange operation. Specifically, according to one aspect of the present invention, there is provided a treatment apparatus for treating water containing metal ions which combines an electrolytic deposition unit and an ion exchange unit.

### BRIEF DESCRIPTION OF DRAWINGS

FIGS. 1A through 1E are schematic views showing an example of a process for forming a copper interconnection in a semiconductor chip;

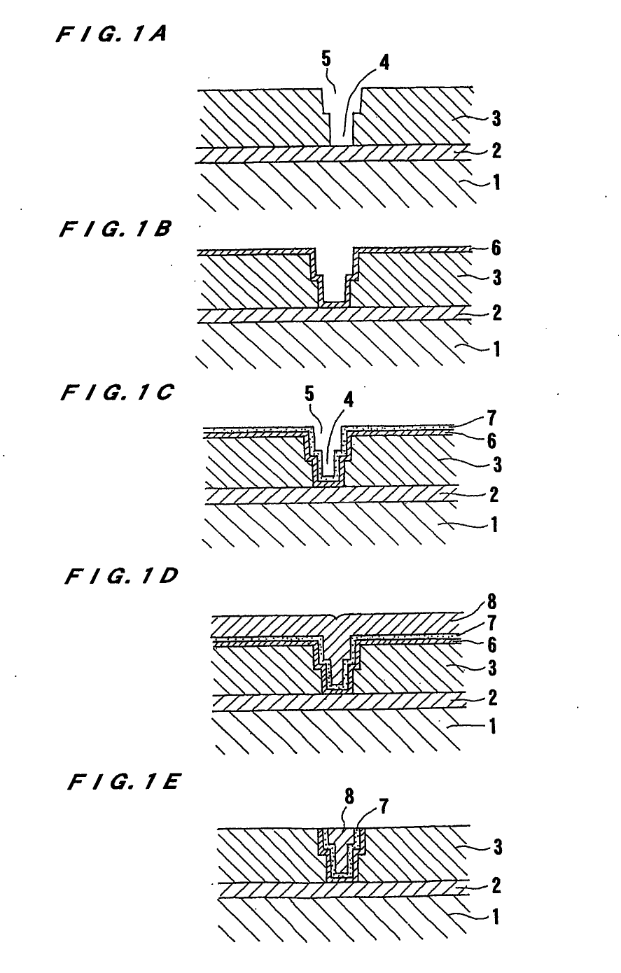

FIG. 2 is a schematic view showing an electrolytic deposition apparatus according to an embodiment of the present invention;

FIG. 3 is a schematic view showing an electrolytic deposition apparatus according to another embodiment of the present invention;

FIG. 4 is a schematic view showing an electrolytic deposition apparatus according to still another embodiment of the present invention;

FIG. 5 is a schematic view showing an electrolytic deposition apparatus according to still another embodiment of the present invention;

FIG. 6 is a schematic view showing an apparatus for treating water to be treated according to an embodiment of the present invention;

FIG. 7 is a schematic view showing an apparatus for treating water to be treated according to another embodiment of the present invention;

FIG. 8 is a schematic view showing an apparatus for treating water to be treated according to still another embodiment of the present invention;

FIG. 9 is a schematic view showing an apparatus for treating water to be treated according to still another embodiment of the present invention;

FIG. 10 is a schematic view showing an electrolytic deposition apparatus according to an embodiment of another aspect of the present invention;

FIG. 11 is a schematic view showing an electrolytic deposition apparatus according to an embodiment of still another aspect of the present invention;

FIG. 12 is a schematic view showing an electrolytic deposition apparatus according to an embodiment of still another aspect of the present invention;

FIG. 13 is a schematic view showing an electrolytic deposition apparatus according to an embodiment of still another aspect of the present invention;

FIG. 14 is a schematic view showing an electrolytic deposition apparatus according to an embodiment of still another aspect of the present invention;

FIG. 15 is a schematic view showing an electrolytic deposition apparatus according to an embodiment of still another aspect of the present invention;

FIGS. 16A and 16B are schematic views showing an apparatus for treating water according to an embodiment of still another aspect of the present invention;

FIGS. 17A through 17H are schematic views showing a method of flowing water in an electrolytic deposition apparatus according to an embodiment of an aspect of the present invention;

FIGS. 18A through 18D are schematic views showing a method of flowing water in an electrolytic deposition apparatus according to an embodiment of another aspect of the present invention;

FIGS. 19A and 19B are schematic views showing a method of flowing water in an electrolytic deposition apparatus according to an embodiment of still another aspect of the present invention;

FIGS. 20A and 20B are schematic views showing a method of detecting an abnormal state in an electrolytic deposition apparatus according to an embodiment of an aspect of the present invention;

FIGS. 21A through 21C are schematic views showing a method of controlling operation of an electrolytic deposition apparatus according to an embodiment of an aspect of the present invention;

FIG. 22 is a schematic view showing a waste water treating system according to an embodiment of an aspect of the present invention;

FIGS. 23A through 23C are schematic views showing a waste water treating system according to an embodiment of another aspect of the present invention;

FIGS. 24A and 24B are schematic views showing a waste water treating system according to an embodiment of still another aspect of the present invention;

FIG. 25 is a schematic view showing a waste water treating system according to an embodiment of still another aspect of the present invention;

FIG. 26 is a schematic view showing a waste water treating system according to an embodiment of still another aspect of the present invention;

FIG. 27 is a schematic view showing a waste water treating system according to an embodiment of still another aspect of the present invention;

FIGS. 28A through 28D are schematic views showing a waste water treating system according to an embodiment of still another aspect of the present invention;

FIGS. 29A through 29F are schematic views showing a waste water treating system according to an embodiment of still another aspect of the present invention;

FIGS. 30A through 30F are schematic views showing a waste water treating system according to an embodiment of still another aspect of the present invention;

FIG. 31 is a schematic view showing a waste water treating system according to an embodiment of still another aspect of the present invention;

FIG. 32 is a schematic view showing a waste water treating system according to an embodiment of still another aspect of the present invention;

FIG. 33 is a schematic view showing a waste water treating system according to an embodiment of still another aspect of the present invention;

FIG. 34 is a schematic view showing a waste water treating system according to an embodiment of still another aspect of the present invention;

FIGS. 35A and 35B are schematic views showing a waste water treating system according to an embodiment of still another aspect of the present invention;

FIGS. 36A and 36B are schematic views showing a method of installing, in a semiconductor device fabrication plant, a waste water treating apparatus according to an embodiment of the present invention;

FIG. 37 is a schematic view showing an electrolytic deposition apparatus used in an experiment;

FIG. 38 is a schematic view showing an electrolytic deposition apparatus according to an embodiment of another aspect of the present invention;

FIG. 39 is a schematic view showing an electrolytic deposition apparatus according to an embodiment of still another aspect of the present invention;

FIGS. 40A and 40B are schematic views showing an electrolytic deposition apparatus according to an embodiment of still another aspect of the present invention;

FIG. 41 is a schematic view showing an electrolytic deposition apparatus according to an embodiment of still another aspect of the present invention;

FIG. 42 is a schematic view showing a waste water treatment system according to an embodiment of another aspect of the present invention;

FIG. 43 is a schematic view showing a waste water treatment system according to an embodiment of still another aspect of the present invention;

FIG. 44 is a schematic view showing a method for treating hydrogen gas generated in an electrolytic deposition apparatus according to the present invention;

FIG. 45 is a schematic view showing another method for treating hydrogen gas generated in an electrolytic deposition apparatus according to the present invention;

FIG. 46 is a schematic view showing still another method for treating hydrogen gas generated in an electrolytic deposition apparatus according to the present invention;

FIG. 47 is a schematic view showing a treatment flow of water to be treated;

FIG. 48 is a schematic view showing a relationship between a plating apparatus and a waste water treatment system according to the present invention;

FIG. 49 is a schematic view showing a relationship between a CMP apparatus and a waste water treatment system according to the present invention;

FIG. 50 is a schematic view showing a case of introducing waste water discharged from an apparatus that carries out etching and cleaning steps, or plating, etching and cleaning steps in the same chamber into a waste water treatment system;

FIG. 51 is a schematic view showing a case of collectively treating waste water discharged from a plurality of apparatuses that perform an identical step;

FIG. 52 is a perspective view showing a waste water treatment unit provided within a casing;

FIGS. 53A and 53B are views showing preferable positional relationships between a CMP apparatus or a plating apparatus and a waste water treatment system according to the present invention;

FIGS. 54A through 54C are views showing cases of collectively treating waste water discharged from apparatuses that perform different process steps; and

FIGS. 55A through 55E are schematic views showing various treatment flows in which a deoxidization step is incorporated.

### BEST MODE FOR CARRYING OUT THE INVENTION

An apparatus for treating water to be treated according to embodiments of the present invention will be described below with reference to the accompanying drawings. Like or corresponding parts are denoted by like or corresponding reference numerals throughout drawings, and will not be described below repetitively.

An apparatus for treating water to be treated according to embodiments of the present invention utilizes combination of electrolytic deposition and ion exchange to treat water containing metal ions.

Electrolytic deposition of waste water containing metal ions is based on the principal that when electrodes of titanium, nickel, stainless steel, or the like are immersed into an aqueous solution containing metal ions and current is supplied to the electrodes, metal is deposited on a surface of a cathode. For example, when such an electrolytic process is applied to water containing copper ions, one or more reactions expressed by the following chemical formulas (1) and/or (2) occur on an anode.
H₂O→2H⁺+½O₂↑+2e⁻ (1)
2OH⁻→H₂O+½O₂↑+2e⁻ (2)
Thus, oxygen gas is produced on the anode. Reactions expressed by the following chemical formulas (3) and (4) and/or (5) occur on a cathode.
Cu²⁺+2e⁻→Cu↓ (3)
2H⁺+2e⁻→H₂↑ (4)
2H₂O+2e⁻→H₂↑+2OH⁻ (5)
Thus, copper is deposited on a surface of the cathode, and hydrogen gas is produced on the cathode.

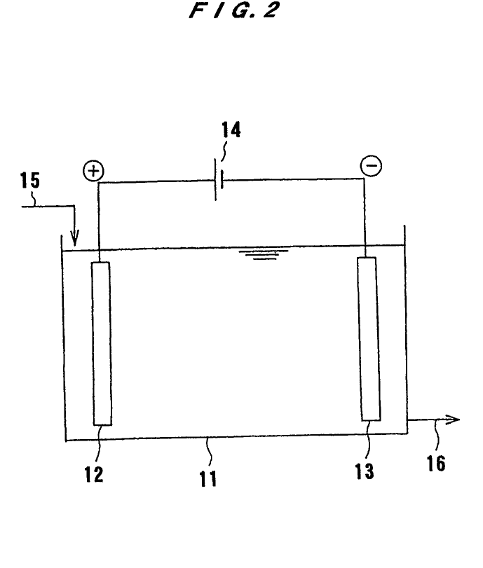

FIG. 2 shows an electrolytic deposition apparatus according to an embodiment of the present invention. As shown in FIG. 2, the electrolytic deposition apparatus has an electrolytic bath 11, an anode 12 disposed in the electrolytic bath 11, a cathode 13 disposed in the electrolytic bath 11, and a DC power supply 14. The anode 12 and the cathode 13 are electrically connected to an anode and a cathode of the DC power supply 14, respectively. Waste water (water to be treated) 15 is supplied into the electrolytic bath 11, and a voltage is applied between the anode 12 and the cathode 13 by the DC power supply 14. Metal ions Mⁿ⁺ in the waste water are attracted to the cathode 13 by a potential gradient and are deposited as metal on a surface of the cathode 13 by electrode reaction. This process reduces the concentration of the metal ions Mⁿ⁺ in the waste water. The waste water whose concentration of the metal ions is lowered is discharged from an outlet 16. In order to deposit the metal uniformly on the surface of the cathode 13, it is preferred to sufficiently stir the waste water 15 in the electrolytic bath 11.

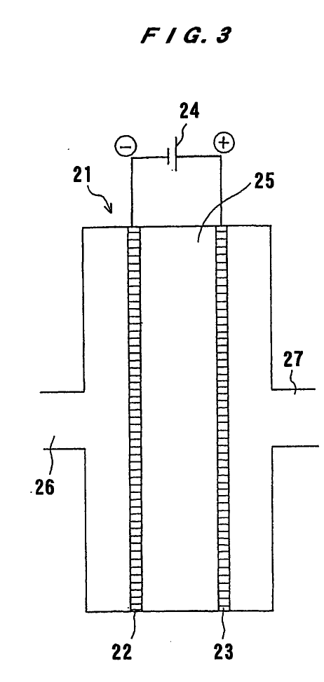

FIG. 3 shows an electrolytic deposition apparatus according to another embodiment of the present invention. The electrolytic deposition apparatus 21 shown in FIG. 3 has a cathode 22 and an anode 23 which are made of water permeable materials, which allow water to pass therethrough. The cathode 22 and the anode 23 form an electrolytic chamber 25 therebetween. The cathode 22 and the anode 23 are electrically connected to a cathode and an anode of a DC power supply 24, respectively. The electrolytic deposition apparatus 21 has a water supply pipe 26 outside of the cathode 22 and a water discharge pipe 27 outside of the anode 23. Waste water (water to be treated) containing metal ions is supplied through the water supply pipe 26 into the electrolytic deposition apparatus 21, and passed through the electrolytic chamber 25 while a voltage is applied between the cathode 22 and the anode 23. Metal ions Mⁿ⁺ in the waste water are deposited as metal on a surface of the cathode 22 by electrode reaction when the waste water is passed through the cathode 22. This process reduces the concentration of the metal ions Mⁿ⁺ in the waste water. The waste water whose concentration of the metal ions is lowered is discharged through the water discharge pipe 27. Waste water may be passed in an opposite direction through the electrolytic deposition apparatus 21. Specifically, waste water may be supplied through the pipe 27, passed through the anode 23, and then the cathode 22, and discharged through the pipe 26.

Electrodes used in such an electrolytic deposition apparatus may be made of various materials, and have various shapes, as in the case of a general electrochemical reaction apparatus such as an electrodialyser or an electrolyzer. For example, the electrodes may be made of carbon materials, such as activated carbon or graphite fiber, or various kinds of conductive metallic materials, such as copper, nickel, titanium, lead dioxide, ferrite, or stainless steel. Further, conductive metallic materials coated with a noble metal may be used as the electrodes. Particularly, when a metallic material is used as a cathode for depositing metal thereon, the cathode should preferably be made of the same kind of metal as the metal to be deposited thereon. Further, the electrodes may be in the form of a plate or a rod, and may be porous, fibrous, felt, or spongelike. Each of the electrodes should preferably have a shape having a large specific surface area because the electrode current density is smaller to thus facilitate control of the intended electrode reaction.

In a case of an electrolytic deposition apparatus as shown in FIG. 3 in which water is passed through electrodes, the electrodes are required to have a sufficient water-permeability. Further, in an electrolytic deposition apparatus as shown in FIG. 2, it may be preferable to allow water to pass through electrodes. In such cases, a water-permeable material is preferably used as an electrode. Such a water-permeable material for electrodes includes expanded metal, metallic materials having diagonal meshes, metallic materials having latticed meshes, and netlike metallic materials. More specifically, such a water-permeable material includes wire gauze, punching metal, expanded metal (lath-metal specification), foamed metal, and fibrous metal. It is desirable to use an anode made of titanium and having the above shape which is plated with platinum. Further, it is desirable to use a cathode made of stainless steel and having the above shape.

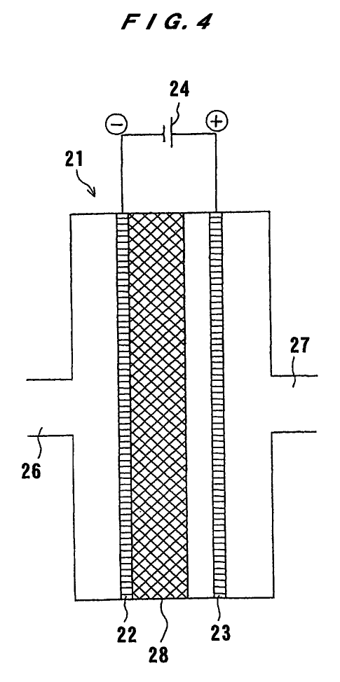

In the electrolytic chamber 25 of the electrolytic deposition apparatus 21, it is preferable to dispose a conductive layer having a water-permeability so as to contact the cathode 22 because the conductive layer can increase a substantial surface area of a cathode serving to deposit metal thereon. FIG. 4 shows an electrolytic deposition apparatus according to still another embodiment of the present invention, in which a conductive layer 28 having a water-permeability is disposed so as to contact the cathode 22 in the electrolytic chamber 25 of the electrolytic deposition apparatus shown in FIG. 3. The conductive layer 28 having a water-permeability is used to increase a substantial surface area of the cathode. Therefore, the conductive layer 28 having a water-permeability should preferably have a large surface area. Sheet-like fiber made of a conductive material such as carbon or metal is preferably used as the conductive layer 28 having a water-permeability. As an example, the conductive layer 28 having a water-permeability includes nonwoven sheet-like materials made of carbon fiber (e.g., activated carbon fiber sheet in a felt form), foamed metal, and metal fiber sheet. Alternatively, carbon fiber may be impregnated with thermosetting resin, then burned and carbonized, and formed into a porous plate of graphite. Such a porous plate can suitably be used as the conductive layer 28.

Further, a sintered metal fiber, which is obtained by providing metal fibers onto a nonwoven fabric, and then sintering the metal fibers, may be preferably used. Metals usable for foamed metal or metal fiber sheet are not particularly limited. However, it is preferred to use the same metal as the metal ion to be deposited because reuse of the deposited metal can be facilitated. Further, in the case where metal such as lead or zinc which causes overvoltage in electrolysis of water is used in foamed metal or metal fiber sheet, the water decomposition expressed by the chemical formula (5) hardly occur. Thus, the voltage range which can be operated is expanded to thus facilitate the operation. In addition, less electric current is used for the unnecessary chemical reaction, and thus the ratio of electric current used for the intended deposition of metal ions becomes higher, leading to an increased electric current efficiency. The use of such a metal is therefore preferred.

The activated carbon fiber sheet material in a felt form may be provided by a carbon fiber sheet in a felt form as it is. Alternatively, the activated carbon fiber sheet in a felt form may be provided in such a manner that filament sheets of polyethylene terephthalate acrylic ester, nonwoven fabric having long fibers into which polyamide, polypropylene, and hydrous magnetic silicate are mixed and spun, or thin sheets such as papers, are attached to both surfaces of the sheet as reinforcing members. When such an activated carbon fiber sheet in a felt form is used as a conductive element having a water-permeability for increasing a substantial surface area of a cathode in an electrolytic deposition apparatus according to the present invention, a plurality of activated carbon fiber sheets may be piled on each other as needed. In experiments carried out by the inventors, when a plurality of felt sheets having reinforcing sheets such as laminated nonwoven fabric having long fibers or papers, attached on both surfaces thereof were piled in an electrolytic deposition apparatus according to the present invention, deposition of metal in waste water could be promoted. Specifically, when non-conductive thin sheets such as nonwoven fabric or papers are interposed between conductive fiber sheets, potential differences are increased between the conductive fiber sheets. The increased potential differences can promote deposition of metal. From this point of view, when a plurality of conductive fiber materials are piled on each other, a non-conductive sheet may be disposed between at least one pair of the conductive fiber materials to form a conductive layer as a whole. When a non-conductive sheet is disposed between adjacent two of a plurality of conductive fiber materials which are piled on each other, each of locations where the non-conductive sheets are disposed serves as a field for deposition. Therefore, the entire part of a conductive layer has a function for depositing metal. Similarly, a non-conductive sheet may be disposed between a layer of a water-permeable conductive element and a layer of a cation exchanger. In this case, the interposed non-conductive sheet can increase potential differences between a water-permeable conductive element serving as a cathode and a cation exchanger to promote deposition of metal.

A foamed metal material having a water-permeability which is formed by various kinds of metals, or a sintered metal fiber may be used as a water-permeable conductive element instead of or in combination with the conductive fiber materials descried above. The foamed metal material has a considerably large surface area as with a fiber material. Therefore, the foamed metal material is suitable for use as a conductive material for increasing a substantial surface area of a cathode to efficiently deposit metal electrolytically. For example, the foamed metal material having a water-permeability includes a foamed copper metal.

For example, when an electrolytic deposition apparatus according to the present invention is used for treating waste water produced in semiconductor device fabrication processes such as CMP, copper plating or electrochemical polishing to remove and recover copper from the waste water, substantially no metal ions other than copper ions may be present in the waste water. In a process of recovering copper from such waste water, when a foamed copper material is used as a conductive material serving as a cathode, copper is deposited on the foamed copper material by electrolytic deposition because the waste water contains substantially only copper as metal ions. When the foamed copper material as a conductive material is recovered after operation of the electrolytic deposition, the foamed copper material can be reused for copper material as it is without any special refining process.

As described above, a conductive layer having a water-permeability should preferably be disposed so as to contact the cathode in an electrolytic chamber formed between electrodes. It is not necessary to dispose such a conductive layer separately from a cathode. For example, when a carbon fiber material or a water-permeable foamed metal material is used as a cathode itself, the surface area of the cathode can be increased. Alternatively, when a plurality of cathodes made of expanded metal or wire gauze are piled on each other, the surface area of the cathode can be increased. Further, by combining the above-described carbon fiber material, water-permeable foamed metal material, expanded metal, and wire gauze arbitrarily, the surface area of the cathode can be increased. When the same or similar materials are used as an anode, the surface area of the anode can be increased.

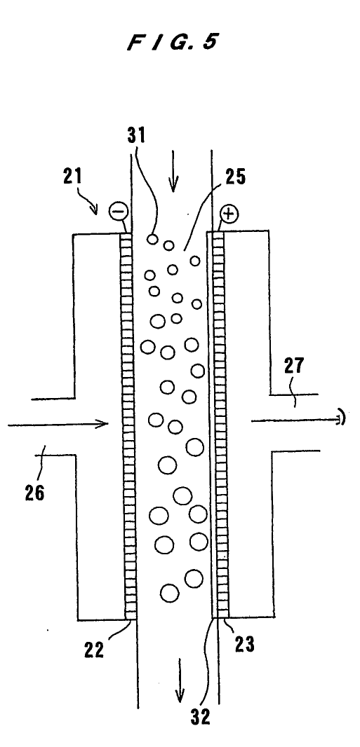

Conductive granular materials may be provided in an electrolytic field between electrodes. Since such conductive granular materials can serve as a cathode, the substantial surface area of the cathode can be increased. Further, when the conductive granular materials on which metal has been deposited are recovered in a batch or continuous manner, metal can easily be recovered. FIG. 5 shows an electrolytic deposition apparatus according to still another embodiment of the present invention, in which conductive granular materials 31 are provided in the electrolytic chamber 25 of the electrolytic deposition apparatus shown in FIG. 3. The conductive granular materials 31 are filled into the electrolytic chamber 25 in a batch manner. Specifically, electrolytic deposition is performed in such a state that a predetermined amount of conductive granular materials 31 are filled into the electrolytic chamber 25. After a certain amount of metal is deposited on the conductive granular materials 31, the conductive granular materials 31 are recovered. Alternatively, the conductive granular materials 31 may be continuously supplied into and recovered from the electrolytic chamber 25 with a water stream or the like. The conductive granular materials 31 in the electrolytic chamber 25 are negatively charged in contact with the cathode 22, and metal ions in waste water are deposited on a surface of the conductive granular materials 31 by electrode reaction. For example, as shown in FIG. 5, when the conductive granular materials 31 are continuously supplied into and recovered from the electrolytic chamber 25 with a water stream or the like, the metal can be recovered continuously. Nevertheless, the conductive granular materials 31 may be supplied into and recovered from the electrolytic chamber 25 in a batch manner. In order to prevent the conductive granular materials 31 which are negatively charged and the anode 23 from being brought into contact with each other to cause short circuit therebetween, it is necessary to dispose an insulating diaphragm 32 having a water-permeability on a surface of the anode 23. For example, the insulating diaphragm 32 may be made of resin, ceramics, or the like. As with electrodes, the insulating diaphragm 32 may be made of netlike materials, materials having diagonal meshes, or materials having latticed meshes. The conductive granular materials 31 may be made of a conductive material as with a cathode. For example, conductive granular materials 31 include granulated metal, graphite, activated carbon, and the like. It is desirable to use the same kind of metal particles as the metal to be deposited. In an electrolytic deposition apparatus as shown in FIG. 4 in which a water-permeable conductive element is disposed so as to contact the cathode, conductive granular materials may be provided between the water-permeable conductive element and the anode.

Next, ion exchange of waste water containing metal ions will be described below. An ion exchanger comprises a column having bead-like ion exchange resin filled therein, a fabric material such as woven fabric or nonwoven fabric, a porous film, a spacer having diagonal meshes, or the like. Waste water (water to be treated) containing metal ions is passed through the ion exchanger. Metal ions Mⁿ⁺ in the waste water are adsorbed by the ion exchanger with ion exchange. Thus, the metal ions Mⁿ⁺ contained in the waste water are removed and recovered more reliably. In the ion exchange process, the waste water may be passed through layers of the ion exchanger. Alternatively, the waste water may be passed along surfaces of layers of the ion exchanger.

Any ion exchange resin beads known in the art may be used for this purpose. For example, strongly acidic cation-exchange resin beads which are used in the present invention can be obtained by using the beads as a basic resin comprising polystyrene which is crosslinked with divinylbenzene, and sulfonating the beads by a sulfonating agent such as sulfuric acid or chlorosulfonic acid to introduce sulfonic group into the basic resin. This production method is known in the art and a variety of products produced by this method are now commercially available. It is also possible to use the resin beads which have various functional groups, for example, functional groups derived from iminodiacetic acid and its sodium salt, functional groups derived from various amino acids such as phenylalanine, lysine, leucine, valine, proline and their sodium salts, and functional groups derived from iminodiethanol.

As an ion-exchange fibrous material which can be used for the same purpose, it is preferable to use a fibrous material comprising polymer fibers as substrates to which ion-exchange groups are introduced by graft polymerization. The substrates of polymer fibers to be grafted may either be single fibers of a polyolefine such as polyethylene or polypropylene, or composite fibers comprising a core portion and a sheath portion in which the core portion and the sheath portion are made of different polymers respectively. Example of composite fibers which can be used in the present invention is composite fibers having a core-sheath structure in which a polyolefin such as polyethylene constitutes the sheath and other polymer such as polypropylene which is not used for the sheath constitutes the core. The ion-exchange fibrous materials, which are obtained by introducing ion-exchange groups into the composite fibers by a radiation-induced graft polymerization, are excellent in the ion-exchange capacity and can be produced with a uniform thickness, and therefore are desirable as ion-exchange fibrous materials to be used for the above object. The ion-exchange fibrous material may be in the form of a woven fabric, nonwoven fabric, and the like.

As an ion exchanger in the form a spacer member such as a diagonal net, an ion exchanger comprising a polyolefin resin is preferably used for its excellent ion exchange ability and excellent ability to disperse the water to be treated. For example, a polyethylene diagonal net which is widely employed in electrodialysis baths is used as substrates and ion-exchange ability is imparted by utilizing a radiation-induced graft polymerization, then desirable ion exchanger is obtained.

The radiation-induced graft polymerization is a technique for introducing a monomer into polymer substrates by irradiating the polymer with radiation rays so as to produce a radical which reacts with the monomer.

Radiation rays usable for the radiation-induced graft polymerization include α-rays, β-rays, γ-rays, electron beam, ultraviolet rays, and the like. Of these, γ-rays or electron beam may preferably be used in the present invention. As the radiation-induced graft polymerization, there are a pre-irradiation graft polymerization comprising previously irradiating graft substrates with radiation rays and then contacting the substrates with a grafting monomer, and a co-irradiation method in which irradiation of radiation rays is carried out in the co-presence of substrates and a grafting monomer. Both of these methods may be employed in the present invention. Further, depending upon the manner of contact between a monomer and substrates, there are polymerization methods such as a liquid-phase graft polymerization method in which polymerization is effected while substrates are immersed in a monomer solution, a gas-phase graft polymerization method in which polymerization is effected while substrates are in contact with vapor of monomer, and an immersion gas-phase graft polymerization method in which substrates are firstly immersed in a monomer solution and then taken out of the monomer solution and a polymerization is effected in a gas phase. Either method of polymerization may be employed in the present invention.

The ion-exchange groups to be introduced into fibrous substrates such as a nonwoven fabric, or into spacer substrates are not particularly limited. Various kinds of cation-exchange groups and anion-exchange groups can be used. For instance, usable cation-exchange groups include strongly acidic cation-exchange groups such as sulfo group, moderately acidic cation-exchange groups such as phosphoric group, and weakly acidic cation-exchange groups such as carboxy group. Usable anion-exchange groups include weakly basic anion-exchange groups such as primary, secondary and tertially amino groups, and strongly basic anion-exchange groups such as quaternary ammonium group. Further, an ion exchanger having both of the above-described cation and anion groups may also be employed. Furthermore, it is also possible to use an ion exchanger having functional groups such as functional groups derived from iminodiacetic acid or its sodium salt, functional groups derived from various amino acids including phenylalanine, lysine, leucine, valine, proline or their sodium salts or functional groups derived from iminodiethanol.

These various ion-exchange groups can be introduced into fibrous substrates or spacer substrates by subjecting a monomer having such an ion-exchange group to graft polymerization, preferably radiation-induced graft polymerization, or by subjecting a polymerizable monomer having a group that are changeable into an ion-exchange group, to graft polymerization, followed by conversion of that group into the ion-exchange group. Monomers having an ion-exchange group usable for this purpose may include acrylic acid (AAc), methacrylic acid, sodium styrenesulfonate (SSS), sodium methallylsulfonate, sodium allylsulfonate, sodium vinylsulfonate, vinylbenzyl trimethylammonium chloride (VBTAC), diethylaminoethyl methacrylate, and dimethylaminopropylacrylamide. Sulfo group as a strongly acidic cation-exchange group, for example, may be introduced directly into substrates by carrying out radiation-induced graft polymerization in which sodium styrenesulfonate is used as a monomer. Quaternary ammonium group as a strongly basic anion-exchange group may be introduced directly into substrates by carrying out radiation-induced graft polymerization in which vinylbenzyl trimethylammonium chloride is used as a monomer. The monomer having groups that can be converted into ion-exchange groups may include acrylonitrile, acrolein, vinylpyridine, styrene, chloromethylstyrene, and glycidyl methacrylate (GMA). Sulfo group as a strongly acidic cation-exchange group, for example, may be introduced into substrates in such a manner that glycidyl methacrylate is introduced into the substrates by radiation-induced graft polymerization, and then react with a sulfonating agent such as sodium sulfite. Quaternary ammonium group as a strongly basic anion-exchange group may be introduced into substrates in such a manner that chloromethylstyrene is graft-polymerized onto substrates and then the substrates are immersed into an aqueous solution of trimethylamine to effect quaternary-ammonification. Further, sodium iminodiacetate group as a functional group can be introduced into substrates in such a manner that chloromethylstyrene is graft-polymerized onto substrates and the substrates react with a sulfide to make a sulfonium salt, and then the sulfonium salt reacts with sodium iminodiacetate. Alternatively, sodium iminodiacetate as a functional group may be introduced into substrates in such a manner that chloromethylstyrene is graft-polymerized onto substrates and chloro group is substituted with iodine group and iodine group reacts with an iminodiacetic acid diethyl ester to substitute iodine group with an iminodiacetic acid diethyl ester group, and finally the ester group reacts with sodium hydroxide to convert the ester group into sodium salt.

Among the above-described various forms of ion exchangers, an ion-exchange fibrous material in the form of a nonwoven fabric or a woven fabric is particularly preferable. A fibrous material, such as a woven fabric or a nonwoven fabric, as compared to materials in the form of beads, a diagonal net, and the like has a remarkably larger surface area, and therefore a larger amount of ion exchange groups, can be introduced thereinto. Further, unlike the case of resin beads in which ion-exchange groups are present in micropores or macropores within the beads, all the ion-exchange groups are present on the surfaces of fibers in the case of an ion-exchange fibrous material. Accordingly, metal ions in the water to be treated can easily diffuse into the vicinity of ion-exchange groups, and the ions are adsorbed by means of ion exchange. Therefore, the use of an ion-exchange fibrous material can thus improve removal and recovery efficiency of metal ions.

The present invention is characterized in that the above-described electrolytic deposition operation and ion exchange operation are used in combination thereof in an apparatus for treating the water containing metal ions so as to recover the metal ions. Electrolytic deposition operation for removal and recovery of metal ions in the water to be treated has the advantage that the water having a certain high degree of metal ion concentration can be successfully treated, and the target metal ions can be recovered. There is, however, the drawback that a decrease in the metal ion concentration of the water to be treated requires the use of a higher operational voltage. On the other hand, ion exchange operation for removal and recovery of metal ions in the water has the advantage that it can be suitably employed for treating the water having a low metal concentration. However, the ion exchange operation involves the following problems: Since metal ions are recovered by allowing the ions to be adsorbed on an ion exchanger, a large amount of acid is required to elute the adsorbed metal ions for recovery. When the water to be treated has a high metal ion concentration or a large volume of water, the amount of metal to be recovered should necessarily become large, leading to an increased frequency of operations, for eluting metal ions from an ion exchanger and recovering the metal ions, that impose heavy burden. Further, since metal ions in the water are recovered as metal ions, an additional treatment such as electrolytic deposition is required for recovering the metals as elemental metal substances.

In the present invention, the electrolytic deposition operation and the ion exchange operation respectively having the above merits and defects are utilized in combination of each operation when treating the water. Accordingly, the present invention makes it possible to combine the merits of these two operations while compensating the defects and carry out an appropriate treatment that can meet variation of quality and quantity of the water to be treated.

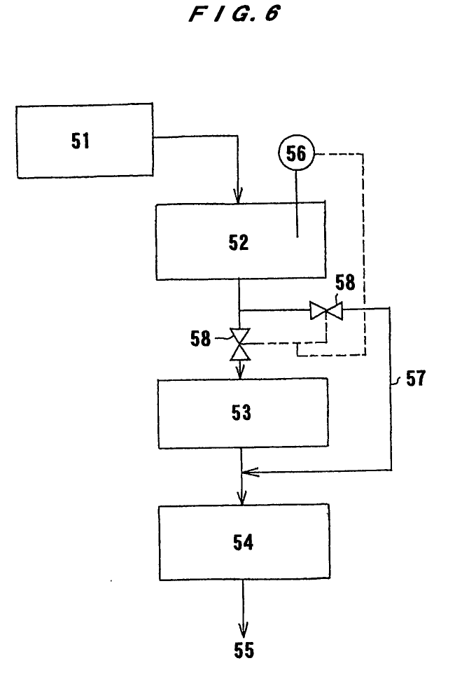

FIG. 6 shows an apparatus for treating water to be treated according to an embodiment of the present invention. The apparatus shown in FIG. 6 has an electrolytic deposition unit 53 and an ion exchange unit 54 which are connected in series to each other for treating waste water (water to be treated). For example, waste water containing metal ions such as copper ions discharged from a processing unit 51 such as a CMP unit, an ECP unit, or a copper plating unit in a semiconductor device fabrication processes is received in a waste water tank 52, and then introduced into the electrolytic deposition unit 53. In the electrolytic deposition unit 53, a sufficient amount of copper ions contained in the waste water is recovered as copper metal by electrolytic deposition. The waste water treated in the electrolytic deposition unit 53 is then introduced into the ion exchange unit 54, where the remaining copper ions are almost completely removed from the waste water. Then, the waste water is discharged as treated water 55 from the ion exchange unit 54.

The waste water tank 52 has a measuring device 56 for measuring the concentration of copper ions. When the concentration of copper ions in the waste water is lower than a predetermined value, the measuring device 56 judges that the electrolytic deposition cannot be performed efficiently. In such a case, control valves 58 may be switched so that the waste water is introduced from the waste water tank 52 directly into the ion exchange unit 54 by bypassing the electrolytic deposition unit 53. Alternatively, operation of the electrolytic deposition unit 53 may be stopped, or a current to be supplied to the electrolytic deposition unit 53 may be reduced, when the measured concentration of copper ions is low.

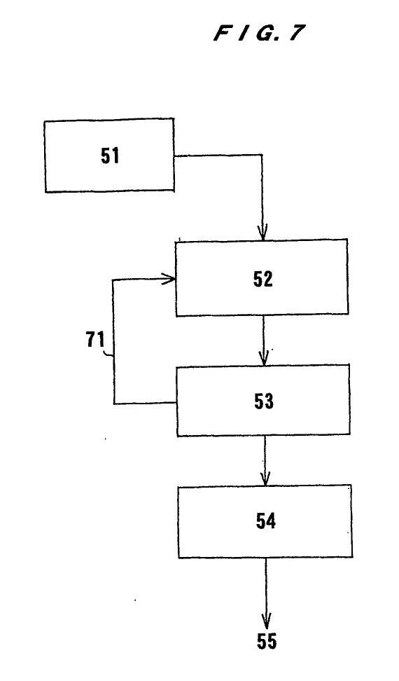

FIG. 7 shows an apparatus for treating water to be treated according to another embodiment of the present invention. As shown in FIG. 7, in the apparatus in which the electrolytic deposition unit 53 and the ion exchange unit 54 are connected to each other in series, a portion of waste water discharged from the electrolytic deposition unit 53 may be returned through a return pipe 71 to the waste water tank 52, and then introduced into the electrolytic deposition unit 53. In this case, it is possible to enhance the efficiency of removing and recovering metal ions from the waste water.

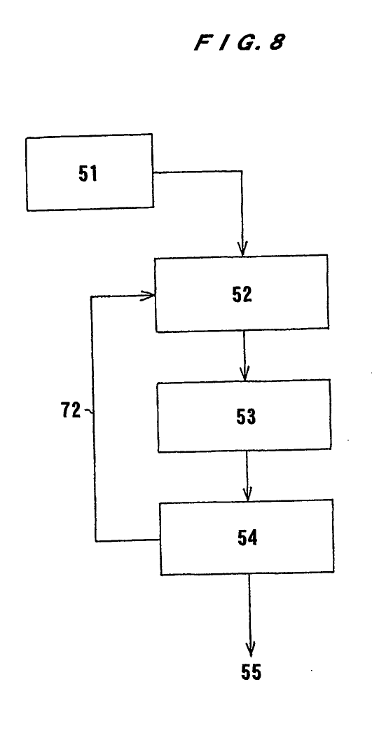

FIG. 8 shows an apparatus for treating water to be treated according to still another embodiment of the present invention. As shown in FIG. 8, a potion of waste water discharged from the ion exchange unit 54 may be returned via a return pipe 72 to the waste water tank 52, and then introduced into the electrolytic deposition unit 53 and the ion exchange unit 54.

In the apparatus as shown in FIGS. 6 through 8 in which the electrolytic deposition unit 53 and the ion exchange unit 54 are connected to each other in series, the electrolytic deposition unit 53 and the ion exchange unit 54 may be exchanged so that waste water is introduced first into the ion exchange unit and then into the electrolytic deposition unit.

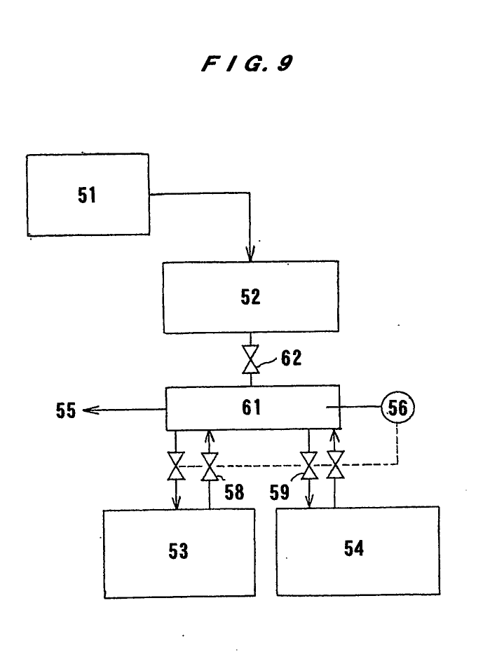

FIG. 9 shows an apparatus for treating water to be treated according to still another embodiment of the present invention, in which an electrolytic deposition unit 53 and an ion exchange unit 54 are connected to each other in parallel for treating waste water (water to be treated). For example, waste water containing metal ions such as copper ions from a processing unit 51 such as a CMP unit, an ECP unit, or a copper plating unit in a semiconductor device fabrication processes is received in a waste water tank 52, and a proper amount of the waste water is supplied through a valve 62 to a treatment tank 61. The waste water received in the treatment tank 61 is circulated through valves 58 between the electrolytic deposition unit 53 and the treatment tank 61. Thus, a sufficient amount of copper ions contained in the waste water can be recovered as copper metal by electrolytic deposition. When the concentration of copper ions in the waste water is reduced down to a predetermined value by electrolytic deposition, the waste water is circulated through valves 59 between the ion exchange unit 54 and the treatment tank 61. Thus, the remaining copper ions can be almost completely removed from the waste water. The waste water from which copper ions are almost completely removed is discharged as treated water 55 from the treatment tank 61. In this case, a measuring device 56 for measuring the concentration of copper ions may be disposed in the treatment tank 61. The measuring device 56 measures the concentration of copper ions in the waste water and controls opening or closing of the valves 58, 59 provided between the treatment tank 61 and the electrolytic deposition unit 53 and between the treatment tank 61 and the ion exchange unit 54 in accordance with the measured concentration. In FIG. 9, although the two valves 58 are provided between the treatment tank 61 and the electrolytic deposition unit 53, and the two valves 59 are provided between the treatment tank 61 and the ion exchange unit 54, one or more valves may be sufficient, respectively.

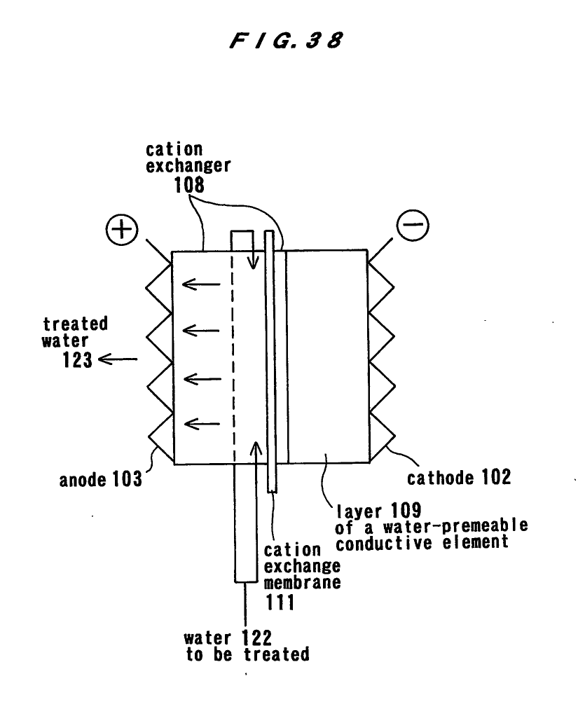

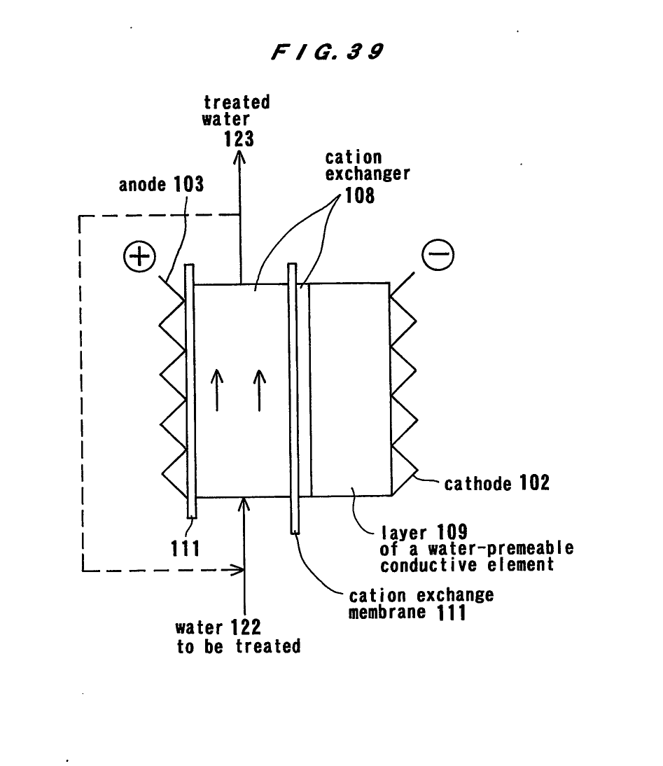

FIGS. 40A, 40B, 41 and 47 show apparatuses for carrying out electrolytic deposition operation for concentrated water having concentrated metal ions, using electrodialysis operation which is a form of ion exchange operation. As shown in FIGS. 40A, 40B, 41 and 47, metal ions are removed from water 15 to be treated by electrodialysis operation, whereby treated water 55 having a decreased metal ion concentration is obtained. The concentrated water 44 containing metal ions is subjected to electrolytic deposition operation in an electrolytic deposition apparatus 45, and hence the metal ions are recovered in the form of metal. Since the concentrated water 44 has a higher metal ion concentration than the water 15 to be treated, electrolytic deposition operation can be carried out with a low voltage. In the electrodialysis operation, liquid to be treated may be supplied to a cathode-side chamber adjacent to a concentrating chamber 41, or an acid or salt solution containing sulfate ion (SO₄²⁻), nitrate ion (NO₃⁻), chlorine ion (Cl⁻), or the like may be supplied to the cathode-side chamber, instead of the liquid to be treated. It is possible to provide a buffer chamber 43 between a concentrating chamber 41 and a desalting chamber 42 for the purpose of reducing the ion concentration difference between the chambers 41 and 42 (see FIG. 41). The desalting chamber 42 is filled with a cation exchanger. The concentrating chamber 41 may be filled with a cation exchanger or an anion exchanger. The buffer chamber 43 may be filled with the cation exchanger, and may be provided with a cation-exchange membrane 111 at the boundary between the buffer chamber 43, and the desalting chamber 42 or the concentrating chamber 41. Pure water may be supplied to the buffer chamber 43 continuously or may be circulated through the buffer chamber 43. In the case of circulation, an ion-exchange resin layer may be provided in a circulation line, so that the ion concentration can be stabilized at a low level over a long period of time.

In the apparatuses as shown in FIGS. 40A, 40B, 41 and 47, such an ion exchange operation that can electrically regenerate the ion exchanger is employed. An ion exchange operation that can effect an electrical regeneration in a continuous manner is preferred. Metal ions are removed from water 15 to be treated by such ion exchange operation. Since the ion exchanger is regenerated electrically, replacement of the ion exchanger is not necessary. The metal ion-concentrated water 44 is subjected to electrolytic deposition operation in the electrolytic deposition apparatus 45, whereby metal ions are recovered in the form of a metal, a metal oxide or a metal hydroxide. Treated water from the electrolytic deposition operation is returned to the ion exchange operation, whereby the treated water can be circulated as raw water for metal ion-concentrated water 44. The metal ion-concentrated water 44 has a metal ion concentration as high as not less than 1000 ppm, thus enabling the deposition operation at a low voltage. In the ion exchange operation, it is preferred to allow an acid or salt solution containing SO₄²⁻, NO₃⁻, etc. to be present in the cathode-side chamber adjacent to the concentrating chamber 41. Anions such as SO₄²⁻ concentrated in the concentrating chamber 41 can be recovered and reused by providing dialysis operation, such as electrodialysis or diffusion dialysis, in the concentrated water line. According to the present method, because water 15 to be treated is not directly subjected to the electrode reaction, the present method has the advantage that the water 15 to be treated is unlikely to suffer alteration of dissolved matter due to the electrode reaction, influence of pH change, and the like.

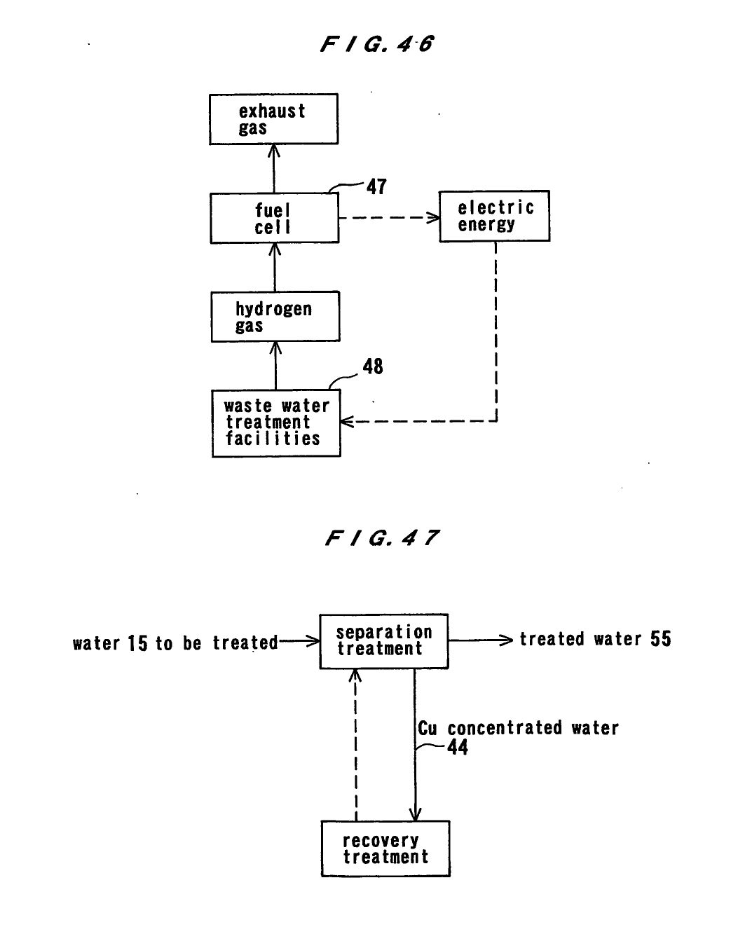

Next, a treatment flow shown in FIG. 47 will be described in detail. Water 15 to be treated is subjected to a separation treatment in an electrodialysis apparatus to thus obtain Cu concentrated water 44. Then, the Cu concentrated water 44 is subjected to a recovery treatment. The recovered treated water may be returned to the separation treatment as shown by a dotted line. The recovery treatment may be carried out by an electrolytic deposition apparatus. The separation treatment may be carried out by a known electrodialysis apparatus. The separation treatment and the recovery treatment may be connected in parallel, or in series. An electrodialysis operation or a diffusion dialysis operation may be further provided in the recovery line to recover anions and to supply the recovered anions to the cathode chamber.

As described above, according to the present invention, various kinds of water containing metal ions in a wide range of concentrations can be treated properly in accordance with the concentration of the metal ions. Specifically, an apparatus for treating waste water according to the present invention can treat waste water from a CMP process which generally has a copper concentration of 100 mg/l or lower, rinsing water from a plating process which generally has a copper concentration of 100 mg/l or lower, and waste plating solution from a plating process which generally has a copper concentration of 2000 mg/l to 10%. With the apparatus for treating waste water according to the present invention, treated water having a lowered concentration of copper can be obtained, and a sufficient amount of copper ions can be recovered as copper metal from the waste water.

According to another embodiment of the present invention, a cation exchanger is incorporated into an electrolytic deposition apparatus. When a cation exchanger is incorporated into an electrolytic deposition apparatus, metal ions (cations) are captured by the cation exchanger. Further, when an ion exchanger is disposed in an electrolytic field, reaction fields (water dissociation fields) are formed for decomposing water molecules, so that a voltage for operating the electrolytic deposition apparatus is lowered. Further, the voltage (theoretical electrolytic voltage+overvoltage) at which water molecules begin to decompose varies depending on the combination of materials of the electrodes or water-permeable conductive element which contacts an ion exchanger. With platinum or copper having a low overvoltage, water decomposition occurs at a low voltage. On the other hand, carbon, lead, zinc, etc. having a high overvoltage require a higher voltage for water decomposition as compared to platinum or copper. Accordingly, in the case of an electrolytic deposition apparatus loaded with an ion exchanger between the electrodes, the occurrences of water decomposition on the cathode side and on the anode side can be controlled by properly selecting the material of the cathode including the water-permeable conductive element and the material of the anode.

By thus controlling the occurrence of water decomposition, the current efficiency can be greatly increased. The current efficiency means a ratio of currents which is represented by (3)/((3)+(4)+(5)) with use of the electrode reaction formulas described above. Therefore, water having a low concentration of metal ions, which cannot be treated by a conventional electrolytic deposition apparatus, can be treated by electrolytic deposition to efficiently remove and recover metal ions from the water.

Specifically, according to another embodiment of the present invention, an electrolytic deposition apparatus comprises an anode and a cathode opposed to each other, and a cation exchanger interposed between the anode and the cathode. In the electrolytic deposition apparatus, the cation exchanger is interposed between the anode and the cathode, and water to be treated is supplied between the electrodes while current is supplied to the electrodes. Some of metal ions (cations) in the water are deposited on the cathode, and the others are exchanged with cation exchange groups of the cation exchanger and captured by the cation exchanger. The metal ions captured by the cation exchanger are moved toward the cathode along a surface of the cation exchanger by a potential gradient produced between the electrodes, and deposited as metal on a surface of the cathode by electrode reaction. Thus, the metal ions are moved on the surface of the cation exchanger between the electrodes. Therefore, even if the concentration of the metal ions in the water becomes extremely low, it is possible to smoothly move ions without increasing a voltage for operation of the apparatus. When the cation exchanger is interposed between the electrodes, portions where the anode and the cation exchanger are brought into contact with each other serve as reaction fields (water dissociation reaction fields) in which water molecules are dissociated with a low voltage. Since the cation exchange groups are sequentially regenerated by H⁺ ions produced in the reaction fields, an electrolytic process can be continued with a low voltage.

As described above, according to the present invention, in an electrolytic deposition apparatus for removing and recovering metal ions from water to be treated by deposition due to electrolysis and electrode reaction, an cation exchanger is disposed between the anode and the cathode to control movement of metal ions in the water. Such an electrolytic deposition apparatus has not heretofore been known as long as the inventors has recognized.

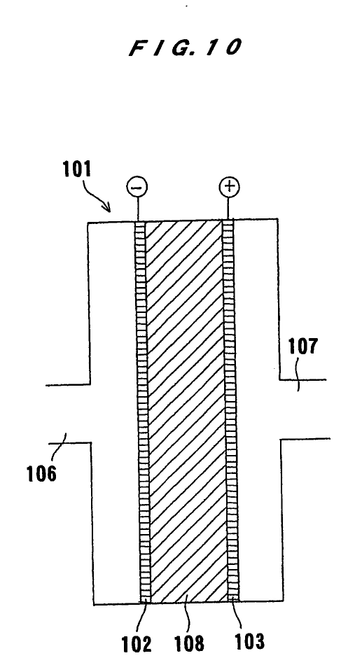

FIG. 10 shows an electrolytic deposition apparatus according to an embodiment of another aspect of the present invention, in which a cation exchanger is incorporated into the electrolytic deposition apparatus as shown in FIG. 3. The electrolytic deposition apparatus 101 shown in FIG. 10 has a cathode 102 and an anode 103 which are made of a water-permeable material, and a layer 108 of a cation exchanger disposed in an electrolytic chamber between the cathode 102 and the anode 103. The layer 108 of the cation exchanger should preferably be held in contact with both of the cathode 102 and the anode 103 in view of a stable voltage for operation of the apparatus. Nevertheless, the layer 108 of the cation exchanger may be held in contact with either the cathode 102 or the anode 103, or neither the cathode 102 nor the anode 103. The electrolytic deposition apparatus 101 has a water supply/discharge pipe 106 outside of the cathode 102 and a water supply/discharge pipe 107 outside of the anode 103. Waste water (water to be treated) is passed through composite layers composed of the cathode 102, the anode 103, and the cation exchanger.

When waste water is supplied through the pipe 107 and is discharged through the pipe 106 in the electrolytic deposition apparatus 101 shown in FIG. 10, the waste water is first passed through the anode 103 and then passed through the layer 108 of the cation exchanger, where metal ions (cations) contained in the waste water are exchanged with cation exchange groups of the cation exchanger 108 and adsorbed by the cation exchanger 108. The metal ions adsorbed by the cation exchanger 108 are attracted to the cathode 102 by a potential gradient and moved on the cation exchanger 108 toward the cathode 102. Then, the metal ions are deposited as metal on a surface of the cathode 102 by electrode reaction. In this manner, the metal ions are removed from the waste water by electrolytic deposition and recovered as metal, and the waste water is discharged as treated water from the pipe 106.

In the electrolytic deposition apparatus 101 shown in FIG. 10, waste water may be supplied through the pipe 106 and discharged through the pipe 107. In this case, the waste water is first passed through the cathode 102, where metal ions (cations) contained in the waste water are deposited as metal on a surface of the cathode 102 by electrode reaction. Then, the waste water is passed through the layer 108 of the cation exchanger, where the remaining metal ions in the waste water are exchanged with cation exchange groups of the cation exchanger 108 and adsorbed by the cation exchanger 108. The metal ions adsorbed by the cation exchanger 108 are attracted to the cathode 102 by a potential gradient and moved (returned) on a surface of the cation exchanger 108 toward the cathode 102. Then, the metal ions are deposited as metal on a surface of the cathode 102 by electrode reaction. The waste water is discharged as treated water from the pipe 107.

As described above, in the electrolytic deposition apparatus 101 shown in FIG. 10, waste water may be supplied through the pipe 107 and discharged through the pipe 106, or may be supplied through the pipe 106 and discharged through the pipe 107. In experiments carried out by the inventors, the efficiency of removal of metal ions was higher when waste water was passed from a cathode to an anode, i.e., the remaining metal ions that had not been captured by the cathode were captured by a subsequent cation exchanger, then returned to the cathode by a potential gradient, and deposited on the cathode. Thus, the method in which waste water is passed from the cathode to the anode is preferable.

The layer of the cation exchanger provided in the electrolytic deposition apparatus is required to have a sufficient water-permeability as a layer. Such a water-permeable layer of a cation exchanger may be formed by, for example, filling beads of cation exchange resin into a predetermined position of the apparatus (in FIG. 10, a position between the anode 103 and the cathode 102). A cation exchange fiber material or a cation conductive spacer may be filled between the cathode 102 and the anode 103.

In the electrolytic deposition apparatus as shown in FIG. 10, resin bead materials, fiber materials, or spacers which have chelate group such as iminodiacetic acid group may be filled in the electrolytic chamber. Alternatively, these materials may be mixed with the aforementioned cation exchanger and filled in the electrolytic chamber.

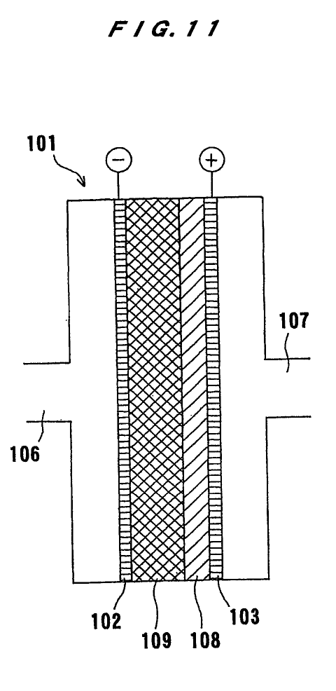

Further, in the electrolytic deposition apparatus as shown in FIG. 10, a water-permeable conductive layer should preferably be disposed so as to contact the cathode in the electrolytic chamber formed between the electrodes and a layer of a cation exchanger should preferably be filled between the water-permeable conductive layer and the anode for thereby increasing a substantial surface area of the cathode. FIG. 11 shows an electrolytic deposition apparatus according to an embodiment of still another aspect of the present invention, in which a water-permeable conductive layer is disposed so as to contact a cathode in the electrolytic deposition apparatus as shown in FIG. 10. The electrolytic deposition apparatus shown in FIG. 11 has a cathode 102 and an anode 103 which are made of a water-permeable material, a layer 109 of a water-permeable conductive element which is disposed between the cathode 102 and the anode 103 and held in contact with the cathode 102, and a layer 108 of a cation exchanger which is disposed between the layer 109 of the conductive element and the anode 103 and held in contact with the layer 109 of the conductive element and the anode 103. The layer 108 of the cation exchanger should preferably be held in contact with both of the layer 109 of the conductive element and the anode 103 in view of a stable voltage for operation of the apparatus. Nevertheless, the layer 108 of the cation exchanger may be held in contact with either the cathode or the anode, or neither the cathode nor the anode. The electrolytic deposition apparatus 101 has a water supply/discharge pipe 106 outside of the cathode 102 and a water supply/discharge pipe 107 outside of the anode 103. Waste water (water to be treated) is passed through composite layers composed of the cathode 102, the anode 103, the layer 108 of the cation exchanger, and the layer 109 of the conductive element.

When waste water is supplied through the pipe 107 and discharged through the pipe 106 in the electrolytic deposition apparatus 101 shown in FIG. 11, the waste water is first passed through the anode 103 and then passed through the layer 108 of the cation exchanger, where metal ions (cations) contained in the waste water are exchanged with cation exchange groups of the cation exchanger 108 and adsorbed by the cation exchanger 108. The metal ions adsorbed by the cation exchanger 108 are attracted to the cathode 102 by a potential gradient and moved on the cation exchanger 108 toward the cathode 102. Since the water-permeable conductive element 109 is held in contact with the cathode 102, the water-permeable conductive element 109 serves as a cathode. Therefore, the metal ions which have been moved on the cation exchanger 108 are deposited as metal on a surface of the water-permeable conductive element 109 serving as a cathode by electrode reaction. In this manner, the metal ions are removed from the waste water by electrolytic deposition and recovered as metal, and the waste water is discharged as treated water from the pipe 106.

In the electrolytic deposition apparatus 101 shown in FIG. 11, waste water may be supplied through the pipe 106 and discharged through the pipe 107. In this case, the waste water is first passed through the cathode 102, and then passed through the layer 109 of the water-permeable conductive element. Since the water-permeable conductive element 109 is held in contact with the cathode 102, the water-permeable conductive element 109 serves as a cathode. While the waste water is passed through the layer 109 of the water-permeable conductive element, metal ions (cations) contained in the waste water are deposited as metal on a surface of the water-permeable conductive element 109 serving as a cathode by electrode reaction. Then, the waste water is passed through the layer 108 of the cation exchanger, where the remaining metal ions in the waste water are exchanged with cation exchange groups of the cation exchanger 108 and adsorbed by the cation exchanger 108. The metal ions adsorbed by the cation exchanger 108 are attracted to the cathode 102 by a potential gradient and moved (returned) on a surface of the cation exchanger 108 toward the cathode 102. Then, the metal ions are deposited as metal on a surface of the water-permeable conductive element 109 serving as a cathode by electrode reaction. The waste water is discharged as treated water from the pipe 107.

As described above, in the electrolytic deposition apparatus 101 shown in FIG. 11, waste water may be supplied through the pipe 107 and discharged through the pipe 106, or may be supplied through the pipe 106 and discharged through the pipe 107. In experiments carried out by the inventors, the efficiency of removal of metal ions was higher when waste water was passed from a cathode to an anode, i.e., the remaining metal ions that had not been captured by the water-permeable conductive element serving as a cathode were captured by a subsequent cation exchanger, then returned to the cathode by a potential gradient, and deposited on the cathode. Thus, the method in which waste water is passed from the cathode to the anode is preferable.

A conductive element used for this purpose is required to allow water to pass therethrough, i.e., to have a water-permeability. Such a conductive element may comprise an activated carbon fiber sheet as described above, a water-permeable foamed metal material, or the like.

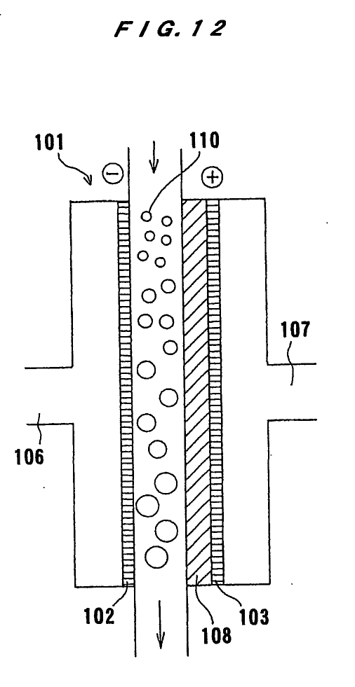

In the electrolytic deposition apparatus as shown in FIG. 10 in which a cation exchanger is disposed in an electrolytic chamber, conductive granular materials may be provided in the electrolytic chamber for increasing a substantial surface area of a cathode. FIG. 12 shows an electrolytic deposition apparatus according to an embodiment of still another aspect of the present invention, in which conductive granular materials are provided in the electrolytic deposition apparatus as shown in FIG. 10. In the electrolytic deposition apparatus 101 shown in FIG. 12, a layer 108 of a cation exchanger is disposed in an electrolytic chamber formed between a cathode 102 and an anode 103 and held in contact with the anode 103, and conductive granular materials 110 are provided between the layer 108 of the cation exchanger and the cathode 102. The conductive granular materials 110 are negatively charged in contact with the cathode 102, and metal ions in waste water are deposited on a surface of the conductive granular materials 110 by electrode reaction. The layer of the cation exchanger may not be brought into contact with the anode 103 or the conductive granular materials 110.

Metal ions that have not been captured by the conductive granular materials 110 are captured by the cation exchanger 108, and then attracted toward the cathode by a potential gradient between the cathode 102 and the anode 103. When the conductive granular materials 110 which have been negatively charged are brought into contact with the cation exchanger 108, the metal ions which have moved on a surface of the cation exchanger 108 are deposited as metal on surfaces of the conductive granular materials 110. Although water containing the conductive granular materials 110 flows from upward to downward in FIG. 12, it is possible to allow the water to flow upwardly. As described in connection with FIG. 5, the conductive granular materials 110 may continuously be supplied into and recovered from the electrolytic chamber with a water stream or the like, or may be supplied into and recovered from the electrolytic chamber in a batch manner. In the electrolytic deposition apparatus shown in FIG. 12, a layer 108 of the cation exchanger having no conductivity is disposed on the anode, unlike the electrolytic deposition apparatus shown in FIG. 5. Therefore, it is not necessary to dispose an insulating diaphragm (diaphragm 32 in FIG. 5) on the anode for preventing the conductive granular materials 110 which are negatively charged and the anode 103 from being brought into contact with each other. The conductive granular materials 110 may comprise various materials as described in connection with FIG. 5. In an electrolytic deposition apparatus as shown in FIG. 11 in which a water-permeable conductive element is held in contact with a cathode, conductive granular materials may be provided in a space formed between a layer 109 of the water-permeable conductive element and a layer 108 of the cation exchanger.

In a case where an ion exchange element is incorporated into an electrolytic deposition apparatus, an anion exchanger may be used in view of only a lowering of a voltage for operating the apparatus. In this case, although metal ions are not expected to be captured by the anion exchanger, a voltage for operating the apparatus can be lowered by water dissociation. When an anion exchanger is incorporated into an electrolytic deposition apparatus, portions where the anode and the anion exchanger are brought into contact with each other serve as reaction fields (water dissociation fields) in which water molecules are dissociated with a low voltage, and OH⁻ ions are produced. Since the anion exchange groups of the anion exchanger are sequentially regenerated by OH⁻ ions, an electrolytic process can be carried out with a low voltage. Therefore, when waste water has a low concentration of metal ions, an anion exchanger may be disposed in the electrolytic deposition apparatus. In this case, treated water discharged from the electrolytic deposition apparatus is introduced again into the electrolytic deposition apparatus in a batch manner, and these processes are repeated to achieve a high efficiency of removal of metal ions. Specifically, according to a wider aspect of the present invention, the electrolytic deposition apparatus has an anode and a cathode opposed to each other, and an ion exchange element interposed between the anode and the cathode. According to the present method, in some cases, metal ions are removed from water in the form of a metal hydroxide or a metal oxide under the influence of OH⁻ ions. The treatment efficiency can be enhanced by making use of such an effect.

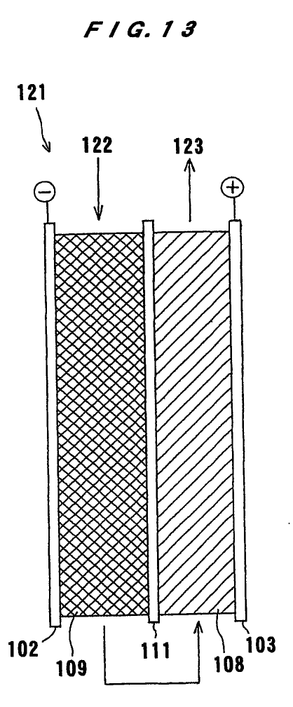

Further, a cation exchange membrane may be disposed between a layer of a conductive element and a layer of a cation exchanger for promoting movement of metal ions. FIG. 13 shows an electrolytic deposition apparatus according to an embodiment of still another aspect of the present invention, in which a cation exchange membrane is disposed between a layer of a conductive element and a layer of a cation exchanger. The electrolytic deposition apparatus 121 shown in FIG. 13 has a layer 109 of a conductive element disposed in an electrolytic chamber formed between a cathode 102 and an anode 103 so as to contact the cathode 102, a layer 108 of a cation exchanger disposed in the electrolytic chamber so as to contact the anode 103, and a cation exchange membrane 111 interposed between the layer 109 of the conductive element and the layer 108 of the cation exchanger. For example, in the electrolytic deposition apparatus 121 shown in FIG. 13, waste water 122 containing metal ions is passed through the layer 109 of the conductive element, and then passed through the layer 108 of the cation exchanger. In this case, metal ions in the waste water are deposited on a surface of the conductive element 109 serving as a cathode. The remaining metal ions that have not been captured by the conductive element 109 are captured by the cation exchanger while the waste water is passed through the layer 108 of the cation exchanger. The metal ions captured by the cation exchanger 108 are attracted toward the cathode by a potential gradient, then passed through the cation exchange membrane 111 to the layer 109 of the conductive element, and deposited as metal on the surface of the conductive element 109 serving as a cathode. Treated water 123 from which metal ions have been removed is discharged from the layer 108 of the cation exchanger. In such an electrolytic deposition apparatus, the cathode 102 and the anode 103 are not necessarily required to have a water-permeability, respectively. In the electrolytic deposition apparatus shown in FIG. 13, waste water may be passed in an opposite direction. Specifically, waste water may be passed through the layer 108 of the cation exchanger, and then passed through the layer 109 of the conductive element. In order to prevent the cation exchange membrane from being damaged, a cation exchanger may be inserted as a cushioning member between the cation exchange membrane 111 and the layer 109 of the conductive element. A space may be provided between the cation exchange membrane and the conductive element or between the cation exchange element and the conductive element. In some cases, metal ions are deposited in the form of fine needle crystals on the layer 109 of conductive element, and the crystals are broken in the course of their growth to produce fine metal particles. Further, in some cases, particles of copper oxide or copper hydroxide are produced. In order to remove such metal-containing fine particles produced in the conductive layer 109, a filtering equipment may be provided, and the water which has passed through the conductive layer may be passed through the cation exchanger layer 108. In this case, the water which has passed through the filtering equipment is supplied to the cation exchanger layer 108, whereby the ion exchange operation can be carried out stably.

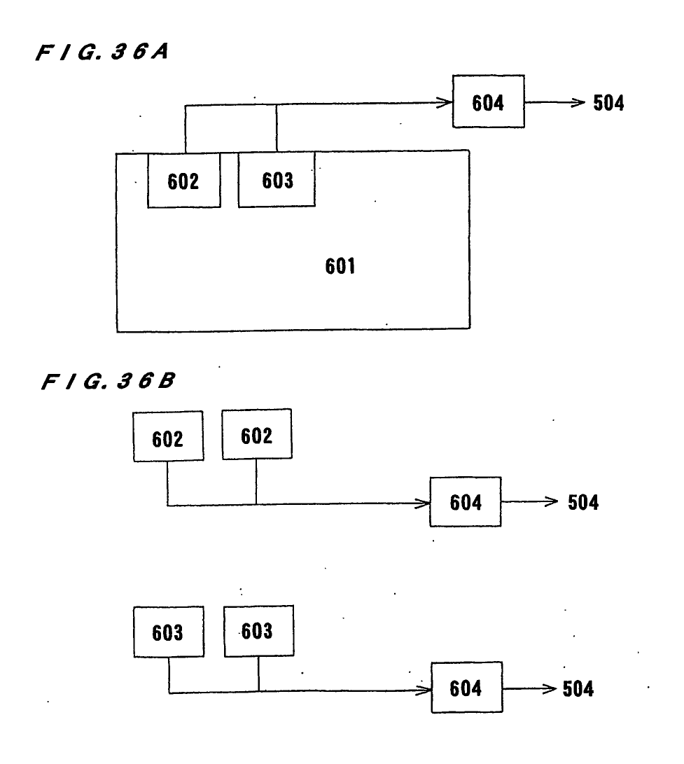

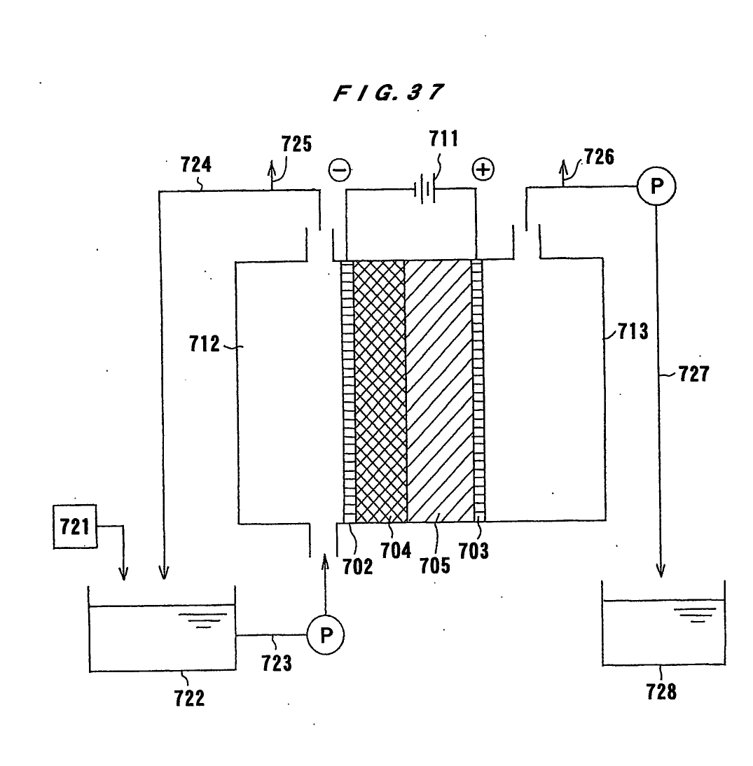

The apparatus may have structures as shown in FIGS. 38 and 39. As shown in FIG. 38, when water 122, to be treated, containing metal ions is passed through the cation exchanger layer 108 and is withdrawn from the water-permeable anode section 103, the metal ions are captured by the cation exchanger. The metal ions which have been captured by the cation exchanger are attracted to the cathode 102 due to potential gradient, and pass through the cation-exchange membrane 111 into the conductive layer 109, and are deposit as a metal on the conductive layer 109 serving as a cathode. Treated water 123, from which the metal ions have been removed, is thus obtained from the cation exchanger layer 108. In the case of such an apparatus, water-permeability is not necessarily required of the cathode material. Further, it is sufficient that the conductive layer serving as a cathode is immersed in the solution, and the solution is not necessarily required to flow. The water to be treated may be supplied to the cation exchanger from one supply location. However, it is preferred to supply the water to be treated from a plurality of supply locations in view of effective use of the ion exchanger. Further, as shown in FIG. 39, the water 122 supplied to the cation exchanger may be withdrawn directly from the cation exchanger layer 108. It is possible to return part of the treated water 123 withdrawn from the cation exchanger to the inlet portion of the cation exchanger as shown by a dotted line. In the case of such an apparatus, water-permeability is not required of the anode and cathode materials.

Next, relationship between an ion exchange element and a cathode in a case where an ion exchange element is incorporated into an electrolytic deposition apparatus will be described below. When an ion exchange element is incorporated into an electrolytic deposition apparatus, metal ions are captured by the ion exchange element, attracted to a cathode, and deposited on a surface of the cathode. In order to lower a voltage for operation of the apparatus, it is desirable that the ion exchange element is held in contact with the cathode. However, as metal ions are deposited on the cathode, the cathode increases its volume. When the ion exchange element is made of an ion exchange fiber material such as woven fabric or nonwoven fabric, the cathode may increase its volume while the cathode attracts fiber of the ion exchange fiber material thereto. Therefore, it may be necessary to remove the attached fiber from the cathode when metal is recovered from the cathode. From this point of view, it is desirable that a gap (e.g., a gap of 0.1 to 2 mm) is formed between the cathode and the ion exchange element. In order to form such a gap between the cathode and the ion exchange element, a spacer comprising water-permeable paper, nonwoven fabric, or diagonal mesh, or a frame may be inserted between the cathode and the ion exchange element. Although the relationship between the ion exchange element and the cathode has been described above, such relationship holds true between an ion exchange element and a water-permeable conductive element when a water-permeable conductive element serving as a cathode is provided in an electrolytic deposition apparatus.

Next, relationship between an ion exchange element and an anode in a case where an ion exchange element is incorporated into an electrolytic deposition apparatus will be described below. When an ion exchange element is incorporated into an electrolytic deposition apparatus, metal ions adsorbed by the ion exchange element are moved toward a cathode on a surface of the ion exchange element by a potential gradient. In this case, H⁺ ions produced by hydrolysis push out metal ions that are coupled to ion exchange groups, so that the metal ions are sequentially moved from one ion exchange group to another toward the cathode. However, when metal ions are moved while being pushed by H⁺ ions, the current efficiency may be lowered. In a case where waste water has a high concentration of metal ions, the current efficiency may be higher by moving metal ions in the waste water. From this point of view, in the electrolytic deposition apparatus 101 shown in FIG. 11, the anode 103 may be movable so as to space the anode 103 from the layer 108 of the ion exchange element when waste water has a high concentration of metal ions. Such an arrangement can improve the current efficiency with respect to movement of metal ions.

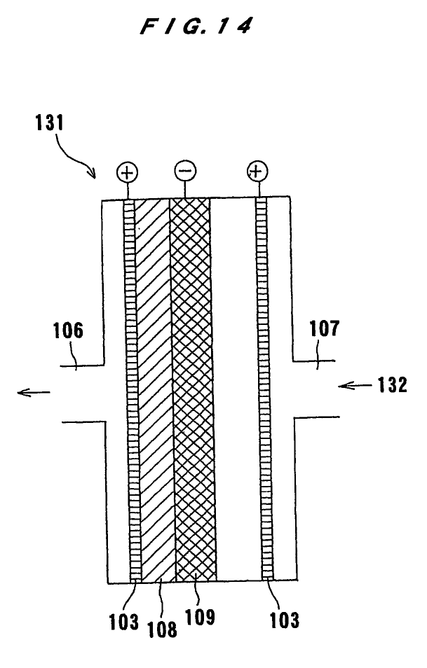

FIG. 14 shows an electrolytic deposition apparatus according to an embodiment of still another aspect of the present invention. The electrolytic deposition apparatus 131 shown in FIG. 14 has two anodes 103, a cathode 109 disposed between and spaced from the two anodes 103, and a layer 108 of an ion exchange element disposed in one of spaces between the anodes 103 and the cathode 109 so as to contact the anode 103 and the cathode 109. With this arrangement, an electrolytic deposition bath in which an ion exchange element is disposed in an electrolytic chamber formed between an anode and a cathode, and an electrolytic deposition bath in which an ion exchange element is not disposed in an electrolytic chamber formed between an anode and a cathode are connected to each other in series in one module. In the electrolytic deposition apparatus 131, when waste water (water to be treated) 132 is supplied through a water supply pipe 107, the waste water is subjected to a first-stage electrolytic deposition treatment in the electrolytic chamber having no ion exchange element, and then subjected to a second-stage electrolytic deposition treatment in the electrolytic chamber having an ion exchange element. Therefore, when waste water having a certain high degree of metal ion concentration is treated with the electrolytic deposition apparatus 131, rough recovery of metal ions is carried out by the first-stage electrolytic deposition treatment, and high level recovery (polishing) of the metal ions is carried out by the second-stage electrolytic deposition treatment.

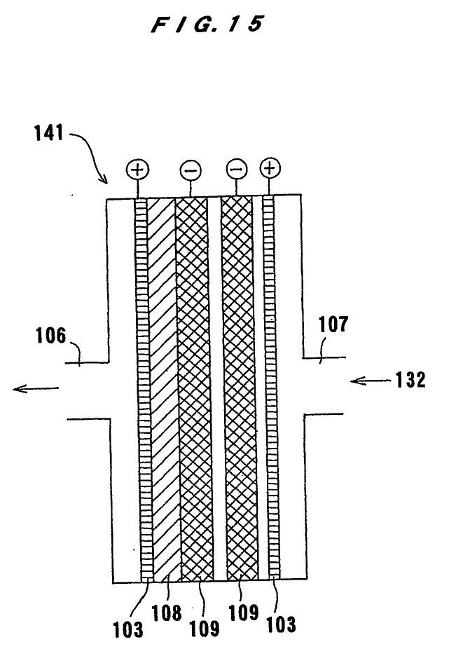

FIG. 15 shows an electrolytic deposition apparatus according to an embodiment of still another aspect of the present invention. In the electrolytic deposition apparatus 141 shown in FIG. 15, there are provided a first anode 103, a first cathode 109 spaced from the first anode 103, a second cathode 109 spaced from the first cathode 109, an ion exchange element 108 held in contact with the second cathode 109, and a second anode 103 held in contact with the ion exchange element 108, in the order of a flow of waste water 132. In this case, the first anode 103 and the first cathode 109 may be exchanged with each other, and the second cathode 109 and the second anode 103 may be exchanged with each other.

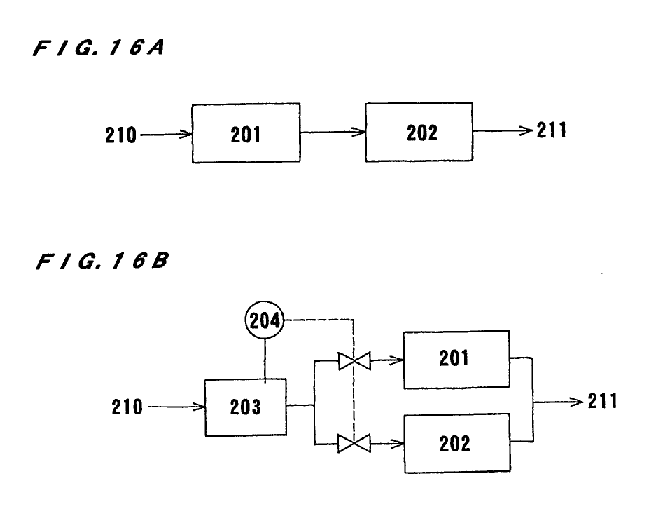

Further, it is also possible to constitute a treatment apparatus by combining an electrolytic deposition apparatus of the type which does not use an ion exchanger in the electrolytic chamber as shown in FIGS. 3 through 5, with an electrolytic deposition apparatus of the type which uses an ion exchanger in the electrolytic chamber as shown in FIGS. 10 through 13. For example, as shown in FIG. 16A, an electrolytic deposition apparatus 201 of the type which does not use an ion exchanger in the electrolytic chamber and an electrolytic deposition apparatus 202 of the type which uses an ion exchanger in the electrolytic chamber may be connected in series. Water 210, to be treated, containing metal ions is allowed to pass through the first-stage electrolytic deposition apparatus 201 to carry out a rough recovery of metal ions, and the thus treated water is allowed to pass through the second-stage electrolytic deposition apparatus 202 to carry out a fine recovery of metal ions. The water, to be treated, containing metal ions at a certain high level of concentration, can thus be treated to remove metal ions therefrom and obtain treated water 211. As an alternative, as shown in FIG. 16B, the electrolytic deposition apparatuses 201, 202 may be connected in parallel. Water 210 to be treated is first received in a water tank 203, where the metal ion concentration of the water is measured by means of a metal ion measurement device 204. Based on the measured value, the water may be passed through an appropriate electrolytic deposition apparatus suitable for the metal concentration to carry out removal and recovery of metal ions. If necessary, the treated water 211 obtained from the above treatment apparatus may further be subjected to the above-described ion exchange operation to thoroughly remove the metal ions in the water.

The embodiments of loading an ion exchanger in the electrolytic deposition apparatus and the variations, described above with reference to FIG. 10 and the following drawings, can also be applied to an electrolytic deposition apparatus of the type in which the electrodes are immersed in the electrolytic bath as shown in FIG. 2.

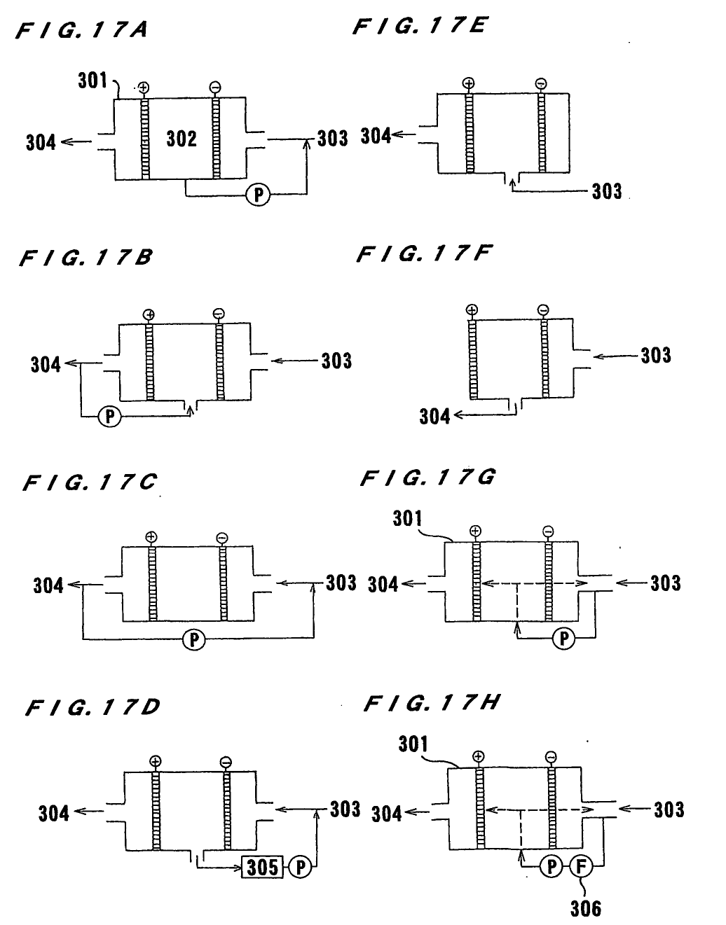

Various embodiments of methods of flowing water in an electrolytic deposition apparatus of the type in which the electrolytic chamber is formed between water-permeable electrodes as shown in FIGS. 3, 4, 10 and 11, will be described with reference to FIGS. 17A through 17F. In FIGS. 17A through 17F, the reference numeral 301 denotes an electrolytic deposition apparatus, 302 denotes an electrolytic chamber between electrodes, 303 denotes water to be treated, and 304 denotes treated water. As shown in FIG. 17A, water 303 to be treated may be supplied into the electrolytic deposition apparatus 301, and at least part of the treated water may be recovered from the electrolytic chamber 302 and returned to the water introduction line. In another embodiment, as shown in FIG. 17B, at least part of the treated water 304 which has passed through the electrolytic deposition apparatus 301 may be returned to the electrolytic chamber 302. In still another embodiment, as shown in FIG. 17C, at least part of the treated water 304 which has passed through the electrolytic deposition apparatus 301 may be returned to the water introduction line. In still another embodiment, as shown in FIG. 17D, at least part of the treated water may be recovered from the electrolytic chamber, and after removing fine particles of copper, copper oxide, or copper hydroxide, and the like from the water by means of a filter 305 or the like, such treated water may be returned to the water introduction line. Instead of the filter, it is possible to use an acid injecting device for injecting an acid capable of dissolving copper oxide or copper hydroxide. The injecting device may be used together with the filter. In still another embodiment, as shown in FIG. 17E, water 303 to be treated may be supplied directly into the electrolytic chamber between the two electrodes. According to this embodiment, it is not necessary to use a water-permeable structure as the cathode. Further, in still another embodiment, the treated water 304 may be taken out directly from the electrolytic chamber as shown in FIG. 17F. As shown in FIG. 17G, it is possible to introduce part of the water 303 to be treated into the electrolytic chamber 302 to circulate the water. As shown in FIG. 17H, a filter 306 may be provided in the circulation line. It is possible to provide an acid injection device instead of the filter 306, or to use both of them. Though FIGS. 17A through 17H do not show the case of loading an ion exchanger layer or a conductive layer in the electrolytic chamber, the same operation for flowing water is possible also with the case of loading these layers in the electrolytic chamber. Further, though FIGS. 17A through 17H show the case of passing water to be treated in the order of cathode-anode, the various methods for flowing water shown in FIGS. 17A through 17H may be employed also with the case of passing water to be treated in the order of anode-cathode.

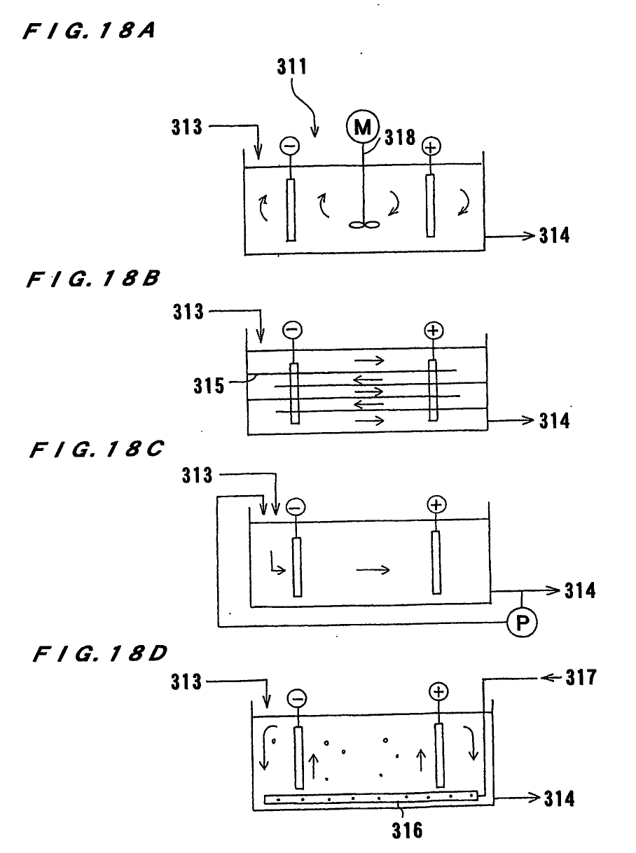

Various embodiments of methods for flowing water (stirring methods) in an electrolytic deposition apparatus of the type in which the electrodes are immersed in the electrolytic bath as shown in FIG. 2, will now be described with reference to FIGS. 18A through 18D. In FIGS. 18A through 18D, the reference numeral 311 denotes an electrolytic bath, 313 denotes water to be treated, and 314 denotes treated water. The arrows in the electrolytic bath indicate the flow of water to be treated. As shown in FIG. 18A, a mechanical stirring device 318, such as a stirring impeller, may be provided in the electrolytic bath, thereby, stirring and flowing water to be treated in the electrolytic bath. The impeller may be provided at a position other than the position between the electrodes. As shown in FIG. 18B, partition plates 315 may be disposed in the electrolytic bath, thereby stirring and flowing water to be treated in the electrolytic bath. As shown in FIG. 18C, at least part of the treated water may be recovered and re-introduced into the electrolytic bath by means of a pump to create a water flow, thereby stirring and flowing water to be treated in the electrolytic bath. Further, as shown in FIG. 18D, a gas-diffusing device 316 may be provided in the electrolytic bath to blow a gas for stirring into the bath to create a water flow in the electrolytic bath, thereby stirring and flowing water to be treated in the electrolytic bath.

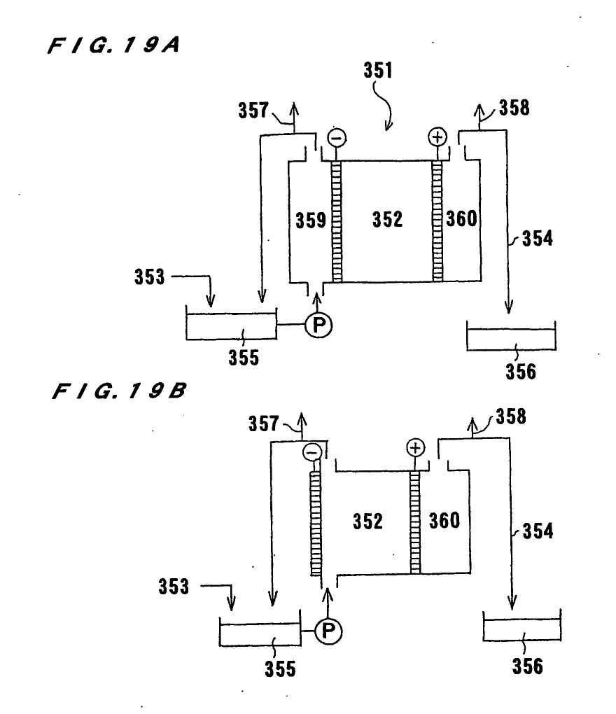

In carrying out electrolytic deposition treatment of water, to be treated, containing metal ions by an electrolytic deposition apparatus, gasses are generated by electrode reaction at the surfaces of electrodes. More specifically, hydrogen gas is generated at the surface of a cathode or a conductive element serving as a cathode, and oxygen gas is generated at the surface of an anode. The hydrogen gas and oxygen gas, when mixed, becomes a so-called detonating gas which makes a loud sound upon catching fire. Further, when a large volume of such gas catches fire, it can cause an explosion phenomenon. In a practical apparatus, therefore, it is desirable to take a measure for removing the gasses generated. FIGS. 19A and 19B show embodiments of treatment apparatuses for water to be treated using an electrolytic deposition apparatus adapted for removal of such gasses generated. In FIGS. 19A and 19B, the reference numeral 351 denotes an electrolytic deposition apparatus, 352 denotes an electrolytic chamber between electrodes, 353 denotes water to be treated, 354 denotes treated water, 355 denotes a water tank for water to be treated, and 356 denotes a water tank for treated water. In the electrolytic deposition apparatus shown in FIG. 19A, there are provided a water supply chamber 359, located adjacent to a cathode, to which water to be treated is supplied, and a treated water discharge chamber 360, located adjacent to an anode, from which the treated water is discharged. Part of water to be treated, which has supplied from the water tank 355 into the water supply chamber 359, passes through the cathode of the electrolytic deposition apparatus, the electrolytic chamber 352, and the anode, and metal ions in the water to be treated are deposited on the cathode and thus removed. The treated water, from which the metal ions have been removed, is received in the treated water discharge chamber 360, passed through a treated water discharge pipe 370 by means of a pump, and received in the treated water tank 356. The remainder of the water to be treated, supplied to the water supply chamber 359, passes through a water circulation pipe and is returned to the water tank 355.

Hydrogen gas generated at the surface of the cathode flows together with the circulating water to be treated, and is discharged from a gas vent 357. On the other hand, oxygen gas generated at the surface of the anode flows together with the treated water, and is discharged from a gas vent 358. By supplying water to be treated to the electrolytic processing apparatus of the present invention while circulating the water to be treated, it becomes possible to progress treatment of the water to be treated while preventing the gasses, generated from the both electrodes, from being mixed and while removing the gasses safely. Further, by controlling the supply amount of water to be treated and the discharge amount of treated water to thereby adjust the amount of water passing through the electrolytic deposition apparatus, it becomes possible to treat water having various concentrations of metals. In order to continue the electrolytic deposition reaction while removing the gasses generated, the electrodes and a water-permeable conductive layer should allow the gasses to pass therethrough. Therefore, the electrodes and the water-permeable conductive layer should preferably have gas-permeability in addition to the water-permeability. According to the electrolytic deposition apparatus shown in FIG. 19B, water to be treated is supplied along the surface of a cathode within the electrolytic chamber 352. Hydrogen gas generated at the surface of the cathode flows together with the circulating water to be treated, and is discharged from a gas vent 357. With such a construction, the cathode is not required to be water-permeable or gas-permeable. Depending on the material used, the amount of water to be treated, and the like, in some cases, gas is accumulated in the electrolytic chamber 352 between the electrodes. In this case, it is preferred to provide a gas vent means also in the electrolytic chamber between the cathode and the anode. Though FIGS. 19A and 19B show electrolytic deposition apparatuses in which water to be treated is allowed to pass from the cathode side to the anode side, the same apparatuses may be used in such a manner that the water to be treated is allowed to pass from the anode side to the cathode side. Though FIGS. 19A and 19B do not show the case of loading an ion exchanger layer or a conductive layer in the electrolytic chamber, the same water treatment operation is possible also with the case of loading these layers in the electrolytic chamber. Further, in the constructions shown in FIGS. 19A and 19B, at least part of the treated water may be circulated to the water tank 355. It is also possible to circulate only at least part of the treated water to the water tank 355 without circulating at least part of water to be treated to the water tank 355.

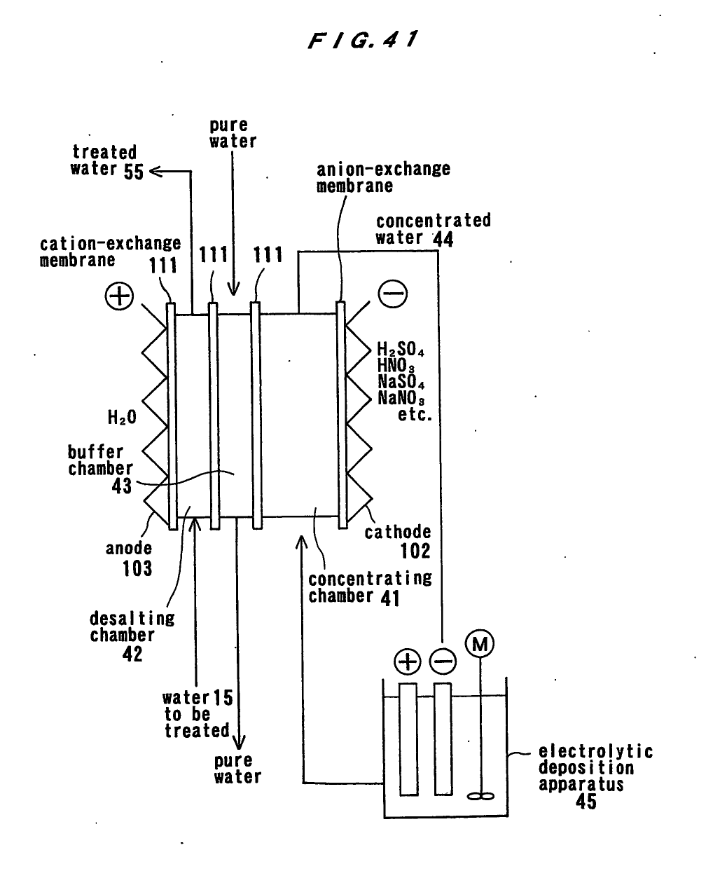

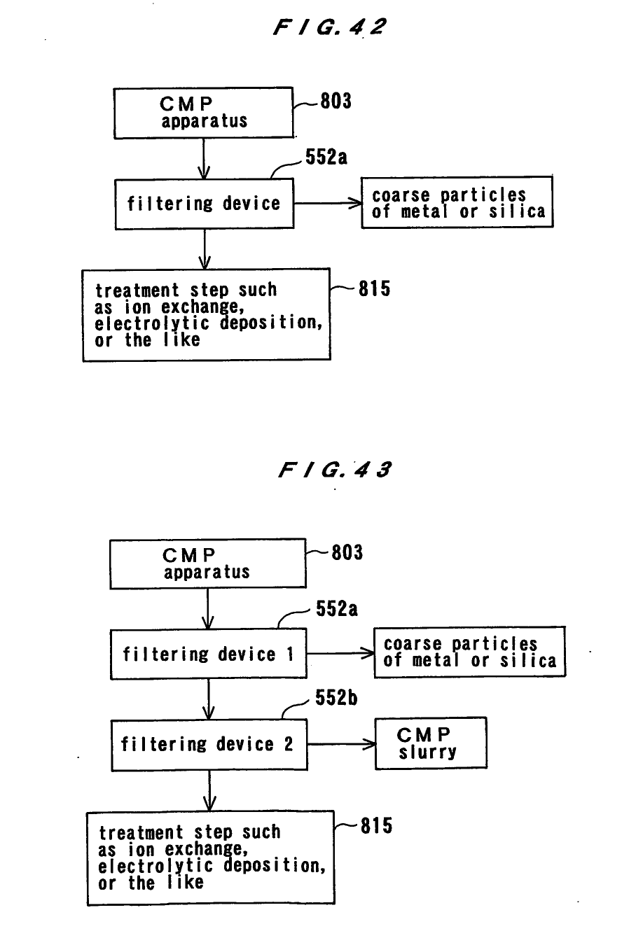

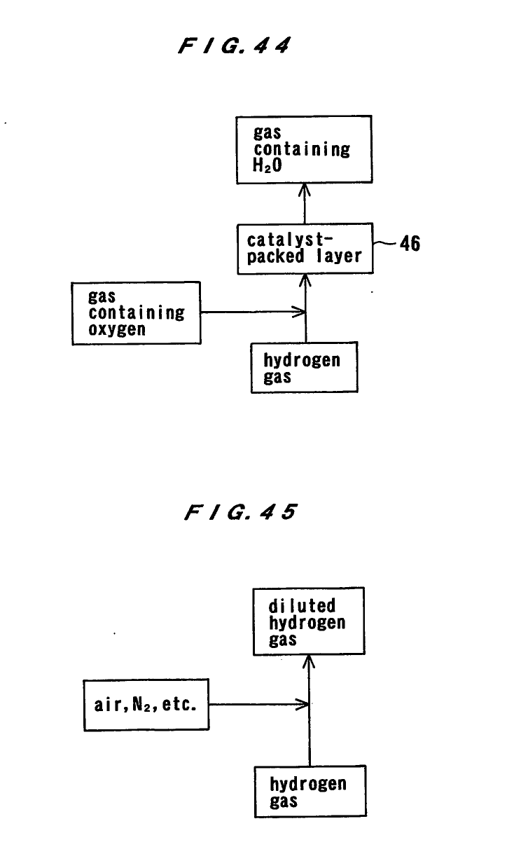

For treating hydrogen gas generated, the following methods may be employed as shown in FIGS. 44 through 46: A method in which hydrogen gas is mixed with a gas containing an equimolar or more oxygen, and the mixed gas is passed through a catalyst-packed layer 46, which is capable of recombining the hydrogen gas and the oxygen gas to produce water, to cause catalytic reaction, thereby making the concentration of the remaining hydrogen gas less than 4% by volume which is the explosion limit concentration (see FIG. 44); a method in which hydrogen gas is mixed with a large amount of air, an inert gas, and the like to lower the hydrogen concentration to less than the explosion limit concentration (see FIG. 45); and a method in which hydrogen gas is supplied to a fuel cell 47 (see FIG. 46). In the case of using the fuel cell 47, the electric energy obtained may be utilized for the operation of waste water treatment facilities 48 or other facilities.

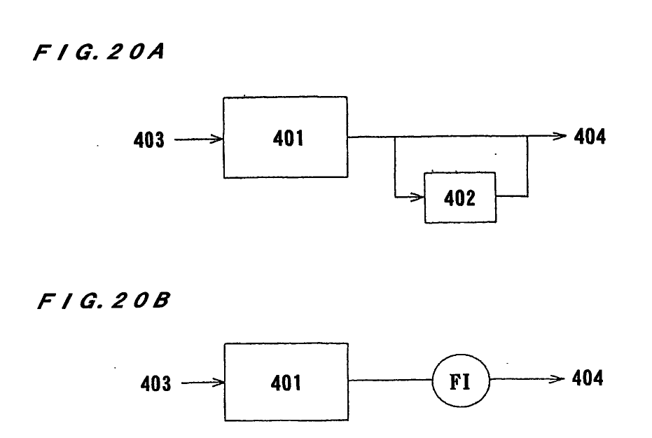

A method for monitoring the quality or quantity of treated water obtained by the above-described waste water treatment apparatus according to the present invention and detecting its abnormality will be described with reference to FIGS. 20A and 20B. In FIGS. 20A and 20B, the reference numeral 401 denotes a waste water treatment apparatus according to any one of the above-described embodiments of the present invention, 403 denotes water to be treated, and 404 denotes treated water. According to a first method, as shown in FIG. 20A, the concentration of metal ions of the treated water 404 obtained from the waste water treatment apparatus 401 according to the present invention is measured by means of a metal ion concentration measurement device 402. The measurement device may be designed such that it gives an alarm when the concentration of metal ions of the treated water becomes higher than a set value. In this case, a shortage of electric current in the electrolytic deposition apparatus, an increase in the concentration of metal ions of the raw water, and deterioration of an ion exchanger due to ion exchange treatment may be considered as the causes. These may be dealt with by a rise of operation current in the electrolytic deposition apparatus, replacement of the ion exchanger, or the like. Metal ion concentration measurement devices usable for this purpose may include measuring devices based on ion-selective electrode, electrode polarography, HPLC electrophoresis, fluorometry, etc. Further, as shown in FIG. 20B, the flow rate of treated water 404 obtained from the waste water treatment apparatus 401 according to the present invention, may be measured with a flow indicator (FI). When the amount of treated water becomes lower than a set value, the apparatus may give an alarm. In this case, blockade of water to be treated due to excessive deposition of metal in the electrolytic deposition apparatus, clogging of ion exchanger, shortage of introduction pressure of water at the water inlet, and the like may be considered as the causes. These may be dealt with respectively by replacement of the cathode or a conductive element, replacement of ion exchanger, a rise of pressure of water at the water inlet, etc. These countermeasures may be executed by automatic control effected in conjunction with measured values obtained in the measuring device.

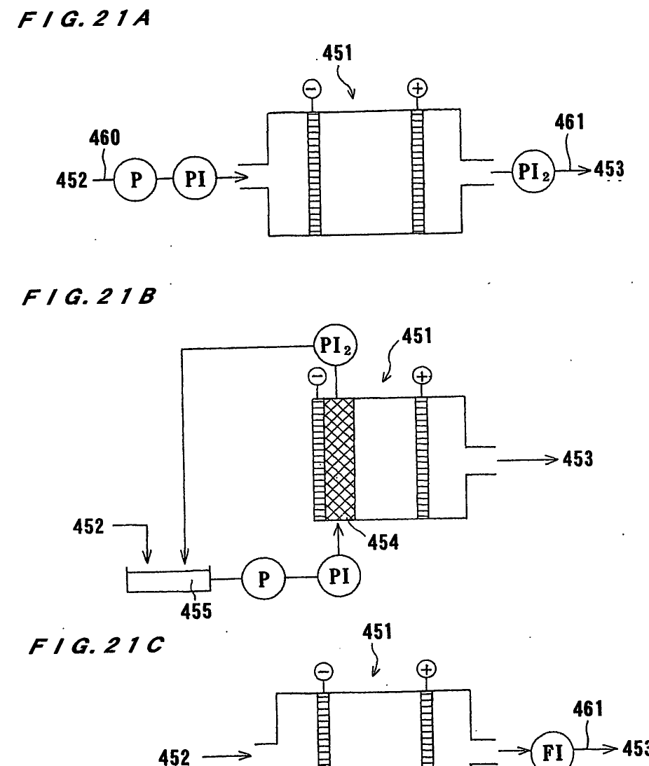

In the waste water treatment apparatus according to the present invention, the time for replacement of a cathode or a conductive element serving as a cathode in the electrolytic deposition apparatus can be determined by various methods as shown in FIGS. 21A through 21C. In FIGS. 21A through 21C, the reference numeral 451 denotes an electrolytic deposition apparatus, 452 denotes water to be treated, and 453 denotes treated water. According to a first method, as shown in FIG. 21A, a pressure indicator (PI) is disposed in a water supply line 460 for supplying water to be treated to the electrolytic deposition apparatus 451. The time for replacement of the cathode or the conductive element can be determined by monitoring the water supply pressure with the pressure indicator PI. When the water supply pressure exceeds a set value, there may occur blockage of the apparatus due to an increased deposition of metal onto the cathode or the conductive element. The cathode or the conductive element may therefore be replaced with a new one. Further, another pressure indicator (PI₂) may be disposed in a treated water line 461. The cathode or the conductive element may be replaced when the pressure difference between PI and PI₂ exceeds a set value. Further, as shown in FIG. 21B, a conductive layer 454 is disposed in contact with the cathode in the electrolytic chamber of the electrolytic deposition apparatus, water to be treated is supplied directly to the conductive layer, and part of the water to be treated is returned to a water tank 455 for water to be treated. In such electrolytic deposition apparatus, a pressure indicator (PI) may be disposed in the water introduction line for supplying water to be treated to the conductive layer and another pressure indicator (PI₂) may be disposed in the water circulation line of treated water from the conductive layer, whereby the same control as in the case of FIG. 21A can be effected. It is also possible to provide only the pressure indicator PI, and determine the replacement time when the supply pressure exceeds a set value. Further, as shown in FIG. 21C, it is possible to dispose a flow indicator (FI) in the treated water line 461, and replace the cathode or the conductive element when the flow rate of treated water becomes lower than a set value.

The electrolytic deposition apparatus according to the present invention can be applied to various recovery techniques, such as recovery of gold from a gold plating waste liquid, recovery of copper from a chemical mechanical polishing (CMP) waste liquid, an electrochemical polishing (ECP) waste liquid, a copper plating rinsing liquid or a copper plating waste liquid in a semiconductor device fabrication processes using copper interconnects, recovery of metal from other plating waste liquid, recovery of palladium contained in a high level waste liquid produced in a reprocessing step of a spent nuclear fuel, and recovery of cadmium from a food waste such as scallop.

According to the above-described waste water treatment systems of the present invention, especially the electrolytic deposition apparatus which has a cation exchanger in the electrolytic chamber between the electrodes, because the cation exchanger is provided between the electrodes, metal can be deposited stably and efficiently to thus be removed and recovered without a rise of operational voltage even for water, to be treated, having a low concentration of metal ions to be removed. Accordingly, the use of an electrolytic deposition apparatus according to the present invention can treat water having a metal ion concentration of not more than 200 mg/l, thereby obtaining treated water having a lowered metal ion concentration and recovering the metal, contained in the water to be treated, in the form of a metal element, or a mixture of metal element, metal oxide, and metal hydroxide. For example, by treating waste water containing copper ions discharged from a semiconductor device fabrication processes such as a CMP process, a copper plating process or an electrochemical polishing process by the present invention, a treated water having a copper concentration of not more than a discharge standard value can be obtained and copper can be recovered in the form of copper metal. The discharge standard value of copper is not more than 3.0 mg/l in Japan, and not more than 2.7 mg/l according to one standard in the United States. According to the present invention, it is preferred to obtain treated water having a copper ion concentration of not more than 1.0 mg/l, more preferably not more than 0.5 mg/l. According to the waste water treatment system of the present invention which employs electrolytic deposition treatment and ion exchange treatment in combination, by treating waste water containing copper ions from a semiconductor device fabrication processes, treated water having a copper ion concentration of not more than 0.5 mg/l can be obtained continuously while recovering copper as a metal or metal hydride or metal oxide. The copper concentration of CMP process waste water or copper plating waste water is usually not more than 100 mg/l. Accordingly, because of the problem of a rise of operational voltage, the electrolytic deposition method has not hitherto been employed for copper recovery treatment from the above waste water. According to the ion-exchange resin method, copper is adsorbed by an ion-exchange resin as metal ions and recovered. Further, according to the coagulating sedimentation, copper is precipitated and recovered in the form of hydroxide or oxide. In either method, an additional treatment is needed when reusing the recovered copper. Furthermore, for ion-exchange resin method, frequency in replacement of ion-exchange resin is high. However, according to the above-described method of the present invention, since copper is recovered as a metal element, the copper can be easily reused as a metal without the need for a subsequent treatment.

By applying the electrolytic deposition apparatus according to the present invention to treatment of waste water from a semiconductor device fabrication processes, such as a CMP process, an ECP process or a copper plating process, it becomes possible to construct a treatment system for such waste water. With respect to a waste water treatment apparatus for use in a clean room semiconductor plant, the apparatus is required to minimize its maintenance. Further, in some cases, a polishing liquid for use in the CMP process can contain as an additive an oxidizing agent, such as hydrogen peroxide, iron nitrate or sodium persulfate. Furthermore, after forming a copper film on the surface of a wafer in a copper plating process, the copper film adhering to a peripheral portion (edge portion) of the wafer or to the back surface of the wafer can peal off and contaminate the clean room. Accordingly, a so-called bevel-etching is carried out to remove the copper film adhering to the peripheral portion or the back surface of the wafer by dissolving the copper film with an acid, such as hydrochloric acid, sulfuric acid, citric acid or oxalic acid while oxidizing the copper film with an oxidizing agent such as hydrogen peroxide. Waste water from a CMP, an ECP, or a copper plating process used for forming copper interconnections thus frequently contains, besides a large amount of copper ions, an oxidizing agent such as hydrogen peroxide. Such an oxidizing agent, particularly hydrogen peroxide, can be easily decomposed by electrolysis, and electrolysis of hydrogen peroxide progresses in preference to electrolytic deposition of a heavy metal such as copper. If a large amount of hydrogen peroxide is contained in waste water, a larger electric current is required for electrolytic deposition. Further, if an oxidizing agent such as hydrogen peroxide is contained in the water to be treated, the problem of lowering of the function of ion exchanger arises. In addition, there is a fear of re-dissolution of the deposited metal, hydroxide or oxide. It is, therefore, preferred to construct a waste water treatment system in consideration of the presence of hydrogen peroxide.

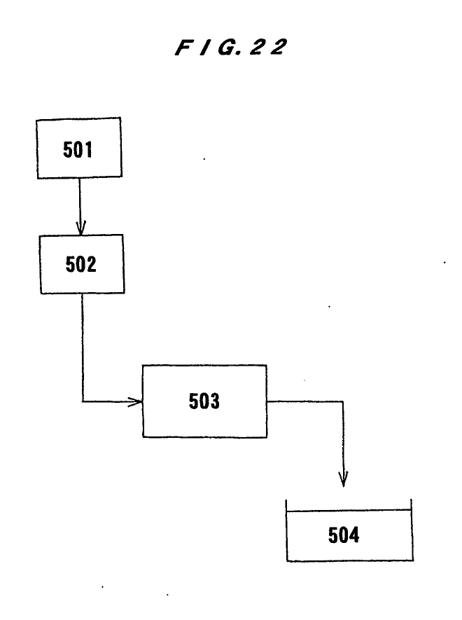

FIG. 22 shows an embodiment of a treatment system for waste water from a semiconductor device fabrication processes in view of the above. According to the system shown in FIG. 22, waste water from various processes 501, such as a CMP process, an ECP process, and a copper plating process, is first treated in an oxidizing agent removing step 502, and then treated in a waste water treatment apparatus 503 according to the present invention which employs electrolytic deposition operation and ion exchange operation in combination. By thus allowing the water to be treated to pass through the oxidizing agent removing step 502 before supplying the water to the waste water treatment apparatus according to the present invention, an oxidizing agent such as hydrogen peroxide in the water to be treated can be decomposed. The water, which has passed through the oxidizing agent removing step 502 to decompose and remove the oxidizing agent such as hydrogen peroxide, is supplied to the waste water treatment apparatus 503 according to the present invention, where metal ions such as copper ions in the water are removed by the combination of electrolytic deposition operation and ion exchange operation, and the treated water is received in a water tank 504. In this case, at least part of the treated water may be circulated to the waste water treatment apparatus 503 according to the present invention. In FIG. 22 and in the following description, “waste water treatment apparatus 503 according to the present invention” refers to a waste water treatment apparatus according to the present invention which employs the above-described combination of electrolytic deposition operation and ion exchange operation, and includes the combination of electrolytic deposition apparatus and ion exchange treatment described above with reference to FIGS. 6 through 9, etc., or the apparatus having an ion exchanger incorporated into the electrolytic deposition apparatus described above with reference to FIGS. 10 through 15, etc., and also includes all of the various methods for flowing water and control methods described above with reference to the relevant Figures.

As treatment processes usable for removing an oxidizing agent, such as hydrogen peroxide, contained in the above-described water to be treated, there may be catalytic decomposition with activated carbon, catalytic decomposition with a noble metal catalyst, e.g. a titania-supported platinum catalyst or an alumina-supported platinum catalyst, catalytic decomposition with a manganese dioxide catalyst, electrolysis, ultraviolet-ray treatment, ozone addition, decomposition treatment with a reducing agent such as hydrazine, sodium thiosulfate or sodium sulfite, and enzymatic hydrolysis with an H₂O₂ degrading enzyme (catalase), etc. When using a platinum catalyst such as an alumina-supported platinum catalyst, it is preferred to use a honeycomb-shaped catalyst because of its large specific surface area and increased decomposition rate. Further, a honeycomb-shaped catalyst can be provided with successive openings in the flow direction, so that particles smaller than the opening area may be passed through the openings without being accumulated in the catalyst. The honeycomb-shaped catalyst can therefore be advantageously used for decomposing an oxidizing agent contained in slurry-containing waste water such as CMP waste water.

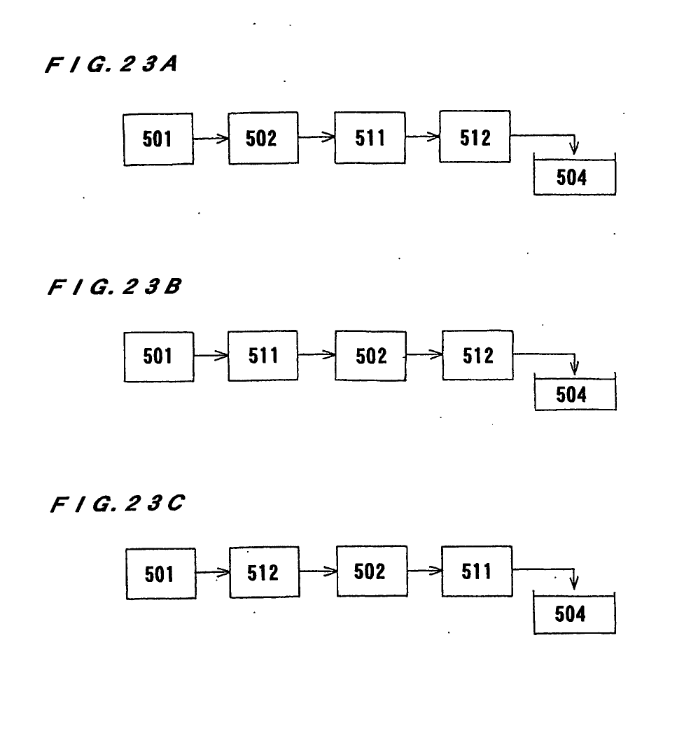

When the combination of ion exchange treatment and the electrolytic deposition apparatus of the type which does not use an ion exchanger in the electrolytic chamber, as described above with reference to FIGS. 6 through 9, is used as the waste water treatment 503 according to the present invention in the system of FIG. 22, the treatment may be carried out in the following various manners: As shown in FIG. 23A, waste water from various semiconductor device fabrication processes 501 may first be treated in the oxidizing agent removing step 502, and the thus-treated waste water may be treated in an electrolytic deposition apparatus 511 of the type which does not use an ion exchanger in the electrolytic chamber, and then in an ion exchange operation 512 to obtain treated water 504. Alternatively, as shown in FIG. 23B, the waste water may first be treated in the electrolytic deposition apparatus 511, and the thus-treated waste water may be subjected to the oxidizing agent removing step 502, and then to the ion exchange operation 512. Alternatively, as shown in FIG. 23C, the waste water may first be subjected to the ion exchange operation 512, then to the oxidizing agent removing step 502, and then be treated in the electrolytic deposition apparatus 511. In the system flow charts shown in FIG. 22 and the following figures, the same reference numeral denotes the same constituent element.

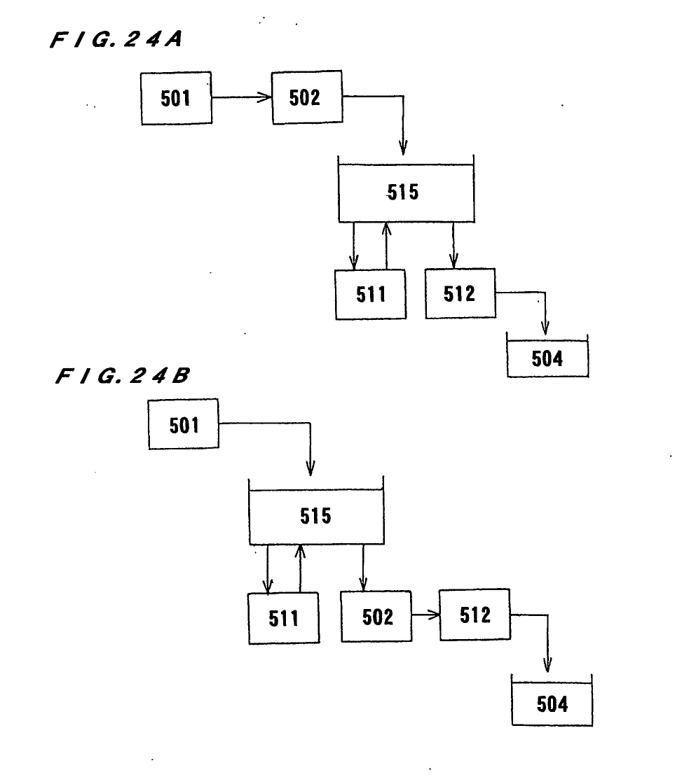

Further, as shown in FIG. 24A, the waste water may first be treated in the oxidizing agent removing step 502, and the discharge water may be received in a water tank 515 and circulated to the electrolytic deposition apparatus 511, whereby after removal of metal ions in the waste water, the remainder of metal ions can be removed by the ion exchange treatment 512 to obtain treated water 504. Alternatively, as shown in FIG. 24B, the waste water may be received in the water tank 515 and circulated to the electrolytic deposition apparatus 511, whereby after removal of metal ions in the waste water, the waste water can be treated in the oxidizing agent removing step 502, and then the remainder of metal ions can be removed by the ion exchange treatment 512 to obtain treated water 504. In the various systems shown in FIGS. 23 and 24, instead of the electrolytic deposition apparatus 511 of the type which does not use an ion exchanger in the electrolytic chamber, it is possible to use an electrolytic deposition apparatus of the type which uses an ion exchanger in the electrolytic chamber as shown in FIGS. 10 through 13, or use an electrolytic deposition apparatus of the type which does not use an ion exchanger in the electrolytic chamber and an electrolytic deposition apparatus of the type which uses an ion exchanger in the electrolytic chamber in combination as shown in FIGS. 14 through 16.

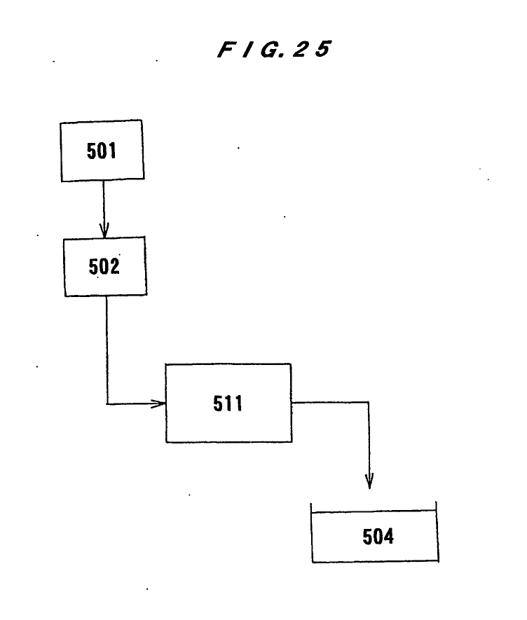

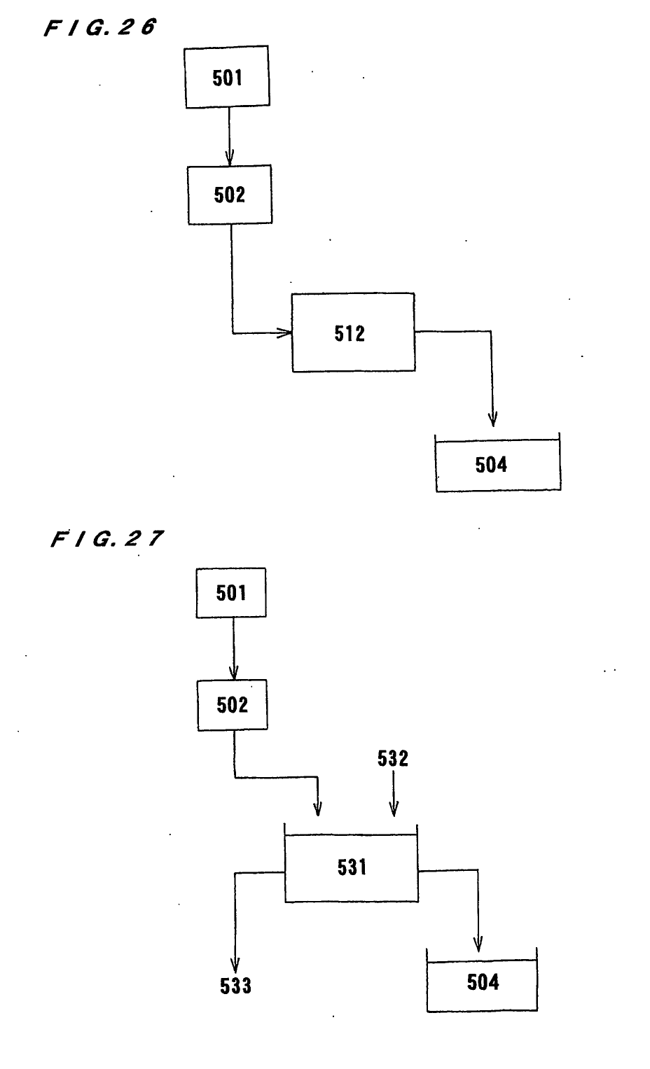

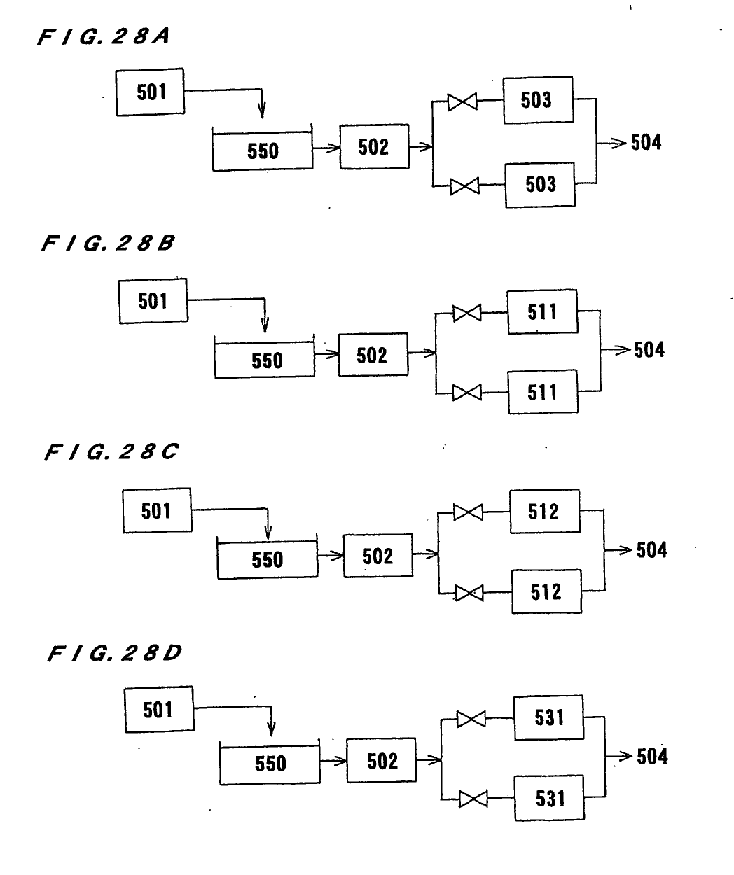

Further, in a system as shown in FIG. 22, it is possible to construct the system only with an ordinary electrolytic deposition apparatus 511 in which an ion exchanger is not disposed between the electrodes. FIG. 25 shows an embodiment of a system which employs such an electrolytic deposition apparatus. According to this system, water which has been treated in the oxidizing agent removing step 502 is subjected to an electrolytic deposition treatment in the electrolytic deposition apparatus 511 to remove and recover metal ions in the water to be treated, thereby obtaining treated water 504. Further, according to such system, as shown in FIG. 26, ion exchange treatment may be employed as a metal removal treatment. According to the system of FIG. 26, the water which has been treated in the oxidizing agent removing step 502 is subjected to an ion exchange treatment in the ion exchange operation 512 to remove metal ions in the water to be treated, thereby obtaining treated water 504. Ion exchangers usable in the ion exchange treatment of this system may include the above-described various ion-exchange resin beads, ion-exchange fibrous materials and ion-exchange spacers. These ion exchangers can be regenerated with an acid or alkali. The regeneration can also be effected electrochemically. An electrochemical regeneration is advantageous for its no-production of regeneration waste liquid. Further, it is possible to employ as a metal removal treatment a coagulating sedimentation treatment using a coagulant. According to the system shown in FIG. 27, the water which has been treated in the oxidizing agent removing step 502 is received in a coagulating sedimentation tank 531. In the coagulating sedimentation tank 531, a coagulant 532 is added to the water to be treated, whereby metal ions in the water to be treated are coagulated and precipitated, and removed from the water, while the supernatant liquid is recovered as treated water 504. The metal precipitated in the coagulating sedimentation 531 is recovered as a precipitate 533 and, if necessary, subjected to a subsequent treatment. As the coagulant 532 to be used in such a system for coagulating sedimentation metal ions in water to be treated, various chemicals known in the art as usable for coagulating and precipitating metal ions in an aqueous medium, can be used. Specific examples include an alkali such as NaOH, Ca(OH)₂ or KOH, a polymer coagulant, inorganic coagulant such as FeSO₄ and FeCl₃. When inorganic coagulant containing Fe²⁺ such as FeSO₄ is used, since Fenton reaction occurs, hydrogen peroxide and chelating agent are decomposed. Thus, using FeSO₄ is more preferable. A sludge produced by the coagulating treatment may be filtered through a membrane, such as an MF membrane which is generally used in waste water treatment.

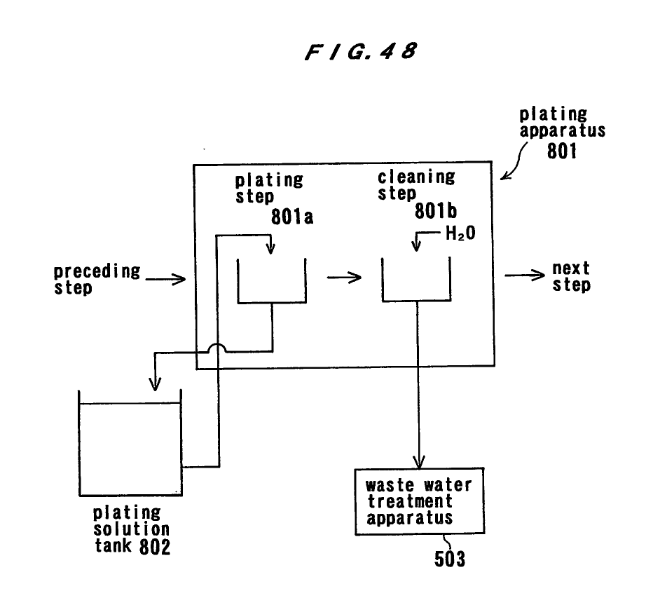

FIG. 48 shows a relationship between a plating apparatus and a waste water treatment system according to the present invention. The plating apparatus 801 includes a plating step 801a and a cleaning step 801b. In the plating step 801a, a plating solution is circulated between the plating step 801a and a plating solution tank 802. In the cleaning step 801b, the plating solution remaining on surfaces of a wafer after the plating step 801a is cleaned off with pure water, etc. The liquid discharged from the cleaning step 801b is introduced into the waste water treatment system 503 according to the present invention.

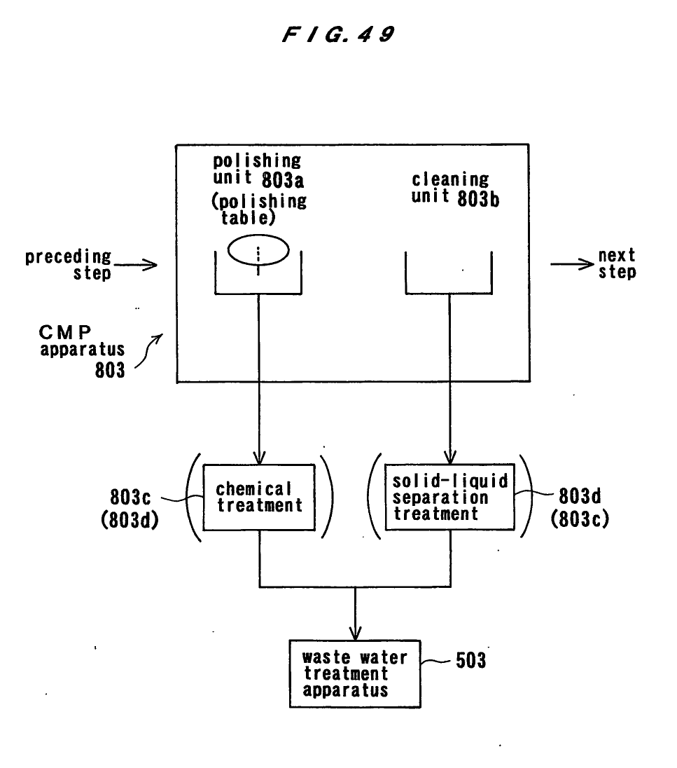

FIG. 49 shows a relationship between a CMP apparatus and a waste water treatment system according to the present invention. The CMP apparatus 803 includes a polishing unit 803a and a cleaning unit 803b. In the polishing step 803a, a wafer is polished. Liquids, such as pure water and a chemical liquid(s) containing a slurry, a dispersant, an acid, an alkali, a chelating agent, etc., are used in the polishing step 803a. Waste water from such liquids is introduced into the waste water treatment system 503. In the cleaning step 803b, the slurry, abrasive particles and the chemical liquid remaining on the wafer are cleaned off with pure water, etc. Such a cleaning waste water is also introduced into the waste water treatment system 503. The polishing unit 803a may be one that performs electrochemical polishing. Substances peculiar to the waste water discharged from the polishing step 803a and the cleaning step 803b is contained therein. In a case where such substances impede the waste water treatment, it is possible to remove the impediments in advance by means of a chemical treatment 803c, a solid-liquid separation treatment 803d, etc. (for example, separation of SS produced by edge-chipping, and dissolution or separation of a metal powder). The waste water treatment system herein may be one that performs at least one of ion exchange treatment and electrolytic treatment.

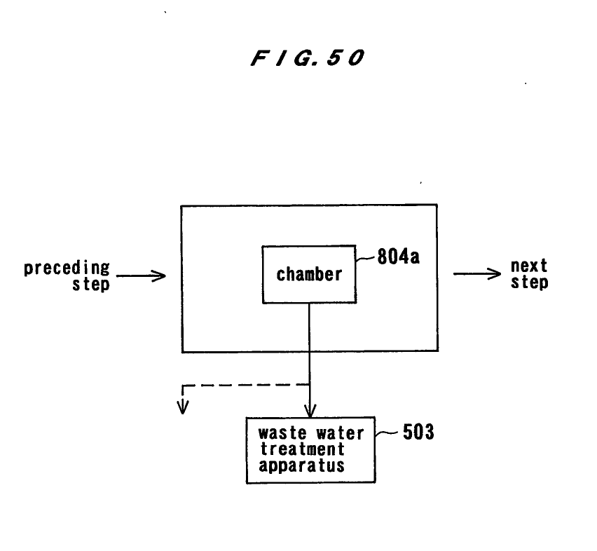

FIG. 50 shows a case of introducing waste water discharged from an apparatus that carries out etching and cleaning steps, or plating, etching and cleaning steps in the same chamber 804a into a waste water treatment system. An electrochemical method, such as electrochemical polishing, may be used in the etching step. Chemical mechanical polishing (CMP) may also be used. It is possible to introduce all the waste water from the respective steps into the waste water treatment system 503, or to introduce only the waste water from part of the steps into the waste water treatment system 503.

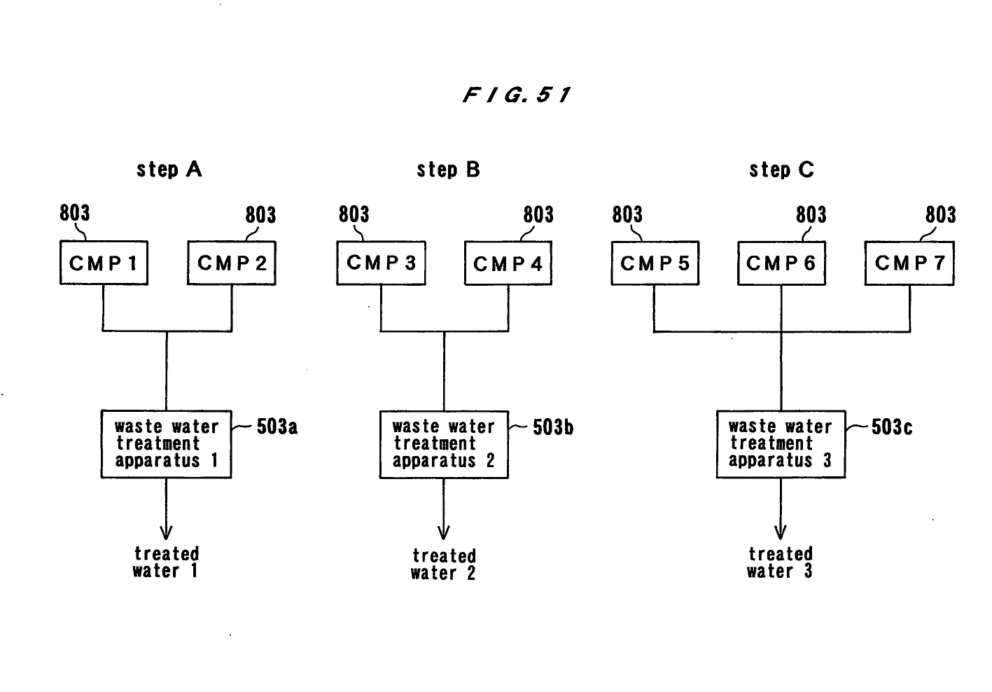

FIG. 51 shows a case of collectively treating waste water discharged from a plurality of apparatuses that perform an identical step. For example, of waste water from polishing apparatuses such as CMP apparatuses 803, waste water from a group of apparatuses that perform a certain identical step is collectively introduced into a waste water treatment apparatus 503a according to the present invention. Of waste water from CMP apparatuses 803, waste water from another group of apparatuses that perform a different step is collectively treated separately in a waste water treatment apparatus 503b or 503c.

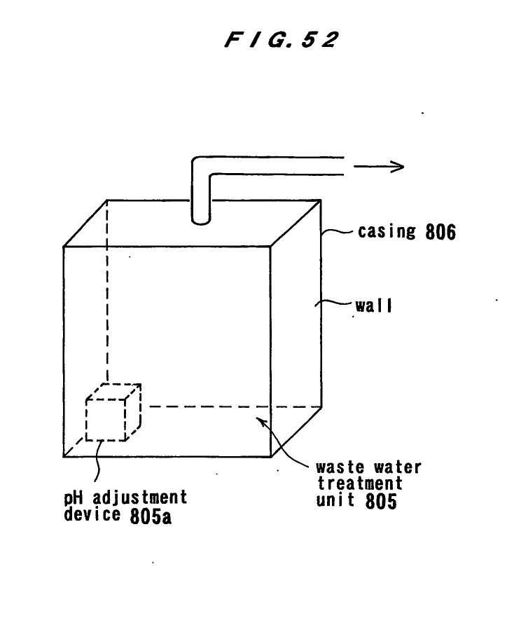

FIG. 52 shows a waste water treatment unit 805 that may be provided with at least one of a pH adjustment device 805a, an internal negative pressure-forming device, a waste water-receiving tank, a caster for movement, and the like within a casing 806. The internal negative pressure-forming device may be one that is controlled by pressure indicator signals. The casing 806 may be a dividable one. The waste water treatment unit 805 having the above structure can be installed in a space that requires a certain high level of cleanness, such as a clean room or its downstairs space.

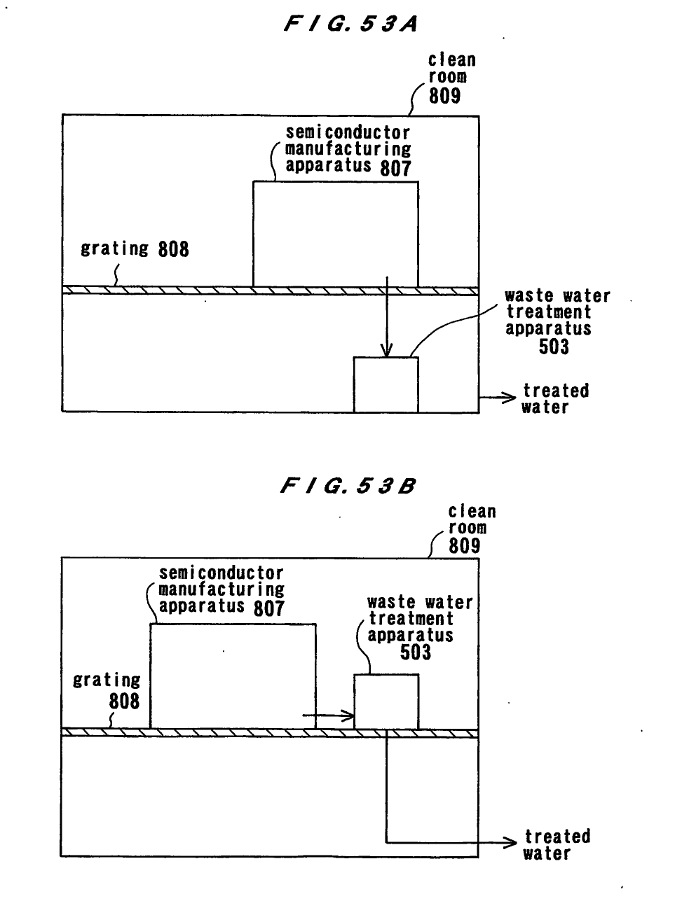

FIGS. 53A and 53B show preferable positional relationships between a CMP apparatus, an ECP apparatus or a plating apparatus and a waste water treatment system according to the present invention. In FIG. 53A, the waste water treatment system 503 is installed right below a semiconductor manufacturing apparatus 807 via a grating 808. In FIG. 53B, the waste water treatment system 503 is installed adjacent to a semiconductor manufacturing apparatus 807. In FIGS. 53A and 53B, the reference numeral 809 represents a clean room. By installing the waste water treatment system close to the manufacturing apparatus as in the above cases, the facility cost (e.g. piping cost) can be reduced and the volume (size) of the entire factory can be made compact, thus reducing a construction cost of the entire factory.

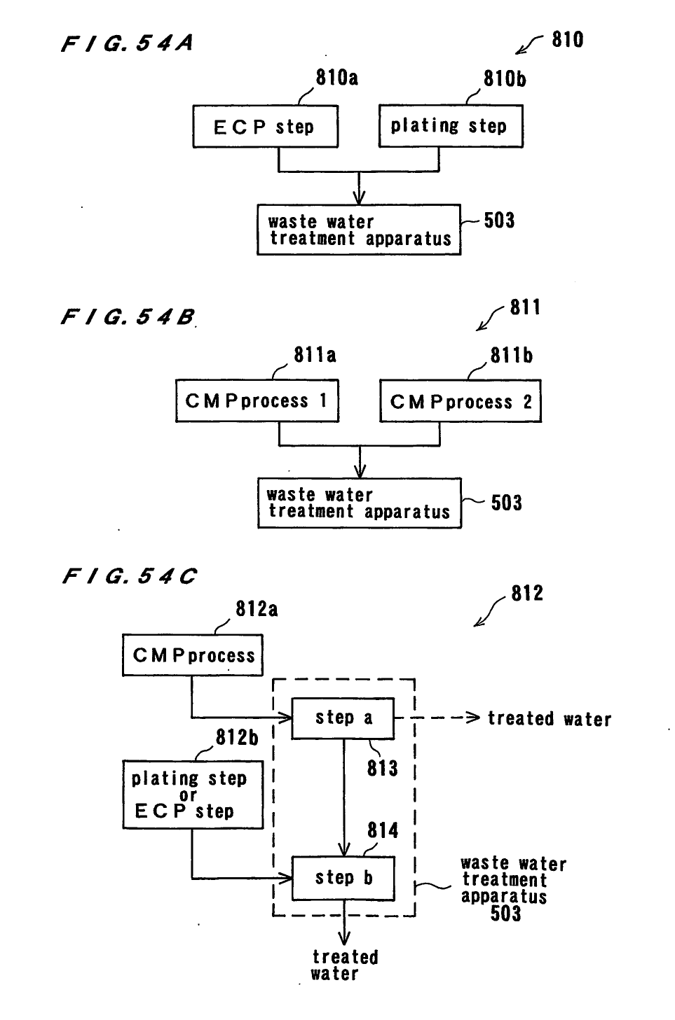

FIGS. 54A through 54C show cases of collectively treating waste water discharged from apparatuses that perform different process steps. For example, as shown. in FIG. 54A, waste water discharged from an electrochemical polishing treatment step 810a and waste water discharged from a plating step 810b may be mixed and treated in the waste water treatment system 503. As shown in FIG. 54B, waste water from apparatuses 811 that operate in the same manner but perform different steps may be mixed and treated in the waste water treatment system 503.

As shown in FIG. 54C, it is also possible to introduce waste water with various natures into different treatment steps of the waste water treatment system 503. Treated water may be withdrawn separately from different steps 813 and 814.

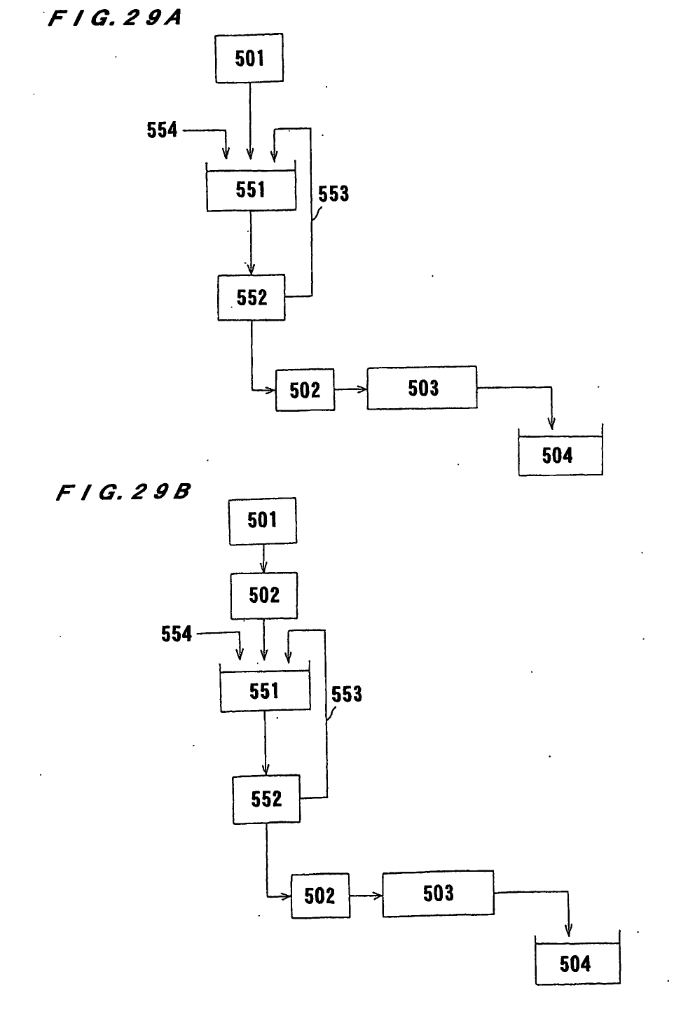

In the systems as shown in FIGS. 22 through 27, the metal ion removing step may be arranged in two lines. By switching the lines upon exchange of replacement parts, such as an ion exchanger and a cathode of the electrolytic deposition apparatus, it becomes possible to secure a continuous treatment. For example, in the system of FIG. 28A, waste water from various processes 501 of semiconductor device fabrication processes is first received in a waste water tank 550, then subjected to the oxidizing agent decomposition step 502, and is then supplied to one of the two waste water treatment apparatuses 503 according to the present invention which employ electrolytic deposition operation and ion exchange operation in combination, where metal ions are removed to obtain treated water 504. At the time of exchange of replacement parts, such as the cathode of the electrolytic deposition apparatus and the ion exchanger of the ion exchange operation, the line is switched to allow the water to be treated to pass through the other waste water treatment apparatus 503, while exchange of the replacement parts of the apparatus 503, to which water supply is stopped, is made. A continuous treatment of the waste water is thus secured. In the system of FIG. 28B, two electrolytic deposition apparatuses 511 which do not use an ion exchanger in the electrolytic chamber are disposed in parallel in two lines; in the system of FIG. 28C, two ion exchange treatment apparatuses 512 are disposed in parallel in two lines; and in the system of FIG. 28D, two coagulating sedimentation apparatuses 531 are disposed in parallel in two lines, thus enabling a continuous treatment of waste water in the same manner. Likewise, two oxidizing agent removing steps 502 may be disposed in parallel in two lines, so that a continuous treatment of waste water can be carried out even at the time of exchange of replacement parts in the oxidizing agent removing step 502.

In many cases, waste water from a CMP process in a semiconductor device fabrication processes further contains slurry particles, such as silica particles and alumina particles which have been used in the CMP process. If such waste water containing slurry particles is passed through the oxidizing agent removing step as it is, the particles can cause clogging in the oxidizing agent removing apparatus or can be accumulated in the electrolytic deposition apparatus. Accordingly, in the waste water treatment systems shown in FIGS. 22 through 28, before allowing water to be treated to pass through the oxidizing agent removing step, an acid or an alkali may be added to the water to be treated to adjust the pH so as to well disperse the slurry in the water to be treated, whereby clogging in the oxidizing agent removing apparatus and accumulation of the slurry particles in the electrolytic deposition apparatus can be prevented. Examples of acids usable for this purpose include citric acid, hydrochloric acid, sulfuric acid, and nitric acid; and examples of usable alkalis include sodium hydroxide, potassium hydroxide, calcium hydroxide, and amine-based compound.

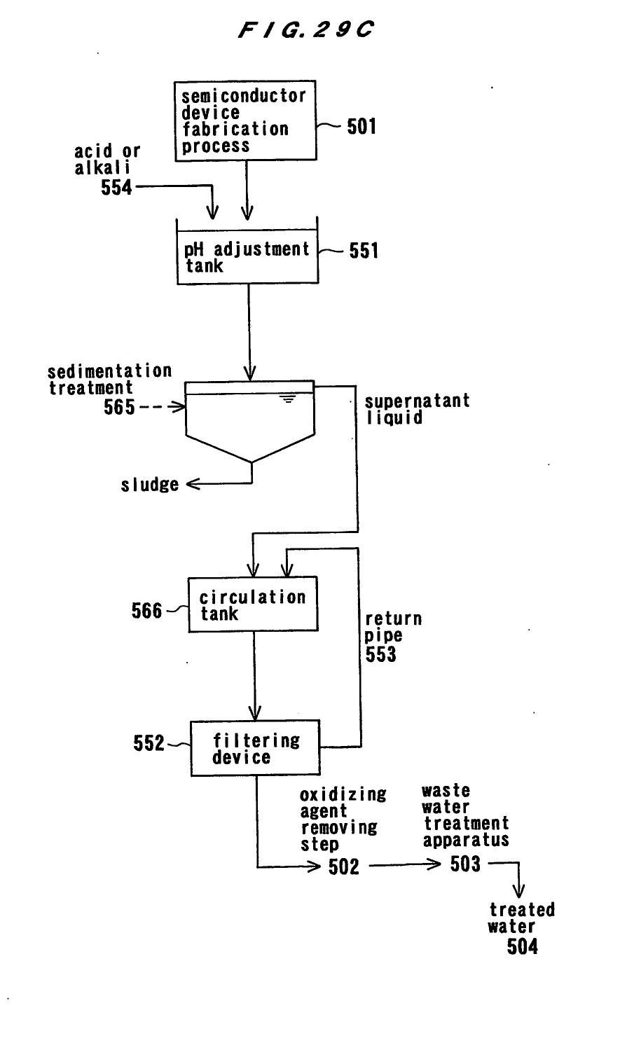

Further, when treating the waste water containing slurry particles such as silica particles and alumina particles discharged from the CMP process, it is also possible to adjust the pH so as to bring the waste water into conditions under which the slurry particles easily aggregate, thereby aggregating the slurry particles, and then pass the waste water through a filtering device such as a ceramic filter to remove the slurry particles, and then cause the waste water to be subjected to the above-described oxidizing agent removing treatment and metal removing treatment. Addition of coagulant may be combined. FIGS. 29A and 29B show treatment systems for water to be treated in such an embodiment. The same reference numeral as in the preceding Figures denotes the same constituent element.

According to the treatment system for water to be treated shown in FIG. 29A, waste water containing metal ions, an oxidizing agent such as hydrogen peroxide, and slurry particles discharged from the various processes 501, is first received in a pH adjustment tank 551, where an acid, alkali or coagulant 554 is added to the waste water to bring the waste water into conditions under which the slurry particles easily aggregate. Coagulant may be added to inflow water of the pH adjustment tank 551 and mixed with the inflow water. The conditions under which slurry particles easily aggregate vary depending on the kind of slurry particles contained in waste water and the nature of the waste water itself. Acids and alkalis usable for this purpose may include citric acid, hydrochloric acid, sulfuric acid, nitric acid, sodium hydroxide, potassium hydroxide, calcium hydroxide, choline, tetramethylammonium hydroxide, and ammonia. Coagulant may include polymer coagulant, inorganic coagulant such as FeSO₄ or FeCl₃. When inorganic coagulant containing Fe²⁺ such as FeSO₄ is used, since Fenton reaction occurs, hydrogen peroxide and chelating agent are decomposed. Thus, using FeSO₄ is more preferable. The waste water is then passed through a filtering device 552 to remove aggregated slurry particles. A ceramic filter, for example, may be used as the filtering device 552. Further, as shown in FIGS. 29A and 29B, part of concentrate by filtering device may be returned to the pH adjustment tank 551 to carry out readjustment. The waste water, from which the slurry particles have been removed by the filtering device 552, is subjected to the oxidizing agent removing step 502 to decompose and remove an oxidizing agent such as hydrogen peroxide, and is then treated in the waste water treatment apparatus 503 according to the present invention, which employs electrolytic deposition operation and ion exchange treatment in combination, to remove and recover metal such as copper contained in the waste water, thereby obtaining treated water 504. Further, as shown in FIG. 29B, the oxidizing agent removing step 502 may be disposed in the forefront of the system. Further, as shown in FIG. 29C, the treatment system may have such a structure that a membrane filtration is carried out for the supernatant liquid after sedimentation. For a sedimentation treatment, in addition to precipitation, centrifugal separation, or the like may be employed.

It is also possible to precipitate and separate a slurry by adding and mixing an acid, alkali or coagulant, and to filtrate the supernatant liquid by a filter. This can reduce a load of solid matter on the filter. The filter having a pore diameter of about<0.1 to 1.0 μm may be used. The filter element may be a ceramic or an organic polymer. Part or all of impermeable water (membrane-concentrated water) in such a membrane separation treatment may be returned to a circulation tank 566 or a sedimentation treatment 565, or may not be returned to a circulation tank 566 or a sedimentation treatment 565. Part of a circulation tank effluent may be returned to the sedimentation treatment 565 or the pH adjustment tank 551.

A sludge produced in the sedimentation treatment is discharged out of the system as it is, and after carrying out a concentration/dehydration treatment thereof, it is discarded. The sludge may be supplied to a separate comprehensive waste water treatment facility or a sludge treatment facility.

When it is intended to further lower the metal ion concentration of the liquid adhering to the sludge, the sludge may be rinsed with water having a low metal concentration, such as pure water or treated water discharged from the waste water treatment system according to the present invention. The rinsing waste water can be introduced into the sedimentation treatment 565 or the pH adjustment tank 551. Centrifugal separation 567 may be employed as a rinsing means (FIG. 29D).

The amount of metal ions adhering to the sludge can also be reduced by introducing rinsing water into the sedimentation tank or a sludge discharge pipe from the sedimentation tank. Such a method may therefore be adopted.

In the case where hydrogen peroxide in waste water impedes the sedimentation or filtration, a hydrogen peroxide decomposition means should be provided before the treatment.

In the case where it is difficult to provide a circulation tank 566 because of a shortage of the installation space, the sedimentation tank for carrying out sedimentation treatment 565 may be utilized also as a circulation tank (FIG. 29E). A return pipe from the filtering treatment to the sedimentation treatment 565 may not be required to be provided. Further, as shown in FIG. 29F, a filtering device 552 may be provided in the sedimentation tank. It is sufficient that the waste water treatment apparatus 503 is provided with at least one of ion exchange, electrolytic deposition and coagulation sedimentation treatment 565.

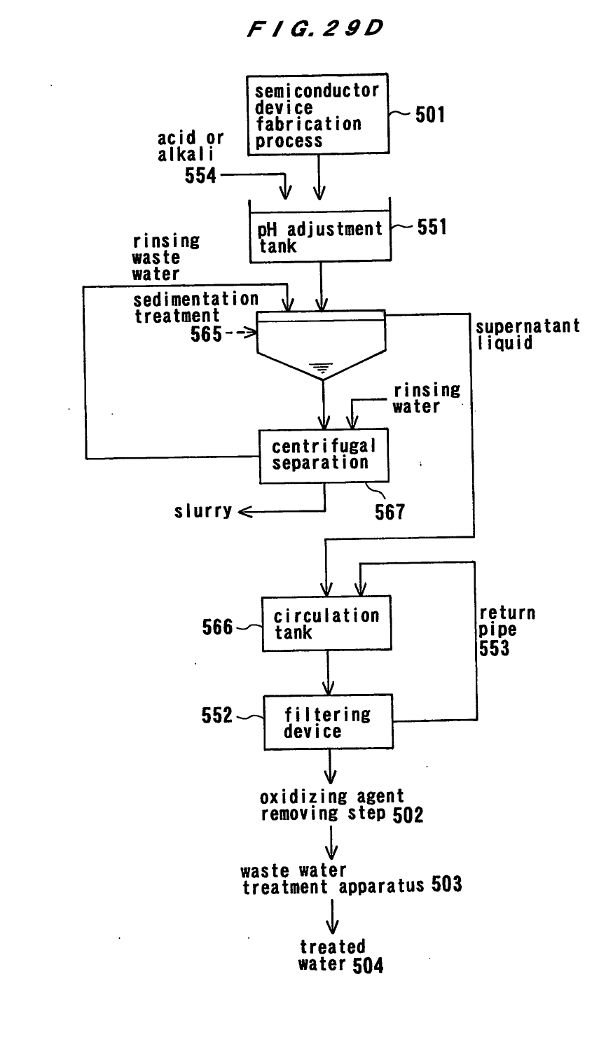

In the system of FIGS. 29A and 29B, in a case where the combination of ion exchange treatment and the electrolytic deposition apparatus of the type which does not use an ion exchanger in the electrolytic chamber, described above with reference to FIGS. 7 through 9, etc., is used as the waste water treatment 503 according to the present invention, various flows may be considered as shown in FIGS. 30A through 30F. In FIGS. 30A through 30F, the reference numeral 555 denotes a slurry removing step which is a combination of the pH adjustment tank 551 and the filtering device 552 shown in FIGS. 29A and 29B, 502 denotes an oxidizing agent removing step, 511 denotes an electrolytic deposition apparatus of the type which does not use an ion exchanger in the electrolytic chamber, and 512 denotes an ion exchange operation. According to the system shown in FIG. 30A, waste water containing metal ions, an oxidizing agent such as hydrogen peroxide, and slurry particles discharged from various processes, is first subjected to the slurry removing step 555 to remove the slurry particles, then subjected to the oxidizing agent removing step 502 to decompose the oxidizing agent, and is then passed through the electrolytic deposition apparatus 511 and then the ion exchange treatment 512 to remove and recover the metal ions in the waste water, thereby obtaining treated water 504. According to the system shown in FIG. 30B, waste water is first subjected to the oxidizing agent removing step 502 to decompose the oxidizing agent in the waste water, then subjected to the slurry removing step 555 to remove the slurry particles, and is then passed through the electrolytic deposition apparatus 511 and then the ion exchange treatment 512 to remove and recover the metal ions in the waste water, thereby obtaining treated water 504. According to the system shown in FIG. 30C, waste water is subjected to the slurry removing step 555 to remove the slurry particles, then subjected to treatment of the electrolytic deposition apparatus 511 to remove and recover the metal ions in the waste water, and then subjected to the oxidizing agent removing step 502 to decompose the oxidizing agent, and is then passed through the ion exchange treatment 512 to remove the metal ions in the waste water, thereby obtaining treated water 504. According to the system shown in FIG. 30D, waste water is first subjected to treatment of the electrolytic deposition apparatus 511 to remove and recover the metal ions in the waste water, then subjected to the slurry removing step 555 to remove the slurry particles, and then subjected to the oxidizing agent removing step 502 to decompose the oxidizing agent, and is finally passed through the ion exchange treatment 512 to remove the metal ions in the waste water, thereby obtaining treated water 504. According to the system shown in FIG. 30E, waste water is first subjected to treatment of the electrolytic deposition apparatus 511 to remove and recover the metal ions in the waste water, then subjected to the oxidizing agent removing step 502 to decompose the oxidizing agent, then subjected to the slurry removing step 555 to remove the slurry particles, and is finally passed through the ion exchange treatment 512 to remove the metal ions in the waste water, thereby obtaining treated water 504. According to the system shown in FIG. 30F, waste water is first subjected to the oxidizing agent removing step 502 to decompose the oxidizing agent, then subjected to treatment of the electrolytic deposition apparatus 511 to remove and recover the metal ions in the waste water, and then subjected to the slurry removing step 555 to remove the slurry particles, and is finally passed through the ion exchange treatment 512 to remove the metal ions in the waste water, thereby obtaining treated water 504. In the various systems shown in FIGS. 30A through 30F, instead of the electrolytic deposition apparatus 511 of the type which does not use an ion exchanger in the electrolytic chamber, it is possible to use an electrolytic deposition apparatus of the type which uses an ion exchanger in the electrolytic chamber as shown in FIGS. 10 through 15, or use the combination of an electrolytic deposition apparatus of the type which does not use an ion exchanger in the electrolytic chamber and an electrolytic deposition apparatus of the type which uses an ion exchanger in the electrolytic chamber as shown in FIG. 16.

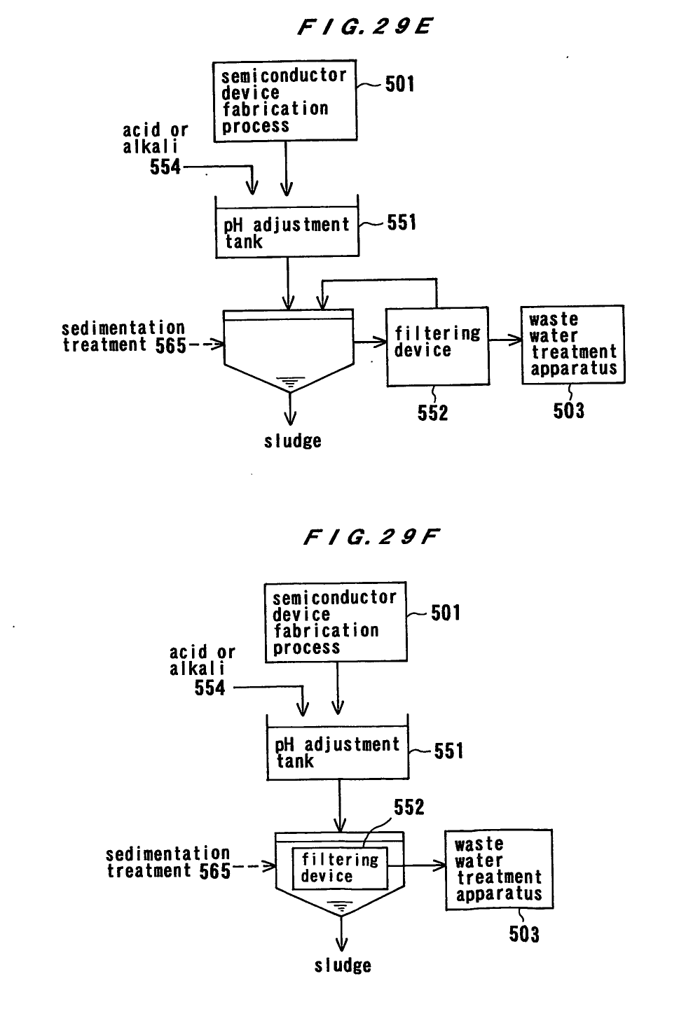

Further, it is possible to combine such a series of pretreatments of slurry removal-oxidizing agent removal with a metal removal treatment by means of an electrolytic deposition apparatus which does not use an ion exchanger in the electrolytic chamber, a metal removal treatment by ion exchange, or a metal removal treatment by the coagulating sedimentation method. FIGS. 31 through 33 show embodiments of such a treatment system for water to be treated. In FIGS. 31 through 33, the same reference numeral as in the preceding Figures denotes the same constituent element.

According to the system shown in FIG. 31, waste water containing metal ions such as copper ions, an oxidizing agent such as hydrogen peroxide, and slurry particles discharged from the various processes 501, is first received in the pH adjustment tank 551, where an acid, alkali or coagulant 554 is added to the waste water to aggregate the slurry particles, and the waste water is then passed through the filtering device 552 to remove the aggregated slurry particles. Part of concentrate by filtering device may be returned via a return pipe 553 to the pH adjustment tank 551 to carry out readjustment. Thereafter, the waste water is passed through the oxidizing agent removing step 502 to decompose the oxidizing agent such as hydrogen peroxide, and is then passed through the electrolytic deposition apparatus 511 to remove and recover the metal ions, such as copper ions, contained in the waste water, thereby obtaining treated water 504.

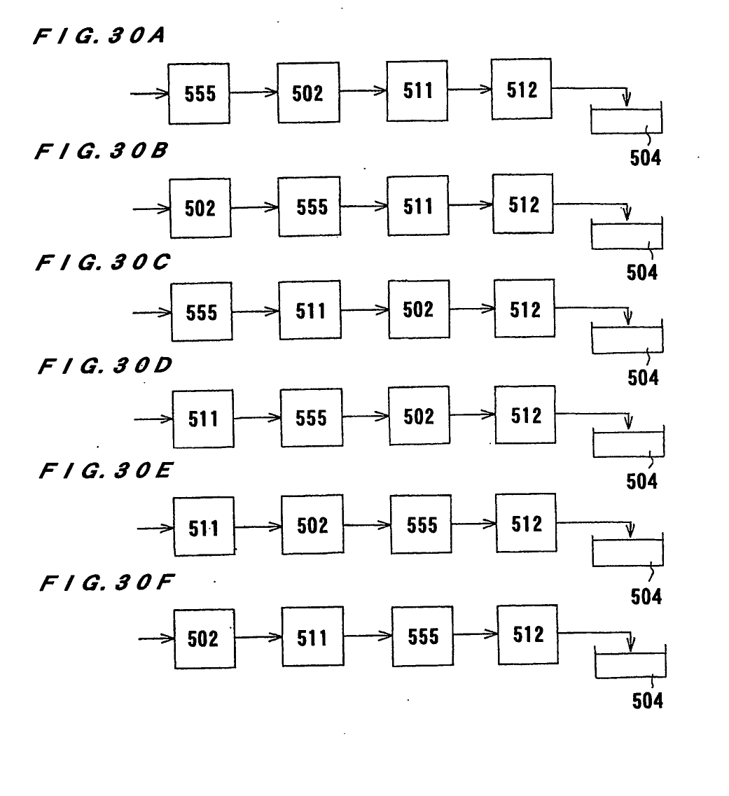

According to the system shown in FIG. 32, waste water containing metal ions such as copper ions, an oxidizing agent such as hydrogen peroxide, and slurry particles discharged from the various processes 501, is first received in the pH adjustment tank 551, where an acid, alkali or coagulant 554 is added to the waste water to aggregate the slurry particles, and the waste water is then passed through the filtering device 552 to remove the aggregated slurry particles. Part of concentrate by filtering device from the filtering device 552 may be returned via a return pipe 553 to the pH adjustment tank 551 to carry out readjustment. Thereafter, the waste water is passed through the oxidizing agent removing step 502 to decompose the oxidizing agent such as hydrogen peroxide, and is then passed through the ion exchange bath 512 which has an ion exchanger therein, where the metal ions contained in the waste water are adsorbed and removed by the ion exchanger, thereby obtaining treated water 504. Ion exchangers usable for the purpose of removing metal ions, such as copper ions, in the water to be treated may include the above-described various ion-exchange resins, ion-exchange fibrous materials and ion-exchange spacers. The ion exchanger on which the metal ions are adsorbed is taken out of the ion exchange bath and is subjected to an appropriate regeneration treatment to recover the metal, after it is used for a predetermined period of time. An electrical regeneration treatment may be used.

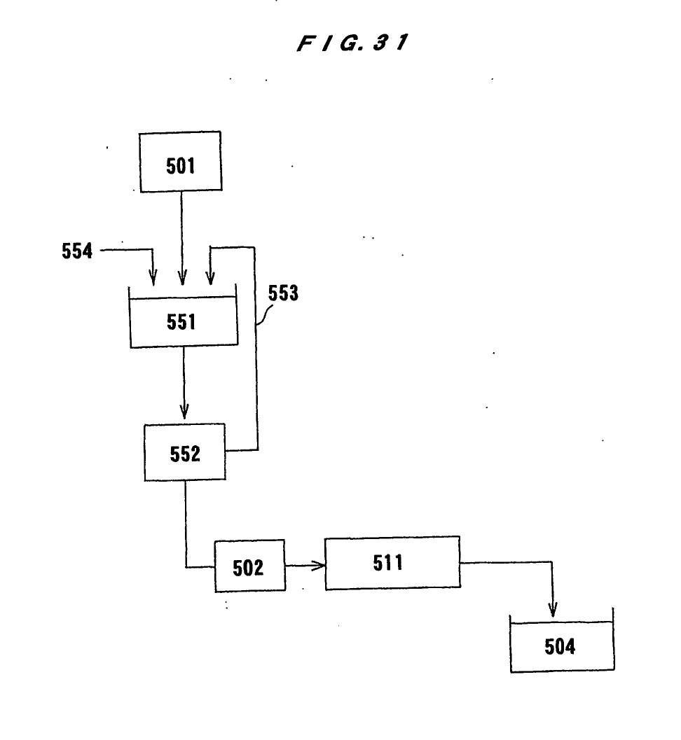

According to the system shown in FIG. 33, waste water containing metal ions such as copper ions, an oxidizing agent such as hydrogen peroxide, and slurry particles discharged from the various processes 501, is first received in the pH adjustment tank 551, where an acid, alkali or coagulant 554 is added to the waste water to aggregate the slurry particles, and the waste water is then passed through the filtering device 552 to remove the aggregated slurry particles. Part of concentrate by filtering device may be returned via a return pipe 553 to the pH adjustment tank 551 to carry out readjustment. Thereafter, the waste water is passed through the oxidizing agent removing step 502 to decompose the oxidizing agent such as hydrogen peroxide, and is then received in the coagulating sedimentation tank 531. In the coagulating sedimentation tank 531, a coagulant 532 is added to the water to be treated, whereby the metal ions are coagulated and precipitated, and removed from the water to be treated, while the supernatant liquid is recovered as treated water 504. The metal precipitated in the coagulating sedimentation tank 531 is recovered as a precipitate 533 and, if necessary, subjected to a subsequent treatment. As the coagulant 532 to be used in such a system for coagulating and precipitating metal ions in the water to be treated, various chemicals known in the art as usable for coagulating and precipitating metal ions in an aqueous medium, can be used. Specific examples include NaOH, KOH, Ca(OH)₂, choline, tetramethylammonium hydroxide, ammonia, and a polymer coagulant. For separation of a precipitate 533 from the supernatant liquid, in addition to precipitation, a membrane treatment or a centrifugal separation may also be employed. Further, the precipitation, the membrane treatment and the centrifugal separation may be used in combination.

In the systems shown in FIGS. 29, 31, 32 and 33, it is possible to pass waste water to the oxidizing agent decomposition step 502, and then pass the treated water to the filtration step. Further, the waste water treatment apparatus 503 in the systems shown in FIGS. 29A through 29F may be one that employs a waste water treatment method as shown in FIGS. 31 through 33, i.e. ion exchange, electrolytic deposition or coagulation sedimentation.

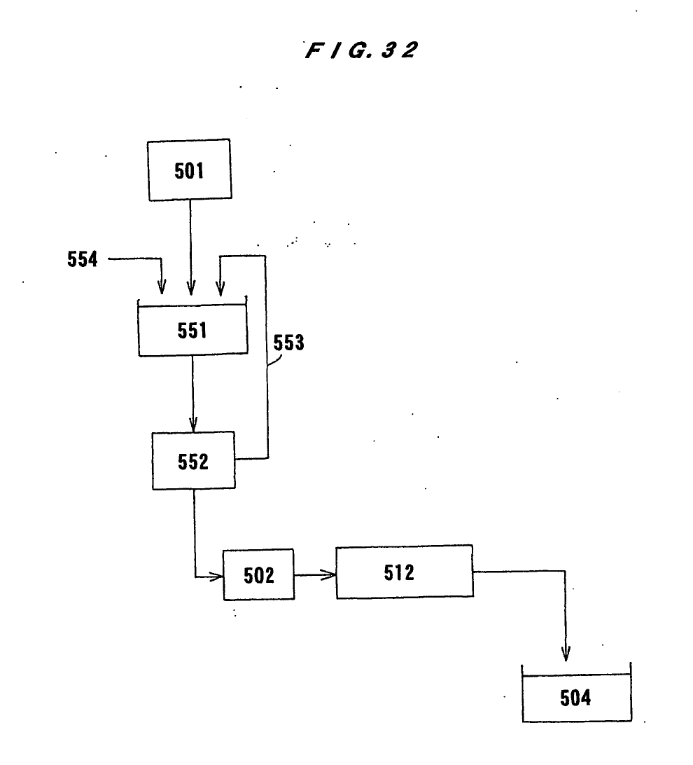

In the systems shown in FIGS. 29, 31, 32 and 33, for at least one of the oxidizing agent decomposition step 502 and a metal ion removing step by electrolytic deposition, ion exchange, or coagulation, two or more steps may be disposed in parallel as shown in FIG. 34, thereby securing a continuous operation even at the time of exchange of replacement parts. In FIG. 34, the reference numeral 556 denotes a metal removing step carried out by any one of the waste water treatment apparatus 503 according to the present invention which employs electrolytic deposition operation and ion exchange treatment in combination as shown in FIGS. 29A and 29B, the electrolytic deposition apparatus 511 which does not use an ion exchanger in the electrolytic chamber as shown in FIG. 31, the ion exchange bath 512 as shown in FIG. 32, and the coagulating sedimentation tank 531 as shown in FIG. 33. In FIGS. 31 through 34, the order of the slurry removing step and the oxidizing agent removing step may be reversed.

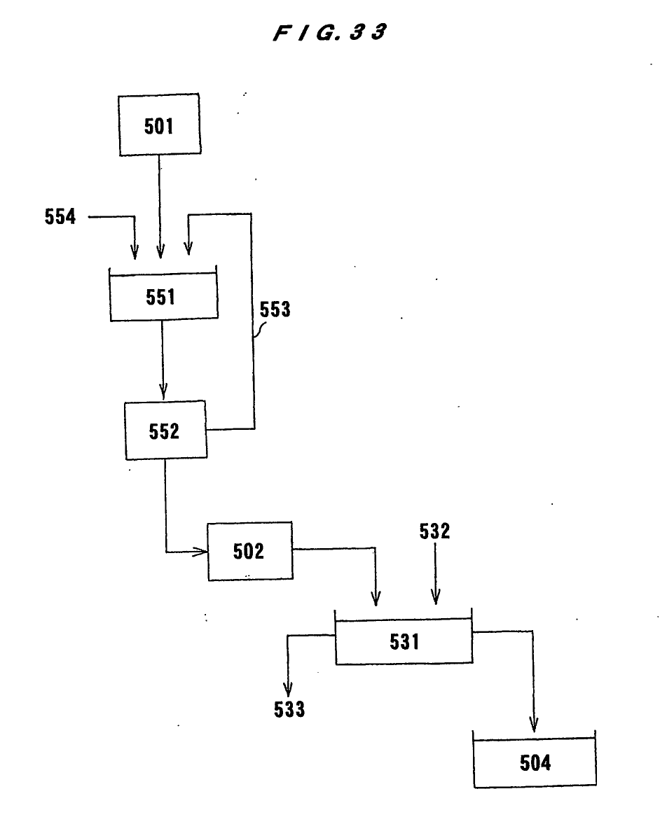

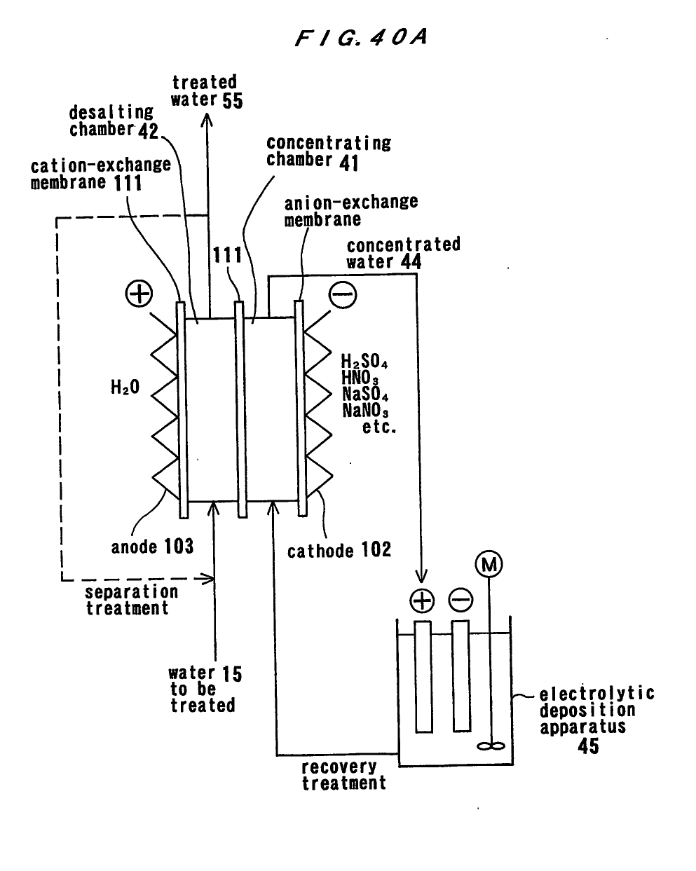

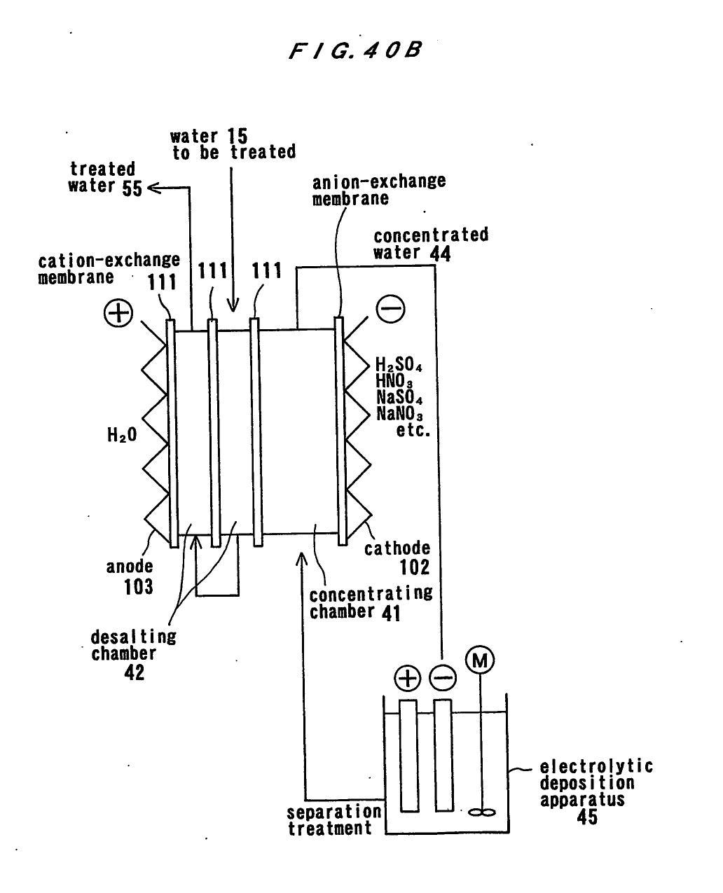

Further, in a waste water treatment system according to the present invention which is a combination of the oxidizing agent removing step 502 and a metal removing step, or in a waste water treatment system which is a combination of the above two steps and the slurry removing step 555 as a preceding step, it is possible to provide a pH adjustment step before at least one of the respective steps in order to optimize the pH of water to be treated for the respective steps. FIGS. 35A and 35B show embodiments of such a system. In FIGS. 35A and 35B, the reference numeral 555 denotes a slurry removing step which is a combination of the pH adjustment tank 551 and the filtering device 552 as shown in FIGS. 29A and 29B, 502 denotes an oxidizing agent removing step, and 561 denotes a metal removing step carried out by any one of the waste water removing apparatus 503 according to the present invention which employs electrolytic deposition operation and ion exchange treatment in combination (see FIGS. 29A and 29B, etc.), the electrolytic deposition apparatus 511 which does not use an ion exchange in the electrolytic chamber (see FIGS. 23A, 23B, 23C, etc.), the metal removing apparatus 561 employing ion exchange operation (see FIG. 26, etc.), and a metal ion removing apparatus employing coagulating sedimentation (see FIG. 27). According to the system shown in FIG. 35A, waste water is first adjusted in a pH adjustment tank 562 to the optimum pH for the next oxidizing agent removing step 502, then passed through the oxidizing agent removing step 502 to remove the oxidizing agent, and then passed through another pH adjustment tank 563 to adjust the waste water to the optimum pH for the next metal removing step 561, and is finally passed through the metal removing step 561 to remove and recover the metal ions in the waste water, thereby obtaining treated water 504. According to the system shown in FIG. 35B, waste water is first adjusted in a pH adjustment tank 564 to the optimum pH for the next slurry removing step 555, then passed through another pH adjustment tank 562 to adjust the waste water to the optimum pH for the next oxidizing agent removing step 502, then passed through the oxidizing agent removing step 502 to remove the oxidizing agent, then passed through still another pH adjustment tank 563 to adjust the waste water to the optimum pH for the next metal removing step 561, and is finally passed through the metal removing step 561 to remove and recover the metal ions in the waste water, thereby obtaining treated water 504. One or more of these pH adjustment tanks may be omitted. In the case of treating waste water discharged from a CMP apparatus 803, in order to remove coarse particles of a metal or silica, the waste water may be treated with a membrane having a pore diameter of about 0.1 to 0.5 μm in advance (FIGS. 42 and 43). Then, the water is subjected to a treatment step 815 such as ion exchange, electrolytic deposition, or the like.

In the embodiment shown in FIG. 42, a filtering device 552a having such membrane is provided, and in the embodiment shown in FIG. 43, two stage filtering devices 552a, 552b are provided to carry out coarse filtration and fine filtration.

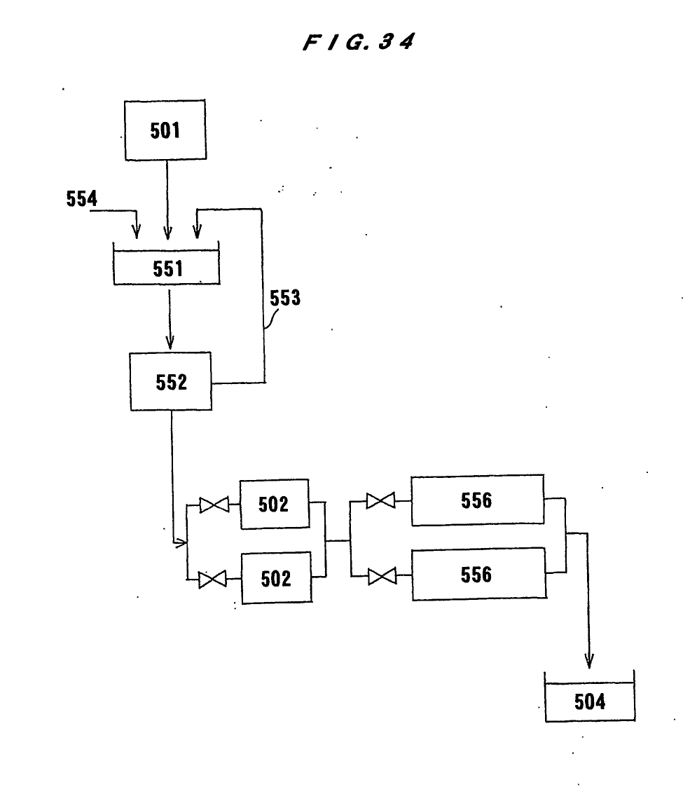

FIGS. 36A and 36B show installation methods of the waste water treatment system according to embodiments of the present invention in the case of using the waste water treatment system in an actual semiconductor device fabrication plant. In FIGS. 36A and 36B, the reference numeral 601 denotes a semiconductor device fabrication plant, 602 denotes a copper plating apparatus, 603 denotes a polishing apparatus, such as a CMP or ECP apparatus, and 604 denotes a waste water treatment apparatus or waste water treatment system according to any one of the above-described various embodiments of the present invention. For example, as shown in FIG. 36A, waste water, from the copper plating apparatus 602 and the polishing apparatus 603 such as a CMP or ECP apparatus in the semiconductor device fabrication plant 601, is collected, and the collected waste water is treated by means of the waste water treatment apparatus or waste water treatment system 604 according to any one of the various embodiments of the present invention, whereby treated water 504, from which metal ions such as copper ions have been removed, can be obtained. Alternatively, as shown in FIG. 36B, waste water from the copper plating apparatus 602 and waste water from the polishing apparatus 603 such as a CMP or ECP apparatus, are collected separately, and the separately collected waste water is treated separately by means of the waste water treatment apparatus or waste water treatment system 604 according to any one of the various embodiments of the present invention, whereby treated water 504, from which metal ions such as copper ions have been removed, can be obtained. Thus, treatment of waste water can be carried out so as to meet the actual circumstances of apparatuses, in respective plants, which generate waste water by installing the waste water treatment apparatus of the present invention at the location where the waste water is generated. When a CMP apparatus and an ECP apparatus coexist, the respective waste water from these apparatus may be treated either separately, or simultaneously as a mixture. When treated water according to the present invention is discharged into a sewage line or supplied to a separate comprehensive waste water treatment facility, an inappropriate water quality, such as pH, if any, should be adjusted in advance.

In the above-described electrolytic deposition operation, a gas having a lower oxygen concentration than air, such as N₂ gas, may be introduced into water which is to be introduced into a bath provided with a cathode on which a metal, such as copper, is deposited, thereby purging oxygen gas dissolved in the water. By thus lowering the concentration of dissolved oxygen in water, consumption of electric current due to reaction of oxygen at the cathode can be lowered, and redissolution of metal such as copper deposited on the cathode surface into water can be suppressed, and hence the electric current efficiency can be increased. The deoxidization step may be introduced at any position, prior to the electrolytic deposition step, in the treatment flows described hereinabove. In the electrolytic deposition step, it is desirable to pass water first in the vicinity of a cathode and then pass the water in the vicinity of an anode.

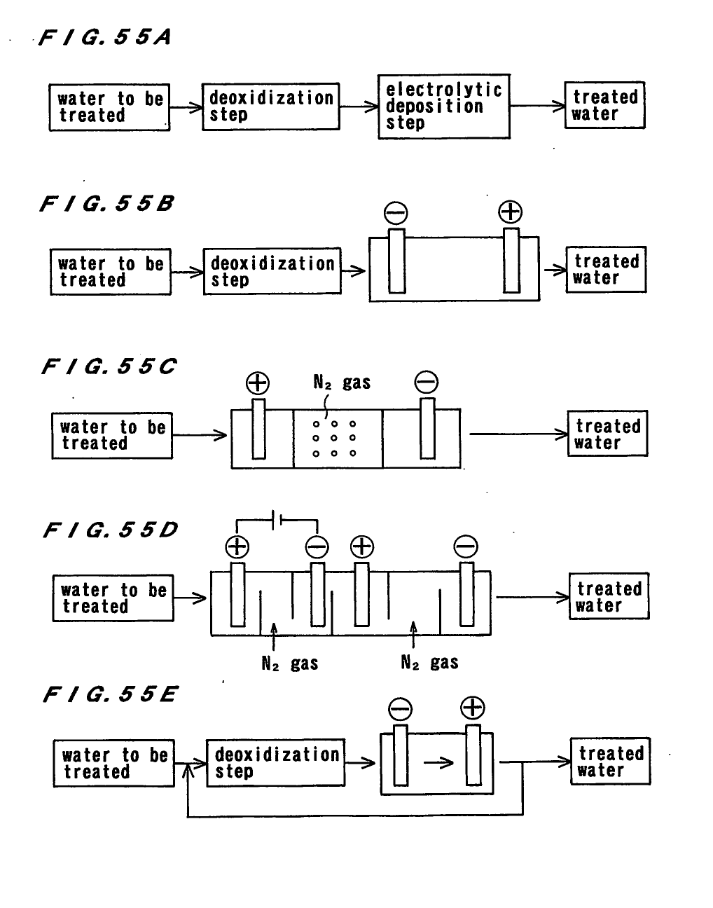

FIGS. 55A through 55E show various treatment flows in which a deoxidization step is incorporated. In the treatment processes shown in FIGS. 55A and 55B, water to be treated is subjected to a deoxidization step, and then an electrolytic deposition step, thus obtaining treated water. In the treatment process shown in FIGS. 55C and 55D, water to be treated is subjected to a deoxidization step carried out by introducing N₂ gas, and an electrolytic deposition step simultaneously, thus obtaining treated water. In the treatment process shown in FIG. 55E, a return step of treated water is added to the treatment process shown in FIG. 55B. Specifically, part of treated water discharged from the electrolytic deposition step is returned to the deoxidization step for thereby further lowering the concentration of dissolved oxygen in water.

As described hereinabove, according to the present invention, water, to be treated, containing metal ions can be treated, and the metal can be removed and recovered in the form of a metal element. When the present invention is applied to waste water from various steps of a semiconductor fabrication processes, such as a CMP step, an ECP step and a copper plating step, the waste water can be treated in situ, i.e. by point-of-use treatment, to obtain treated water which meets discharge standards and recover copper as copper metal.

Various aspects of the present inventions are as follows:

(1) An apparatus for treating water containing metal ions, said apparatus comprising:

a combination of an electrolytic deposition unit and an ion exchange unit.

(2) An apparatus for treating water containing metal ions according to the above (1), said apparatus comprising:

an electrolytic deposition unit for removing and recovering metal ions from the water by electrolytic deposition; and

an ion exchange unit for removing and recovering metal ions from the water discharged from said electrolytic deposition unit by ion exchange.

(3) A method for treating water containing metal ions and an oxidizing agent, said method comprising:

an oxidizing agent removing step for decomposing and removing an oxidizing agent from the water; and

an electrolytic deposition step for removing and recovering metal ions from the water discharged from said oxidizing agent removing step by electrolytic deposition.

(4) A method for treating water containing metal ions and an oxidizing agent, said method comprising:

an oxidizing agent removing step for decomposing and removing an oxidizing agent from the water;

an electrolytic deposition step for removing and recovering metal ions from the water discharged from said oxidizing agent removing step by electrolytic deposition; and

an ion exchange step for removing and recovering metal ions from the water discharged from said electrolytic deposition step by ion exchange.

(5) A method for treating water containing metal ions and an oxidizing agent, said method comprising:

an oxidizing agent removing step for decomposing and removing an oxidizing agent from the water; and

an electrolytic deposition step for removing and recovering metal ions from the water discharged from said oxidizing agent removing step by an electrolytic deposition unit having electrodes and an ion exchange element disposed between said electrodes.

(6) A method for treating water containing metal ions and an oxidizing agent, said method comprising:

an oxidizing agent removing step for decomposing and removing an oxidizing agent from the water; and

an ion exchange step for removing and recovering metal ions from the water discharged from said oxidizing agent removing step by ion exchange.

(7) A method for treating water containing metal ions and an oxidizing agent, said method comprising:

an oxidizing agent removing step for decomposing and removing an oxidizing agent from the water; and

an aggregation and precipitation step for adding a flocculant into the water discharged from said oxidizing agent removing step to aggregate and precipitate metal from said water.

(8) A method according to any one of the above (3) through (7), further comprising:

an addition step for adding one of an acid and an alkali into water before being introduced into said oxidizing agent removing step.

(9) A method for treating water containing metal ions, an oxidizing agent, and an inorganic particle slurry, said method comprising:

a slurry particle removing step for adding a pH adjustor to the water to aggregate at least a portion of slurry particles in the water, and passing the water through a filtering device to remove the aggregated slurry particles;

an oxidizing agent removing step for decomposing and removing an oxidizing agent from the water discharged from said slurry particle removing step; and

an electrolytic deposition step for removing and recovering metal ions from the water discharged from said oxidizing agent removing step by electrolytic deposition.

(10) A method for treating water containing metal ions, an oxidizing agent, and an inorganic particle slurry, said method comprising:

a slurry particle removing step for adding a pH adjustor to the water to aggregate at least a portion of slurry particles in the water, and passing the water through a filtering device to remove the aggregated slurry particles;

an oxidizing agent removing step for decomposing and removing an oxidizing agent from the water discharged from said slurry particle removing step;

an electrolytic deposition step for removing and recovering metal ions from the water discharged from said oxidizing agent removing step by electrolytic deposition; and

an ion exchange step for removing and recovering metal ions from the water discharged from said electrolytic deposition step by ion exchange.

(11) A method for treating water containing metal ions, an oxidizing agent, and an inorganic particle slurry, said method comprising:

a slurry particle removing step for adding a pH adjustor to the water to aggregate at least a portion of slurry particles in the water, and passing the water through a filtering device to remove the aggregated slurry particles;

an oxidizing agent removing step for decomposing and removing an oxidizing agent from the water discharged from said slurry particle removing step; and

an electrolytic deposition step for removing and recovering metal ions from the water discharged from said oxidizing agent removing step by an electrolytic deposition unit having electrodes and an ion exchange element disposed between said electrodes.

(12) A method for treating water containing metal ions, an oxidizing agent, and an inorganic particle slurry, said method comprising:

a slurry particle removing step for adding a pH adjustor to the water to aggregate at least a portion of slurry particles in the water, and passing the water through a filtering device to remove the aggregated slurry particles;

an oxidizing agent removing step for decomposing and removing an oxidizing agent from the water discharged from said slurry particle removing step; and

an ion exchange step for removing and recovering metal ions from the water discharged from said oxidizing agent removing step by ion exchange.

(13) A method for treating water containing metal ions, an oxidizing agent, and an inorganic particle slurry, said method comprising:

a slurry particle removing step for adding a pH adjustor to the water to aggregate at least a portion of slurry particles in the water, and passing the water through a filtering device to remove the aggregated slurry particles;

an oxidizing agent removing step for decomposing and removing an oxidizing agent from the water discharged from said slurry particle removing step; and

an aggregation and precipitation step for adding a flocculant into the water discharged from said oxidizing agent removing step to aggregate and precipitate metal from said water.

(14) An apparatus according to the above (1) or (2), wherein the water comprises waste water discharged from a semiconductor device fabrication process.

(15) A method according to any one of the above (3) through (13), wherein the water comprises waste water discharged from a semiconductor device fabrication process.

(16) An apparatus according to the above (1) or (2), wherein the water comprises waste water discharged from one of a CMP process, a copper plating process, and an electrochemical polishing process in a semiconductor device fabrication process.

(17) A method according to any one of the above (3) through (13), wherein the water comprises waste water discharged from one of a CMP process, a copper plating process, and an electrochemical polishing process in a semiconductor device fabrication process.

(18) An electrolytic deposition apparatus comprising:

an anode and a cathode opposed to each other; and

an ion exchange element disposed between said anode and said cathode.

(19) An electrolytic deposition apparatus according to the above (18), wherein said anode and said cathode are made of a water-permeable material, respectively;

an electrolytic chamber is formed between said anode and said cathode;

said ion exchange element comprises at least a layer disposed between said anode and said cathode;

a water supply and discharge device for passing water through composite layers composed of said anode, said cathode, and said layer of said ion exchange element.

(20) An electrolytic deposition apparatus according to the above (18) or (19), further comprising:

a layer of a water-permeable conductive element disposed so as to contact said cathode; and

a layer of said ion exchange element disposed between said layer of said water-permeable conductive element and said anode and held in contact with said layer of said water-permeable conductive element and said anode.

(21) An electrolytic deposition apparatus according to the above (20), wherein said water-permeable conductive element is made of a water-permeable carbon fiber material.

(22) An electrolytic deposition apparatus according to the above (21), wherein said water-permeable carbon fiber material comprises an activated carbon fiber sheet.

(23) An electrolytic deposition apparatus according to the above (20), wherein said water-permeable conductive element is made of a water-permeable foamed metal material or a metal fiber material.

(24) An electrolytic deposition apparatus according to the above (23), wherein said water-permeable foamed metal material comprises a foamed copper material.

(25) An electrolytic deposition apparatus according to any one of the above (18) through (24), wherein said ion exchange element is made of an ion exchange fiber material.

(26) An electrolytic deposition apparatus according to the above (25), wherein said ion exchange fiber material is a fiber material in which an ion exchange group is introduced into an organic polymer nonwoven fiber substrates by radiation-induced graft polymerization.

(27) An electrolytic deposition apparatus according to the above (26), wherein said ion exchange group comprises a cation exchange group which is selected from sulfo group, phosphoric acid group, and carboxyl group.

(28) An electrolytic deposition apparatus according to any one of the above (18) through (27), wherein said ion exchange element comprises a cation exchange group.

(29) An electrolytic deposition apparatus according to the above (26), wherein said ion exchange group is selected from a functional group derived from iminodiacetic acid group and sodium salt thereof, and a functional group derived from phenylalanine, lysine, leucine, valine, and proline, and sodium salt thereof.

(30) An electrolytic deposition apparatus according to any one of the above (18) through (29), wherein said anode and said cathode are made of at least one of expanded metal, metallic materials having diagonal meshes, metallic materials having latticed meshes, or netlike metallic materials, respectively.

(31) An electrolytic deposition apparatus according to any one of the above (18) through (30), wherein said anode and said cathode are made of a material having a water-permeability and a gas-permeability, respectively.

(32) An electrolytic deposition apparatus according to any one of the above (20) through (31), wherein said water-permeable conductive element or water-permeable foamed metal material is made of a material having a water-permeability and a gas-permeability.

(33) A method of treating water containing metal ions, said method comprising:

treating water having a metal ion concentration of 200 mg/l or lower to provide treated water having a lowered concentration of the metal ions; and

recovering metal contained in the water in the form of metal element from the treated water.

(34) A method of treating waste water containing copper ions, said method comprising:

treating waste water discharged from a semiconductor device fabrication process to provide treated water having a copper concentration lower than a predetermined value; and

recovering copper in the form of copper metal from the treated water.

(35) A method according to the above (34), wherein the waste water comprises waste water discharged from at least one of a CMP process, a copper plating process, and an electrochemical polishing process in a semiconductor device fabrication process.

(36) A method according to the above (34) or (35), wherein the waste water has a copper ion concentration of 100 mg/l or lower.

(37) A method according to any one of the above (33) through (36), wherein treated water having a copper concentration of 0.5 mg/l or lower is continuously obtained.

(38) A method according to any one of the above (9) through (13), the slurry particle removing step and the oxidizing agent removing step are reversed in order.

### EXAMPLES

Specific examples according to the present invention will be described below. The present invention is not limited to the following examples.

### Example 1

### Productions of Cation Exchanger of Nonwoven Fabric

In this example, nonwoven fabric having the following characteristics was used as a base material for producing a cation exchanger of nonwoven fabric. The base nonwoven fabric was formed by thermal fusion of composite fiber which consists of a core portion of polypropylene and a sheath portion of polyethylene.

TABLE 1

| Component of core | Polypropylene |
|---|---|
| Component of sheath | Polyethylene |
| Areal density | 50 g/m² |
| Thickness | 0.55 mm |
| Diameter of fiber | 15-40 μm |
| Producing method of nonwoven fabric | thermal |
| | fusion |
| Porosity | 91% |

A gamma ray was irradiated to the nonwoven fabric substrates under a nitrogen atmosphere and then immersed into a solution of glycidyl methacrylate (GMA). Thus, the nonwoven fabric substrates were reacted with the solution to form graft-polymerized nonwoven fabric having a graft ratio of 175%. The graft-polymerized nonwoven fabric was immersed into a mixed solution of sodium sulfite, isopropyl alcohol, and water, for sulfonation. Thus, a cation exchanger of nonwoven fabric was produced. When the ion exchange capacity of the cation exchanger of nonwoven fabric was measured, it was found that a strongly acidic cation exchanger having a salt splitting capacity of 2.82 meq/g was obtained.

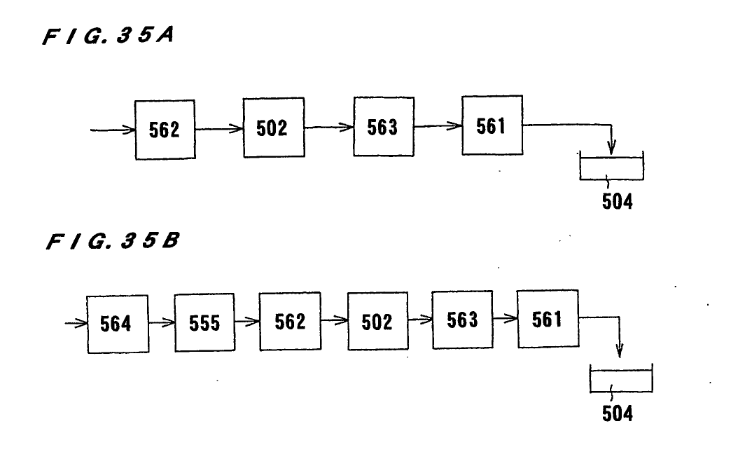

The above cation exchanger was incorporated into an electrolytic deposition apparatus shown in FIG. 37. A cathode 702 was made of expanded metal (lath-metal specification). Specifically, the expanded metal was made of stainless steel, and had a short width of 7 mm and a long width of 14 mm, and a thickness of 3 mm. An anode 703 was made of expanded metal (lath-metal specification) specially ordered. Specifically, the expanded metal was made of titanium coated with platinum, and had a short width of 6 mm and a long width of 14 mm, and a thickness of 3 mm. Ten sheets of the above cation exchanger of nonwoven fabric were piled on each other to form a layer 705 having a thickness of 10 mm. The layer 705 of the cation exchanger of nonwoven fabric was disposed so as to contact the anode 703. Five activated carbon nonwoven fabric sheets having a thickness of 2 mm were piled on each other to form a layer 704 having a thickness of 10 mm. The layer 704 of the activated carbon nonwoven fabric was disposed so as to contact the cathode 702. A passage for waste water in the apparatus had a cross section of 77 cm².

Copper sulfate was dissolved into pure water to form an aqueous solution having a copper ion concentration of 100 mg/l as raw water. The raw water was placed in a tank 722. While a voltage was applied between the cathode 702 and the anode 703, the raw water was supplied into a waste water supply chamber 712 in the electrolytic deposition apparatus by a pump. Treated water was recovered at a ratio of 100 volume of treated water to 500 volume of supplied water by a pump. Circulating water was circulated at a ratio of 400 volume of treated water to 500 volume of supplied water. During operation, a produced gas was released from a vent hole as needed. Currents and voltages for operation and concentrations of copper ions in the treated water are listed below in Experiments I and II of Table 2. It can be seen from the results that an electrolytic deposition apparatus according to the present invention can highly efficiently remove copper ions from waste water with a low voltage and a small current. The electrolytic deposition apparatus was disassembled after operation, and the states of the activated carbon nonwoven fabric sheets were observed. With this observation, copper metal was deposited on surfaces of the activated carbon nonwoven fabric sheets.

The activated carbon nonwoven fabric sheets used in the above experiments were sheets having non-conductive nonwoven fabric sheets attached to both surfaces thereof for reinforcement. In the above experiments I and II, the activated carbon nonwoven fabric sheets were piled on each other after the non-conductive nonwoven fabric sheets were peeled from each of the activated carbon nonwoven fabric sheets.

In the Experiment III, five activated carbon nonwoven fabric sheets were piled on each other with the non-conductive nonwoven fabric sheets attached thereto to form a layer 704 having a thickness of 10 mm. Other conditions are the same as in the Experiments I and II. The results are listed below together with the results of the Experiments I and II in Table 2. In the Experiment III, treated water had substantially the same water quality as in the Experiments I and II. The electrolytic deposition apparatus was disassembled after operation, and the states of the activated carbon nonwoven fabric sheets were observed. With this observation, copper was deposited uniformly on surfaces of the activated carbon nonwoven fabric sheets.

TABLE 2

| | Water quality | | | | Thickness | |
|---|---|---|---|---|---|---|
| | (concentration | | | | of | |
| | of copper | | | | activated | |
| | ions) | | Conditions for | | carbon | |
| | Raw | Treated | operation | | nonwoven | |
| | water | water | Current | Voltage | fabric | |
| | (mg/l) | (mg/l) | (A) | (V) | layer | Note |
| Experi- | 100 | 0.13 | 1.0 | 5 | 10 mm | |
| ment I | | | | | | |
| Experi- | 100 | 0.07 | 1.5 | 7 | 10 mm | |
| ment II | | | | | | |
| Experi- | 100 | 0.10 | 1.0 | 10 | 10 mm | Copper was |
| ment III | | | | | Five | deposited |
| | | | | | sheets | uniformly |
| | | | | | with non- | on |
| | | | | | conductive | activated |
| | | | | | nonwoven | carbon |
| | | | | | fabric | nonwoven |
| | | | | | sheets | fabric |
| | | | | | | sheets |

### Example 2

In this example, the cathode and the anode were exchanged with each other in the apparatus of the Example (1). Specifically, the electrolytic deposition apparatus was arranged such that waste water was passed through the anode 703, the layer 705 of the cation exchanger of nonwoven fabric, the layer 704 of the activated carbon nonwoven fabric, and then the cathode 702. Three activated carbon nonwoven fabric sheets were piled on each other to form the layer 704 having a thickness of 5 mm. Two sheets of the cation exchanger of nonwoven fabric were plied on each other to form the layer 705 having a thickness of 2 mm. Further, the raw water was adjusted to have a copper ion concentration smaller than that in the Example (1). Other conditions were the same as in the Example (1). The results are listed below in Experiment IV and V of Table 3.

TABLE 3

| | Water quality | | | | |
|---|---|---|---|---|---|
| | (concentration | | | | Thickness of |
| | of copper ions) | | Conditions for | | activated |
| | Raw | Treated | operation | | carbon |
| | water | water | Current | Voltage | nonwoven |
| | (mg/l) | (mg/l) | (A) | (V) | fabric layer |
| Experiment | 38 | 5.8 | 1.0 | 6 | 5 mm |
| IV | | | | | |
| Experiment V | 3.1 | 0.09 | 0.2 | 7 | 5 mm |

It can be seen from the results that the treated water had water quality which is worse than that in the Example (1) in which the waste water was passed through the cathode, the activated carbon nonwoven fabric sheet, the cation exchange nonwoven fabric, and then the anode. However, it is shown that copper ions could be removed from the waste water to a certain extent.

### Example 3

### Production of Iminodiacetate Nonwoven Fabric (with the Same Base Material)

The specifications of the base nonwoven fabric, which was used in the production of an iminodiacetate nonwoven fabric that was used in the following examples, are shown in Table 1 above. The nonwoven fabric was obtained by thermal fusion of composite fibers comprising a core of polypropylene and a sheath of polyethylene.

The nonwoven fabric of the specifications shown in table 1 was irradiated with γ-rays in a nitrogen atmosphere, and was then immersed in a chloromethylstyrene (CMS) solution for reaction, thereby obtaining a grafted nonwoven fabric with a graft ratio of 115%. Next, the grafted nonwoven fabric was immersed in a mixture of sodium iodide and acetone for reaction. The nonwoven fabric after the reaction was cleaned with pure water and acetone, and was then immersed in a mixed solution of diethyl iminodiacetate and dimethylformamide for reaction. The nonwoven fabric after the reaction was cleaned with methanol. Thereafter, the nonwoven fabric after the cleaning was immersed in a mixed solution of sodium hydroxide and ethanol for reaction, thereby obtaining an iminodiacetate nonwoven fabric.

### Example 4

Experiment was carried out in the same manner as in Example 1, using a 7 mm-thick copper foamed metal (60 ppi) as a water-permeable conductive element in the apparatus of Example 1 (Experiment VI). Further, experiment was carried out in the same manner as in Example 1, using a 7-mm thick copper foamed metal and a carbon fiber nonwoven fabric as a water-permeable conductive element (Experiment VII). Further, experiment was carried out in the same manner as in Experiment VI, except that a 1.2-mm space was provided between the foamed metal and the ion exchanger (Experiment VIII).

In Experiment VII, the carbon fiber nonwoven fabric was interposed between the foamed metal and the ion exchanger. The results are shown in Table 4. In Experiments VI and VIII, deposition of copper hydroxide and copper oxide on the surface of water-permeable conductive element was observed. It was confirmed that this phenomenon can be suppressed when the pH of the raw water is not more than 2. In Experiment VII, no deposition of copper oxide or copper hydroxide was observed irrespective of the pH of raw water. It was recognized that the use of the carbon fiber nonwoven fabric could suppress the deposition of copper oxide or copper hydroxide.

From the results of these Experiments, it was confirmed that the use of the foamed metal as a water-permeable conductive element could also attain the effect of the present invention.

TABLE 4
Experimental results of Example 4

| | Water quality | | | | Thickness of |
|---|---|---|---|---|---|
| | (concentration | | | | water- |
| | of copper ions) | | Conditions for | | permeable |
| | Raw | Treated | operation | | conductive |
| | water | water | Current | Voltage | element |
| | (mg/l) | (mg/l) | (A) | (V) | (mm) |
| Experiment | 100 | <0.1 | 2.4 | 10 | 7 |
| VI | | | | | |
| Experiment | 100 | <0.1 | 2.4 | 9 | 7 (foamed |
| VII | | | | | copper metal) |
| | | | | | 0.5 (carbon |
| | | | | | fiber |
| | | | | | nonwoven |
| | | | | | fabric) |
| Experiment | 100 | <0.1 | 2.4 | 20 | 7 (foamed |
| VIII | | | | | copper metal) |

### Example 5

Experiment was carried out in the same manner as in Experiment VII of Example 4, using an ion-exchange nonwoven fabric having iminodiacetic acid group as an ion exchanger (Experiment IX). Further, experiment was carried out in the same apparatus as in Experiment IX, using rinsing waste water discharged from a copper-plating cleaning process as raw water (Experiment X). The results are shown in Table 5.

It was confirmed from the results that the use of the ion exchanger having iminodiacetic acid group as an ion exchanger could also attain the effect of the present invention. It was also confirmed that the effect of the present invention could be attained also for the copper-plating rinsing waste water.

TABLE 5
Experimental results of Example 5

| | Water quality | | | | Thickness of |
|---|---|---|---|---|---|
| | (concentration | | | | water- |
| | of copper ions) | | Conditions for | | permeable |
| | Raw | Treated | operation | | conductive |
| | water | water | Current | Voltage | element |
| | (mg/l) | (mg/l) | (A) | (V) | (mm) |
| Experiment | 100 | <0.1 | 2.4 | 10 | 7 |
| IV | | | | | |
| Experiment X | 110 | <0.1 | 2.4 | 10 | 7 |

### Example 6

Experiment was carried out using the experimental apparatus shown in FIG. 40A. In the separation treatment, the ion-exchange nonwoven fabric having iminodiacetic acid group was used as an ion exchanger in the desalting chamber 42, and the ion-exchange nonwoven fabric having sulfo group was used as an ion exchanger in the concentrating chamber 41. The electrode material was the same as in Example 1. Sulfuric acid or nitric acid was supplied to the cathode chamber so that its concentration becomes about 1%.

In the recovery of treated water, plate-like electrodes were employed. The anode material was platinized titanium coating, and the cathode material was copper. The bath was stirred at a rotational speed of 300 rpm (m⁻¹) by means of a stirrer.

Experiment XI was carried out using a copper-plating rinsing waste water as raw water. Experiment XII was carried out using CMP waste water discharged from a polishing process for copper as raw water. The slurry concentration of the CMP waste water was 2000 ppm in terms of TS (Total Solid: Residue, Total, EPA Method 160.3).

The current density was set at 3 A/dm² both in the separation treatment and the recovery treatment.

As a result, in Experiment XI, the Cu concentration of raw water was 120 ppm, whereas the Cu concentration of treated water was less than 0.1 ppm. The constitution of this Example could also attain the effect of the present invention. The copper ion concentration concentrated in the concentrating chamber was found to be not less than 1000 ppm. The copper ions in the concentrated water were recovered as copper metal at the cathode in the recovery treatment step.

In Experiment XII, the Cu concentration of raw water was 110 ppm, whereas the Cu concentration of treated water was less than 0.1 ppm. The copper ions in the concentrated water were recovered as copper metal at the cathode in the recovery treatment step. It was thus confirmed that the effect of the present invention could be attained also for the CMP waste water.

### Example 7

Experiment was carried out using the same apparatus as used in Example 6, and using the ion-exchange nonwoven fabric having sulfo group as an ion exchanger in the desalting chamber. The same raw water as in Example 6 (CMP waste water, copper-plating rinsing waste water) was used. The current density was set at 3 A/dm² both in the separation treatment and the recovery treatment. As a result, the same quality of treated water (Cu conc.<0.1 ppm) was obtained, and copper ions in the waste water were recovered as copper metal.

### Example 8

Experiment was carried out according to a treatment flow shown in FIG. 29D. The same CMP waste water as in Example 5 was used. The waste water was adjusted to a pH of 2 to 3 with sulfuric acid to obtain a precipitate composed mainly of a slurry component. The supernatant liquid was subjected to filtration using a ceramic filter (molecular weight cutoff of 50000 pore diameter of<0.1 μm). Thereafter, Cu²⁺ ions were removed by means of an apparatus as shown in FIG. 40A, Example 7, thereby obtaining treated water having a Cu concentration of less than 0.1 ppm. The Cu²⁺ ions recovered in the concentrating chamber were deposited on the cathode and recovered as copper metal. The precipitate was subjected to a centrifuge to carry out centrifugal separation treatment, thereby removing most of mother water on the slurry surface. Thereafter, pure water with its pH adjusted to 2 to 3 was supplied as rinsing water to a centrifugal separation treatment to carry out centrifugal separation again. The mother water and rinsing waste water separated in the centrifugal separation treatment were supplied to sedimentation treatment.

As described above, according to the present invention, water to be treated, containing heavy metal ions, can be treated so as to provide treated water having a lowered concentration of heavy metal, and the heavy metal can be recovered in the form of metal element. For example, waste water discharged from a semiconductor fabrication process (e.g., a CMP process or a copper plating process) can be treated so as to provide treated water having a copper concentration lower than a discharge standard value, and copper can be recovered as copper metal from the waste water. Therefore, the present invention is extremely effective in view of discharge standard value and resource saving.

Although certain preferred embodiments of the present invention have been shown and described in detail, it should be understood that various changes and modifications may be made therein without departing from the scope of the appended claims.

### INDUSTRIAL APPLICABILITY

The present invention is suitable for use in an apparatus for removing and recovering metal ions from various kinds of waste water to be treated.

1. An apparatus for treating water containing metal ions and an oxidizing agent, said apparatus comprising:
an oxidizing agent removing apparatus for decomposing and removing an oxidizing agent from the water; and
an electrolytic deposition apparatus for removing and recovering metal ions from the water discharged from said oxidizing agent removing apparatus, said electrolytic deposition apparatus having electrodes and an ion exchanger disposed between said electrodes.

2. A method for treating water containing metal ions and an oxidizing agent, said method comprising:
decomposing and removing an oxidizing agent from the water; and
introducing the water from which the oxidizing agent has been decomposed and removed into an electrolytic deposition apparatus having electrodes and an ion exchanger disposed between said electrodes to remove and recover metal ions from the water.

3. A method for treating water containing metal ions, an oxidizing agent, and an inorganic particle slurry, said method comprising:
a slurry particle removing step for adding a pH adjustor to the water to aggregate at least a portion of slurry particles in the water, and passing the water through a filtering device to remove the aggregated slurry particles;
an oxidizing agent removing step for decomposing and removing an oxidizing agent from the water discharged from said slurry particle removing step; and
an electrolytic deposition step for removing and recovering metal ions from the water discharged from said oxidizing agent removing step by an electrolytic deposition apparatus having electrodes and an ion exchanger disposed between said electrodes.

4. An electrolytic deposition apparatus comprising:
an anode and a cathode opposed to each other; and
an ion exchanger disposed between said anode and said cathode.

5. An electrolytic deposition apparatus according to claim 4, wherein said anode and said cathode are made of a water-permeable material, respectively;
an electrolytic chamber is formed between said anode and said cathode;
said ion exchanger comprises at least a layer disposed between said anode and said cathode; and
a water supply and discharge device for passing the water to be treated through composite layers composed of said anode, said cathode, and said layer of said ion exchanger.

6. An electrolytic deposition apparatus according to claim 4, further comprising:
a layer of a water-permeable conductive element disposed so as to contact said cathode;
wherein said layer of said ion exchanger is disposed between said layer of said water-permeable conductive element and said anode and held in contact with said layer of said water-permeable conductive element and said anode.

7. An electrolytic deposition apparatus according to claim 6, wherein said water-permeable conductive element is made of a water-permeable carbon fiber material.

8. An electrolytic deposition apparatus according to claim 6, wherein said water-permeable conductive element is made of a water-permeable metal comprising a foamed metal material or a metal fiber.

9. An electrolytic deposition apparatus according to claim 6, wherein said water-permeable conductive element is made of a combination of a water-permeable carbon fiber material and a water-permeable metal material.

10. An electrolytic deposition apparatus according to claim 4, wherein said ion exchanger is made of an ion exchange fiber material.

11. An electrolytic deposition apparatus according to claim 10, wherein said ion exchange fiber material is a fiber material in which an ion exchange group is introduced into an organic polymer nonwoven fiber substrates by radiation-induced graft polymerization.

12. An electrolytic deposition apparatus according to claim 4, wherein said ion exchanger comprises a cation exchanger or a chelate.

13. A method for treating water containing metal ions, said method comprising:
treating water having a metal ion concentration of 200 mg/l or lower to provide treated water having a lowered concentration of the metal ions; and
recovering metal contained in the water in the form of metal element from the treated water.

14. A method for treating waste water containing copper ions, said method comprising:
treating waste water discharged from a semiconductor device fabrication process to provide treated water having a copper concentration lower than a predetermined value; and
recovering copper in the form of a copper metal from the treated water.

15. An electrolytic deposition apparatus according to claim 5, further comprising:
a layer of a water-permeable conductive element disposed so as to contact said cathode;
wherein said layer of said ion exchanger is disposed between said layer of said water-permeable conductive element and said anode and held in contact with said layer of said water-permeable conductive element and said anode.

16. An electrolytic deposition apparatus according to claim 5, wherein said ion exchanger is made of an ion exchange fiber material.

17. An electrolytic deposition apparatus according to claim 6, wherein said ion exchanger is made of an ion exchange fiber material.

18. An electrolytic deposition apparatus according to claim 7, wherein said ion exchanger is made of an ion exchange fiber material.

19. An electrolytic deposition apparatus according to claim 8, wherein said ion exchanger is made of an ion exchange fiber material.

20. An electrolytic deposition apparatus according to claim 9, wherein said ion exchanger is made of an ion exchange fiber material.
